(19) United States
(12) Patent Application Publication
(10) Pub. No.: US 2026/0029625 A1
(43) Pub. Date: Jan. 29, 2026

(54) OPTICAL SYSTEM AND CAMERA MODULE

(71) Applicant: NINGBO SUNNY OPOTECH CO., LTD., Yuyao City (CN)

(72) Inventors: Meishan GUO, Yuyao City (CN); Hansheng Cen, Yuyao City (CN); Takehiko Tanaka, Yuyao City (CN); Tongji Jiang, Yuyao City (CN); Xiuxiu Zhou, Yuyao City (CN); Liguo Liu, Yuyao City (CN); Yu Wu, Yuyao City (CN); Anan Wu, Yuyao City (CN); Hao Zhang, Yuyao City (CN); Hang Yu, Yuyao City (CN); Dandan Ge, Yuyao City (CN); Xipu Dong, Yuyao City (CN)

(73) Assignee: NINGBO SUNNY OPOTECH CO., LTD., Yuyao City (CN)

(21) Appl. No.: 19/022,046

(22) Filed: Jan. 15, 2025

(30) Foreign Application Priority Data
Jul. 23, 2024 (CN) 202410993371.8
Sep. 18, 2024 (CN) 202411303192.3
Sep. 18, 2024 (CN) 202411305116.6
Sep. 18, 2024 (CN) 202411305134.4
Sep. 18, 2024 (CN) 202411305153.7

(51) Int. Cl. G02B 13/00; G02B 23/08; G03B 17/17

(52) U.S. Cl. CPC G02B 13/0065; G02B 13/0045; G02B 23/08; G03B 17/17

(57) ABSTRACT

An optical system and a camera module are provided, and the optical system along an optical axis from an object side to an image side sequentially includes: a first element group, a second element group, and a third element group having a positive refractive power. The first element group, from the object side to the image side sequentially includes: a first lens having a positive refractive power and a reflective element. The reflective element is configured to reflect light exiting from the first lens. The optical system satisfies: 0.85<|FG12/FG3|<1.1, where FG12 is a combined focal length of the first element group and the second element group, and FG3 is an effective focal length of the third element group.

### CROSS-REFERENCE TO RELATED APPLICATIONS

This application claims the benefit from Chinese Patent Application No. 202410993371.8, filed on Jul. 23, 2024, Chinese Patent Application No. 202411305116.6, filed on Sep. 18, 2024, Chinese Patent Application No. 202411305134.4, filed on Sep. 18, 2024, Chinese Patent Application No. 202411305153.7, filed on Sep. 18, 2024, and Chinese Patent Application No. 202411303192.3, filed on Sep. 18, 2024 before the China National Intellectual Property Administration. All of the aforementioned patent applications are hereby incorporated by reference in their entireties.

### TECHNICAL FIELD

The present disclosure relates to the field of optical devices, in particular to an optical system and a camera module.

### BACKGROUND

With the rapid development of portable devices such as smart phones, telephoto lens assemblies have been widely used due to their advantages such as clear imaging of distant objects, providing high magnification, and presenting detailed features of objects.

The effective focal length of the optical system is an important criterion for determining whether the optical system is a telephoto lens assembly. The greater the effective focal length of the optical system, the clearer the images of distant objects photographed by the optical system will be. However, the effective focal length of the optical system is directly proportional to an optical path length required by the optical system, meaning that a longer effective focal length of the optical system necessitates a greater optical path length required by the optical system. Therefore, in order to achieve the telescope characteristic of the optical system, a total length of the existing optical system is usually substantial, which significantly limits application of the optical system in portable devices.

### SUMMARY

According to an aspect of the present disclosure, an optical system is provided, and the optical system along an optical axis from an object side to an image side sequentially includes: a first element group, a second element group and a third element group having a positive refractive power. The first element group from the object side to the image side sequentially includes: a first lens having a positive refractive power and a reflective element. The reflective element is configured to reflect light exiting from the first lens. The optical system satisfies: 0.85<|FG12/FG3|<1.1, where FG12 is a combined focal length of the first element group and the second element group, and FG3 is an effective focal length of the third element group.

According to an exemplary implementation of the present disclosure, the first element group includes: a second lens, having a negative refractive power, and disposed between the reflective element and the second element group.

According to an exemplary implementation of the present disclosure, the optical system satisfies: 0.1<tan(α)×d12<1.8, where a is an included angle between emitting light corresponding to the first lens and incident light corresponding to the first lens, and d12 is an on-axis distance from an image-side surface of the first lens to an object-side surface of the second lens.

According to an exemplary implementation of the present disclosure, the second element group includes a third lens closest to the object side, where the optical system satisfies: 0.1<tan(α)×d12+tan(β)×d23<1.8, where a is an included angle between emitting light corresponding to the first lens and incident light corresponding to the first lens, d12 is an on-axis distance from an image-side surface of the first lens to an object-side surface of the second lens, β is an included angle between emitting light corresponding to the second lens and incident light corresponding to the first lens, and d23 is an on-axis distance from an image-side surface of the second lens to an object-side surface of the third lens.

According to an exemplary implementation of the present disclosure, the optical system satisfies: 1.1< (d1P+dP2)/SH<1.6, where d1P is an on-axis distance from an object-side surface of the first lens to the reflective element, dP2 is an on-axis distance from the reflective element to an image-side surface of the second lens, and SH is a total height of the optical system.

According to an exemplary implementation of the present disclosure, the optical system satisfies: 0.1<dP2/SL<0.3, where dP2 is an on-axis distance from the reflective element to an image-side surface of the second lens, and SL is a total length of the optical system.

According to an exemplary implementation of the present disclosure, the optical system satisfies: 0.6<d1P/dP2<1.1, where d1P is an on-axis distance from an object-side surface of the first lens to the reflective element, and dP2 is an on-axis distance from the reflective element to an image-side surface of the second lens.

According to an exemplary implementation of the present disclosure, the optical system satisfies: tan (FOV/2)<0.40, where FOV is a maximal field-of-view of the optical system.

According to an exemplary implementation of the present disclosure, the optical system satisfies: 3.0<D1/CT1<7.0, where D1 is a maximal effective aperture radius of the first lens, and CT1 is a center thickness of the first lens on the optical axis.

According to an exemplary implementation of the present disclosure, the optical system satisfies: 1.8≤D2/CT2<8.1, where D2 is a maximal effective aperture radius of the second lens, and CT2 is a center thickness of the second lens on the optical axis.

According to an exemplary implementation of the present disclosure, where the optical system satisfies: |f1/f2|≤1.0, where f1 is an effective focal length of the first lens, and f2 is an effective focal length of the second lens.

According to an exemplary implementation of the present disclosure, the optical system satisfies: 0.55≤|FG12/EFL|≤0.67, where FG12 is the combined focal length of the first element group and the second element group, and EFL is an effective focal length of the optical system.

According to an exemplary implementation of the present disclosure, the optical system satisfies: 15.5 mm<|EFL/(FG12/FG3)|<35 mm, where FG12 is the combined focal length of the first element group and the second element group, FG3 is the effective focal length of the third element group, and EFL is an effective focal length of the optical system.

According to an exemplary implementation of the present disclosure, the optical axis includes a first optical axis and a second optical axis having a preset angle therebetween, the reflective element is configured to receive the light exiting from the first lens along a direction of the first optical axis, and reflect the light along a direction of the second optical axis to be emitted into the second lens, where the optical system satisfies: 0.02 mm⁻¹≤D2x/EPDx/d12<0.15 mm⁻¹, where D2x is a maximal effective aperture radius of the second lens in a first direction, EPDx is an entrance pupil diameter of the optical system in the first direction, and d12 is an on-axis distance from an image-side surface of the first lens to an object-side surface of the second lens; where the first direction is a direction perpendicular to a plane formed by the first optical axis and the second optical axis.

According to an exemplary implementation of the present disclosure, the optical axis includes a first optical axis and a second optical axis having a preset angle therebetween, the reflective element is configured to receive the light exiting from the first lens along a direction of the first optical axis, and reflect the light along a direction of the second optical axis to be emitted into the second lens, where the optical system satisfies: 0.02 mm⁻¹≤D2y/EPDy/d12<0.15 mm⁻¹, where D2y is a maximal effective aperture radius of the second lens in a second direction, EPDy is an entrance pupil diameter of the optical system in the second direction, and d12 is an on-axis distance from an image-side surface of the first lens to an object-side surface of the second lens; where the second direction is a direction parallel to the first optical axis.

According to an exemplary implementation of the present disclosure, the optical system satisfies: −0.60<fs1/fs2<1.85, where fs1 is an effective focal length of an object-side surface of the first lens, and fs2 is an effective focal length of an image-side surface of the first lens.

According to an exemplary implementation of the present disclosure, the optical system satisfies: 0.56<EFL/SL<1.0, where EFL is an effective focal length of the optical system, and SL is a total length of the optical system.

According to an exemplary implementation of the present disclosure, the optical system satisfies: 0.95≤SD1/SD2≤1.12, where SD1 is a maximal effective aperture radius of a lens closest to the object side in the second element group, and SD2 is a maximal effective aperture radius of another lens adjacent to the lens closest to the object side in the second element group.

According to an exemplary implementation of the present disclosure, the optical system satisfies: the reflective element includes a planar reflector.

According to an exemplary implementation of the present disclosure, a position of the second element group relative to an image plane disposed on the image side is fixed, and a distance between the third element group and the second element group on the optical axis is adjustable.

According to another aspect of the present disclosure, a camera module is provided, the camera module including the optical system according to any one of the above implementations and an imaging element configured to convert an optical image formed by the optical system into an electrical signal.

### BRIEF DESCRIPTION OF THE DRAWINGS

Other features, objectives, and advantages of the present disclosure will become more apparent from the following detailed description of non-limiting embodiments with reference to the accompanying drawings. In the accompanying drawings:

FIG. 1A illustrates a schematic structural diagram of an optical system according to the present disclosure;

FIG. 1B illustrates a schematic diagram of an optical path of light in a first element group;

FIG. 2 illustrates a schematic structural diagram of an optical system in a first state according to Embodiment 1 of the present disclosure;

FIG. 3 illustrates a schematic structural diagram of the optical system in a second state according to Embodiment 1 of the present disclosure;

FIG. 4A, FIG. 4B and FIG. 4C respectively illustrate a longitudinal aberration curve, an astigmatic curve and a distortion curve of the optical system in the first state according to Embodiment 1 of the present disclosure;

FIG. 5 illustrates a schematic structural diagram of an optical system in the first state according to Embodiment 2 of the present disclosure;

FIG. 6 illustrates a schematic structural diagram of the optical system in the second state according to Embodiment 2 of the present disclosure;

FIG. 7A, FIG. 7B and FIG. 7C respectively illustrate a longitudinal aberration curve, an astigmatic curve and a distortion curve of the optical system in the first state according to Embodiment 2 of the present disclosure;

FIG. 8 illustrates a schematic structural diagram of an optical system in the first state according to Embodiment 3 of the present disclosure;

FIG. 9 illustrates a schematic structural diagram of the optical system in the second state according to Embodiment 3 of the present disclosure;

FIG. 10A, FIG. 10B and FIG. 10C respectively illustrate a longitudinal aberration curve, an astigmatic curve and a distortion curve of the optical system in the first state according to Embodiment 3 of the present disclosure;

FIG. 11 illustrates a schematic structural diagram of an optical system in the first state according to Embodiment 4 of the present disclosure;

FIG. 12 illustrates a schematic structural diagram of the optical system in the second state according to Embodiment 4 of the present disclosure;

FIG. 13A, FIG. 13B and FIG. 13C respectively illustrate a longitudinal aberration curve, an astigmatic curve and a distortion curve of the optical system in the first state according to Embodiment 4 of the present disclosure;

FIG. 14 illustrates a schematic structural diagram of an optical system in the first state according to Embodiment 5 of the present disclosure;

FIG. 15 illustrates a schematic structural diagram of the optical system in the second state according to Embodiment 5 of the present disclosure;

FIG. 16A, FIG. 16B and FIG. 16C respectively illustrate a longitudinal aberration curve, an astigmatic curve and a distortion curve of the optical system in the first state according to Embodiment 5 of the present disclosure;

FIG. 17 illustrates a schematic structural diagram of an optical system in the first state according to Embodiment 6 of the present disclosure;

FIG. 18 illustrates a schematic structural diagram of the optical system in the second state according to Embodiment 6 of the present disclosure;

FIG. 19A, FIG. 19B and FIG. 19C respectively illustrate a longitudinal aberration curve, an astigmatic curve and a distortion curve of the optical system in the first state according to Embodiment 6 of the present disclosure;

FIG. 20 illustrates a schematic structural diagram of an optical system in the first state according to Embodiment 7 of the present disclosure;

FIG. 21 illustrates a schematic structural diagram of the optical system in the second state according to Embodiment 7 of the present disclosure;

FIG. 22A, FIG. 22B and FIG. 22C respectively illustrate a longitudinal aberration curve, an astigmatic curve and a distortion curve of the optical system in the first state according to Embodiment 7 of the present disclosure;

FIG. 23 illustrates a schematic structural diagram of an optical system in the first state according to Embodiment 8 of the present disclosure;

FIG. 24 illustrates a schematic structural diagram of the optical system in the second state according to Embodiment 8 of the present disclosure;

FIG. 25A, FIG. 25B and FIG. 25C respectively illustrate a longitudinal aberration curve, an astigmatic curve and a distortion curve of the optical system disclosure in the first state according to Embodiment 8 of the present;

FIG. 26 illustrates a schematic structural diagram of an optical system in the first state according to Embodiment 9 of the present disclosure;

FIG. 27 illustrates a schematic structural diagram of the optical system in the second state according to Embodiment 9 of the present disclosure;

FIG. 28A, FIG. 28B and FIG. 28C respectively illustrate a longitudinal aberration curve, an astigmatic curve and a distortion curve of the optical system in the first state according to Embodiment 9 of the present disclosure;

FIG. 29 illustrates a schematic structural diagram of an optical system in the first state according to Embodiment 10 of the present disclosure;

FIG. 30 illustrates a schematic structural diagram of the optical system in the second state according to Embodiment 10 of the present disclosure;

FIG. 31A, FIG. 31B and FIG. 31C respectively illustrate a longitudinal aberration curve, an astigmatic curve and a distortion curve of the optical system in the first state according to Embodiment 10 of the present disclosure;

FIG. 32 illustrates a schematic structural diagram of an optical system in the first state according to Embodiment 11 of the present disclosure;

FIG. 33 illustrates a schematic structural diagram of the optical system in the second state according to Embodiment 11 of the present disclosure;

FIG. 34A, FIG. 34B and FIG. 34C respectively illustrate a longitudinal aberration curve, an astigmatic curve and a distortion curve of the optical system in the first state according to Embodiment 11 of the present disclosure;

FIG. 35 illustrates a schematic structural diagram of an optical system in the first state according to Embodiment 12 of the present disclosure;

FIG. 36 illustrates a schematic structural diagram of the optical system in the second state according to Embodiment 12 of the present disclosure;

FIG. 37A, FIG. 37B and FIG. 37C respectively illustrate a longitudinal aberration curve, an astigmatic curve and a distortion curve of the optical system in the first state according to Embodiment 12 of the present disclosure;

FIG. 38 illustrates a schematic structural diagram of an optical system in the first state according to Embodiment 13 of the present disclosure;

FIG. 39 illustrates a schematic structural diagram of the optical system in the second state according to Embodiment 13 of the present disclosure;

FIG. 40A, FIG. 40B and FIG. 40C respectively illustrate a longitudinal aberration curve, an astigmatic curve and a distortion curve of the optical system disclosure in the first state according to Embodiment 13 of the present;

FIG. 41 illustrates a schematic structural diagram of an optical system in the first state according to Embodiment 14 of the present disclosure;

FIG. 42 illustrates a schematic structural diagram of the optical system in the second state according to Embodiment 14 of the present disclosure;

FIG. 43A, FIG. 43B and FIG. 43C respectively illustrate a longitudinal aberration curve, an astigmatic curve and a distortion curve of the optical system in the first state according to Embodiment 14 of the present disclosure;

FIG. 44 illustrates a schematic structural diagram of an optical system in the first state according to Embodiment 15 of the present disclosure;

FIG. 45 illustrates a schematic structural diagram of the optical system in the second state according to Embodiment 15 of the present disclosure;

FIG. 46A, FIG. 46B and FIG. 46C respectively illustrate a longitudinal aberration curve, an astigmatic curve and a distortion curve of the optical system in the first state according to Embodiment 15 of the present disclosure;

FIG. 47 illustrates a schematic structural diagram of an optical system in the first state according to Embodiment 16 of the present disclosure;

FIG. 48 illustrates a schematic structural diagram of the optical system in the second state according to Embodiment 16 of the present disclosure; and

FIG. 49A, FIG. 49B and FIG. 49C respectively illustrate a longitudinal aberration curve, an astigmatic curve and a distortion curve of the optical system in the first state according to Embodiment 16 of the present disclosure.

Illustration of reference signs: 10, 100, 200, 300, 400, 500, 600, 700, 800, 900, 1000, 1100, 1200, 1300, 1400, 1500, 1600: optical system; E1: first lens; E2: second lens; E3: third lens; E4: fourth lens; E5: fifth lens; E6: sixth lens; E7: seventh lens; E8: eighth lens; E9: optical filter; P: reflective element; STO: diaphragm; G1: first element group; G2: second element group; G3: third element group; and IMA: image plane.

### DETAILED DESCRIPTION OF EMBODIMENTS

For a better understanding of the present disclosure, various aspects of the present disclosure will be described in more detail with reference to the accompanying drawings. It should be understood that the detailed description is merely illustrative of the exemplary embodiments of the present disclosure and is not intended to limit the scope of the present disclosure in any way. Throughout the specification, the same reference numerals designate the same elements.

It should be noted that, in the specification, the expressions such as “first,” “second” and “third” are only used to distinguish one feature from another, rather than represent any limitations to the features. Thus, the first lens discussed below may also be referred to as the second lens or the third lens without departing from the teachings of the present disclosure.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. The surface of each lens that is closest to the object being photographed is referred to as the object-side surface of that lens. The surface of each lens that is closest to the imaging plane is referred to as the image-side surface of that lens.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. Furthermore, when an expression such as “at least one of . . . ” appears before a list of features, it modifies the entire list of features, rather than individual elements within the list. In addition, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. Detailed descriptions of the features, principles, and other aspects of the present disclosure are provided below.

Periscope camera modules are common camera modules for long-distance photographing. For an optical system in a periscope camera module, a prism may be provided. The prism increases an effective focal length of the periscope camera module by refracting an optical path, so that the periscope camera module may meet the requirement for telephoto photographing, while shortening a total length of the periscope camera module, thus achieving miniaturization of the periscope camera module.

Aperture is an important parameter of the periscope camera module, and the aperture may directly affect functions of the periscope camera module such as night photography, snapshot capturing, background blurring, or video recording. For example, a large-aperture periscope camera module may enhance a blurring effect on the background of a photo and highlight the main subject, while also increasing a shutter speed and a focusing speed, ensuring that the periscope camera module obtains a good imaging quality.

However, currently the optical system of the periscope camera module still has some shortcomings. Due to the limited sizes of the light-entering and light-exiting surfaces of the prism, the area through which the prism receives light is restricted, which leads to small amount of light entering the optical system, and a small effective aperture of the optical system, leading to issues of the periscope camera module such as poor performance in low-light conditions and inadequate background blurring. When the aperture of the periscope camera module is increased, the size and weight of the prism also increase, causing the module's size and weight to grow accordingly. Clearly, the demand for a large aperture in periscope camera modules contradicts the trend of miniaturization.

Furthermore, periscope camera modules typically use motors to drive the prism for optical image stabilization. Larger and heavier prisms place higher demands on the motor's thrust capacity. Additionally, they occupy more space within the periscope camera module, leaving less room for the motor, which affects its driving performance. The dual requirements of high thrust and limited installation space undoubtedly pose greater challenges for the motor.

In order to at least partially solve one or more of the above problems as well as other potential problems, the present disclosure provide an optical system, in particular, it provides an optical system that may reduce a total height and a total length of the optical system while achieving a large aperture, and improve an imaging quality as well as an optical image stabilization performance of the optical system.

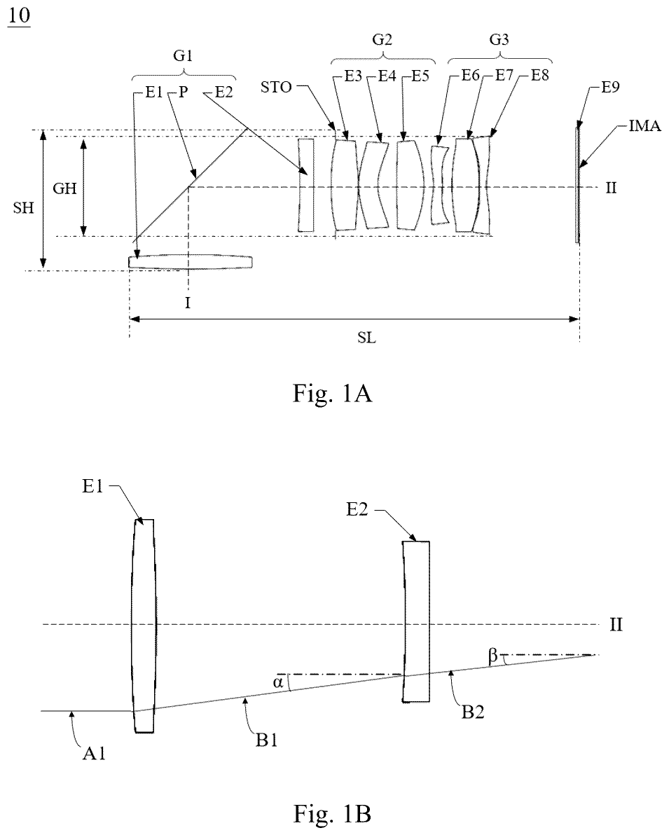

FIG. 1A illustrates a schematic structural diagram of an optical system according to the present disclosure. The optical system may, for example, be applied to a camera module, the camera module may, for example, be a periscope camera module. It should be understood that the optical system may also be applied to other camera modules, which is not limited herein.

Referring to FIG. 1A, the optical system 10 may sequentially include a first element group G1, a second element group G2 and a third element group G3 along an optical axis from an object side to an image side. The first element group G1 may include a first lens E1 and a reflective element P. The first lens E1 may have a positive refractive power. The reflective element P may be configured to reflect light exiting from the first lens E1. For example, the second element group G2 may include at least one lens. The third element group G3 may include at least one lens. As another example, an image plane IMA may be disposed on the image side of the optical system 10.

The first lens E1 may converge light, so that the light remains in a converged state after being reflected by the reflective element P, increasing the amount of light entering the second lens E2, thereby enlarging an effective aperture of the optical system 10, and improving the imaging quality of the optical system 10. In addition, it can reduce an optical aperture of the lenses within a rear element group (e.g., the second element group G2 and the third element group G3), reduce a shoulder height of the rear element group, thereby reducing a total height of the optical system 10.

In an exemplary implementation, the first element group G1 may further include the second lens E2. The second lens E2 may have a negative refractive power, and is disposed between the reflective element P and the second element group G2.

In an exemplary implementation, referring to FIG. 1A, the reflective element P may be positioned at any desired angle to bend an optical path. The reflective element P may be arranged to deflect the incident optical path by a preset degree (such as, but not limited to, 90°), for example, changing the direction of the incident optical path from propagating along a first optical axis (simply referred to as optical axis I) to propagating along a second optical axis (simply referred to as optical axis II). It should be understood that the optical axes mentioned herein may include the first optical axis and the second optical axis having a preset angle therebetween. In the following text, the first direction referred to in the disclosure may be, for example, a direction perpendicular to the plane formed by optical axis I and optical axis II, while the second direction may be, for example, a direction parallel to optical axis I.

In an exemplary implementation, referring to FIG. 1A, the reflective element P may be disposed between the first lens E1 and the second lens E2. That is, the first lens E1 may be located on the optical axis I and disposed between the object side and the reflective element P, and the second lens E2 may be located on the optical axis II and disposed between the reflective element P and the second element group G2. The reflective element P may receive the light emitted by the first lens E1 in a direction of the optical axis I, and reflect the light to be emitted into the second lens E2 along the direction of optical axis II. Herein, optical axis I and optical axis II form a preset angle, such as but not limited to, optical axis I being perpendicular to optical axis II.

In an exemplary implementation, referring to FIG. 1A, the reflective element P may be a planar reflector, and the planar reflector may have a reflective surface. Light emitted by the first lens E1 in the direction of the optical axis I is totally reflected by the reflective surface of the reflective element P, and redirected to be emitted into the second lens E2 in the direction of the optical axis II. The reflective surface of the reflective element P passes through an intersection point of the optical axis I and the optical axis II, i.e., the reflective surface of the reflective element P is located on both the optical axis I and the optical axis II. By adopting a planar reflector with a smaller weight and size as the reflective element P, when the optical system 10 achieves a large aperture, the weight and size of the first element group G1 can be constrained within a certain range, thereby minimizing the weight and size of the optical system 10 as much as possible, and reducing a driving burden on the reflective element P.

It should be understood that the planar reflector merely possesses a reflective surface, with empty spaces facing the incident light side and the emergent light side. The first lens E1 may be disposed closer to the planar reflector, which may reduce height space occupied by the first lens E1 and the reflective element P, thereby reducing the total height of the optical system 10.

In an exemplary implementation, the first lens E1 may have a positive refractive power, and may be used to converge light. By enabling the first lens E1 to have a converging effect on the light, the light remains converged after being reflected by the reflective element P, thereby increasing the amount of light entering the second lens E2, which enlarge the effective aperture (i.e., the amount of light admitted) of the optical system 10 without changing a physical aperture of a diaphragm STO. In other words, the optical system 10 may capture more light under the same light conditions, leading to an increase in the brightness of images formed by the optical system 10. For example, in a low-light environment, the optical system 10 having a large aperture may capture more light, which is particularly important for improving the imaging quality of the optical system 10 and the camera module including the optical system 10 in such environment.

At the same time, the first lens E1 converges the light, and the converged light remains converged after being reflected by the reflective element P, which is conducive to reducing an aperture of the second lens E2, and ensures that the aperture of the second element group G2 which is entered by the light exiting from the second lens E2, is still smaller than the aperture of the first lens E1 which is entered by the light, reducing the effective diameter of the lenses within the rear element group (e.g., the second element group G2 and the third element group G3), thereby reducing the shoulder height of the rear element group. It should be understood that when the camera module including the optical system 10 is applied to an electronic device, the shoulder height of the rear element group affects a thickness of the electronic device. Therefore, reducing the shoulder height of the rear element group is conducive to reducing the thickness of the electronic device, and satisfying the design requirement for miniaturization.

Furthermore, compared to parallel light rays, the reflection points of the light rays converged by the first lens E1 at the outermost edge positions on the reflective element P are closer to the optical axis. This allows the reflective element P to be made smaller, further reducing the height of reflective element P and consequently decreasing the overall height of the optical system 10.

In an exemplary implementation, the second lens E2 may have a negative refractive power, and may diverge the light reflected by the reflective element P. By enabling the second lens E2 to diverge the light, the light exiting from the second lens E2 can be incident on the second element group G2 in a direction that is nearly parallel to the optical axis II. In other words, light rays at various edge positions propagates in the directions that are nearly parallel to the optical axis II, which ensures that the aperture of the lenses within the rear element group (e.g., the second element group G2 and the third element group G3) is relatively close to the aperture of the second lens E2. With the converging effect of the first lens E1 on the light rays, the aperture of the lenses within the rear element group may be further reduced, thereby reducing the shoulder height of the rear element group.

At the same time, by providing the second lens E2 and configuring the second lens E2 to have a diverging effect on the light, when the reflective element P is driven to achieve optical image stabilization, the movement of the reflective element P has a small impact on the position of the light on the second element group G2, and a drop value of an MTF of the optical system 10 is small, i.e., the sensitivity to image stabilization is low. In particular, the diverging effect of the second lens E2 increases a coverage area of the light on the second element group G2. In addition, the pre-diverged light is not all concentrated in a very small area. Therefore, even if the reflective element P moves while an optical image stabilization operation is being performed, these movements have a relatively small influence on the position of the light on the second element group G2, and the drop value of the MTF of the optical system 10 is small, i.e., the sensitivity to image stabilization is low.

If the second lens E2 does not have a refractive power or has a positive refractive power, the light reflected by the reflective element P directly reaches the second element group G2, and the light is still in a state of converging towards the center when reaching the second element group G2, which results in a small coverage area of the light on the second element group G2. In this case, the light on the second element group G2 is relatively concentrated, if the reflective element P moves while an optical image stabilization operation is being performed, these movements have large influence on the position of the light on the second element group G2, thereby causing the drop value of the MTF of the optical system 10 to be large, i.e., the sensitivity to image stabilization is high.

In an exemplary implementation, there may be a spacing distance between the first lens E1 and the reflective element P. There may be a spacing distance between the second lens E2 and the reflective element P. By spacing the first lens E1, the second lens E2 and the reflective element P apart, multiple options can be provided for the design of surface type of side surfaces, which are closer to the reflective element P, of the first lens E1 and the second lens E2, thereby improving flexibility in the design of the surface type of the side surfaces of the first lens E1 and the second lens E2 that are closer to the reflective element P.

It should be understood that the spacing distance between the first lens E1 and the reflective element P refers to a certain gap between the side surface of the first lens E1 that is closer to the reflective element P and at least a portion of the reflective element P, rather than a complete lack of contact between the first lens E1 and the reflective element P. Similarly, the spacing distance between the second lens E2 and the reflective element P refers to a certain gap between the side surface of the second lens E2 that is closer to the reflective element P and at least a portion of the reflective element P, rather than a complete lack of contact between the second lens E2 and the reflective element P.

In an exemplary implementation, at least one of the surfaces of the first lens E1 and/or the second lens E2 is an aspheric surface. An aspheric lens is characterized in that the curvature continuously changes from the center of the lens to the periphery. Different from a spherical lens having a constant curvature from the center of the lens to the periphery, the aspheric lens has a better radius-of-curvature characteristic, and has advantages of improving a distortion aberration and an astigmatic aberration. The use of the aspheric lens can eliminate as much as possible aberrations that occur during imaging, thereby improving the imaging quality.

In an exemplary implementation, the first element group G1 may have a negative refractive power. An effective focal length FG1 of the first element group G1 may satisfy: −530.0 mm<FG1<−74.7 mm.

As an example, the effective focal length FG1 of the first element group G1 and an effective focal length EFL of the optical system 10 may satisfy: −16.8<FG1/EFL<−4.6.

As an example, an object-side surface of the first lens E1 may be a convex surface, and an image-side surface of the first lens E1 may be a convex surface or a concave surface.

As an example, an effective focal length f1 of the first lens and the effective focal length EFL of the optical system 10 may satisfy: 1.9<f1/EFL<4.0.

As an example, an object-side surface of the second lens E2 may be a convex surface or a concave surface, and an image-side surface of the second lens E2 may be a convex surface or a concave surface.

It should be understood that the number of lenses contained in the first element group G1 is only exemplary, and the present disclosure does not impose any limitation on the number of lenses contained in the first element group G1.

In an exemplary implementation, referring to FIG. 1A, the second element group G2 may have a negative refractive power. An effective focal length FG2 of the second element group G2 may satisfy: −17.2 mm<FG2<−9.2 mm.

As an example, the effective focal length FG2 of the second element group G2 and the effective focal length EFL of the optical system 10 may satisfy: −0.65<FG2/EFL<−0.40.

As an example, the second element group G2 may include a third lens E3, a fourth lens E4 and a fifth lens E5 arranged sequentially from the object side to the image side. The third lens E3, the fourth lens E4 and the fifth lens E5 may be arranged sequentially along the optical axis II from the second lens E2 to the image side.

As an example, the third lens E3 may have a positive refractive power. The fourth lens E4 may have a negative refractive power. The fifth lens E5 may have a positive refractive power.

As an example, the second element group G2 may further include the diaphragm STO. For example, the diaphragm STO may be disposed between the second lens E2 and the third lens E3.

It should be understood that the number of lenses contained in the second element group G2 is only exemplary, and the present disclosure does not impose any limitation on the number of lenses contained in the second element group G2.

As an example, an effective focal length FG3 of the third element group G3 and the effective focal length EFL of the optical system 10 may satisfy: 0.5<FG3/EFL<0.8.

As an example, the third element group G3 may include a sixth lens E6, a seventh lens E7 and an eighth lens E8 arranged sequentially from the object side to the image side. The sixth lens E6, the seventh lens E7 and the eighth lens E8 may be arranged sequentially along the optical axis II from the fifth lens E5 to the image side.

As an example, the sixth lens E6 may have a positive refractive power or a negative refractive power. The seventh lens E7 may have a positive refractive power. The eighth lens E8 may have a negative refractive power.

It should be understood that the number of lenses contained in the third element group G3 is only exemplary, and the present disclosure does not impose any limitation on the number of lenses contained in the third element group G3.

In addition, the number of lenses contained in the optical system 10 is also only exemplary, and the present disclosure does not impose any limitation on the number of lenses contained in the optical system 10.

In an exemplary implementation, the effective focal length FG1 of the first element group G1, the effective focal length FG2 of the second element group G2, and the effective focal length FG3 of the third element group G3 may satisfy: 0.6 mm⁻¹<FG1/FG2/FG3<1.8 mm⁻¹. Further, FG1, FG2, FG3, and the effective focal length EFL of the optical system 10 may satisfy: 12.5 mm²<EFL/(FG1/FG2/FG3)<46.0 mm².

By reasonably distributing the refractive powers of the element groups, on the one hand, the first lens E1 in the first element group G1 can have a strong light converging ability, realizing a significant expansion effect on the aperture. On the other hand, after passing through the first lens E1 in the first element group G1 and then exiting from the reflective element P, the light can have a smooth transition in the rear element group (e.g., the second element group G2 and the third element group G3), which is conducive to controlling the aberration generated by the light passing through the first lens E1 in the first element group G1 and the reflective element P, so that the rear element group (e.g., the second element group G2 and the third element group G3) can correct the aberration, thereby improving the imaging quality of the optical system 10. If the value of FG1/FG2/FG3 or EFL/(FG1/FG2/FG3) is smaller than the minimal value, the processing of the first lens is difficult and is not conducive to the processability of the first lens. If the value of FG1/FG2/FG3 or EFL/(FG1/FG2/FG3) is greater than the maximal value, the light passing through the first lens E1 and exiting from the reflective element P may not transition smoothly into the rear element group (e.g., the second element group G2 and the third element group G3), thereby affecting the imaging effect.

In an exemplary implementation, referring to FIG. 1A, the optical system 10 may further include an optical filter E9. The optical filter E9 may be disposed on an image side of the third element group G3, and is used to filter light exiting from the third element group G3. The optical filter E9 may be, for example, an infrared optical filter.

In an exemplary implementation, referring to FIG. 1A, when light enters the optical system 10, first, the light enters the first lens E1 in the direction of the optical axis I, then is converged by the first lens E1, and reaches the reflective element P. The light is then totally reflected by the reflective element P and redirected along the direction of optical axis II into the second lens E2. Subsequently, after exiting from the second lens E2, the light enters the second element group G2, the third element group G3 and reaches the optical filter E9 after sequentially passing through the third lens E3, the fourth lens E4, the fifth lens E5, the sixth lens E6, the seventh lens E7 and the eighth lens E8, and finally reaches the image plane IMA after passing through the optical filter E9.

By adopting the first lens E1 having a positive refractive power the reflective element P, the aperture of the optical system 10 can be enlarged, so that the optical system 10 obtains a higher brightness of image plane, and the imaging quality and the optical image stabilization performance of the optical system 10 may be improved, while also reducing the weight and size of the optical system 10.

In an exemplary implementation, referring to FIG. 1A, the position of the second element group G2 relative to the image plane IMA on the optical axis (such as the optical axis II) may be fixed. The third element group G3 is movable along the optical axis (such as the optical axis II) relative to the second element group G2, i.e., a distance between the third element group G3 and the second element group G2 (such as a distance between the third element group G3 and the second element group G2 on the optical axis II) is adjustable. When a distance between a photographed object and the optical system 10 changes from long to short, adjusting the distance between the third element group G3 and the second element group G2 on the optical axis II enables the optical system 10 to switch between a first state and a second state to achieve a focusing function of the optical system 10. For example, when the photographed object is infinitely far from the optical system 10, the optical system 10 is in the first state (e.g., long-distance state); when the photographed object is at a preset distance from the optical system 10, the optical system 10 is in the second state (e.g., close-distance state). By making the second element group G2 a fixed element group and the third element group G3 a movable element group, a travelling distance of the motor may be shortened during focusing process of the optical system 10, thereby improving the imaging quality of the optical system 10. As an example, during focusing process, the position of the first element group G1 relative to the image plane IMA on the optical axis (such as optical axis II) may be fixed.

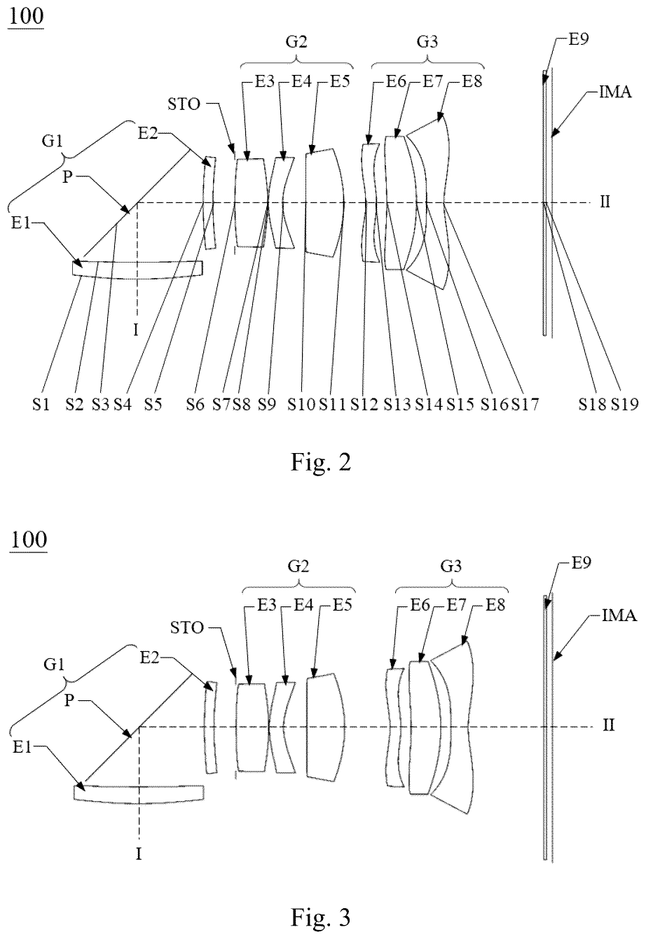

In an exemplary implementation, referring to FIG. 2 and FIG. 3, when the distance between the photographed object and the optical system 10 changes from long to short, the third element group G3 is movable along the optical axis II towards a direction away from the second element group G2 to cause the optical system 10 to switch from the first state to the second state. When the distance between the photographed object and the optical system 10 changes from short to long, the third element group G3 is movable along the optical axis II in a direction towards the second element group G2 to cause the optical system 10 to switch from the second state to the first state.

In an exemplary implementation, during focusing process of the optical system 10, a maximal travelling distance of the third element group G3 may range from 1.0 mm to 7.0 mm.

In an exemplary implementation, the optical system 10 may further include a lens barrel assembly (not shown). The lens barrel assembly may include a first lens barrel, a second lens barrel and a third lens barrel. The first element group G1 may be fixed within the first lens barrel. The second element group G2 may be fixed within the second lens barrel. The third element group G3 may be fixed within the third lens barrel. The first lens barrel has a first opening on the light entry side and a second opening on the light exit side. The first lens E1 is disposed within the first opening, the second lens E2 is disposed within the second opening, and the reflective element P is disposed between the first opening and the second opening. An inner diameter of the first opening is greater than an inner diameter of the second opening; alternatively, the inner diameter of the first opening is equal to the inner diameter of the second opening. The inner diameters of sections corresponding to different lenses in the second lens barrel are different. The inner diameters of sections corresponding to different lenses in the third lens barrel are also different.

During focusing process of the optical system 10, the positions of the second lens barrel and the second element group G2 on the optical axis II relative to the image plane IMA may be fixed, and the third lens barrel and the third element group G3 is movable along the optical axis II towards the direction away from the second element group G2. Alternatively, the third lens barrel and the third element group G3 is movable along the optical axis II in the direction towards the second element group G2. It should be understood that when the optical system 10 achieves the focusing function, the third lens barrel and the third element group G3 may be driven by the motor (not shown) to move along the optical axis II, and the second lens barrel and the second element group G2 do not move. As an example, during focusing process, the positions of the first lens barrel and the first element group G1 on the optical axis II relative to the image plane IMA are fixed.

In an exemplary implementation, the optical system 10 may further include a lens barrel assembly (not shown). The second element group G2 may be fixed within the lens barrel assembly. The third element group G3 may be movably provided within the lens barrel assembly. During focusing process of the optical system 10, the positions of the lens barrel assembly and the second element group G2 on the optical axis II relative to the image plane IMA may be fixed, and the third element group G3 is movable along the optical axis II towards the direction away from the second element group G2, alternatively, the third element group G3 is movable along the optical axis II towards the direction close to the second element group G2. It should be understood that when the optical system 10 achieves the focusing function, the third element group G3 may be driven by the motor (not shown) to move along the optical axis II, and the lens barrel assembly and the second element group G2 do not move. As an example, during focusing, the first element group G1 may be fixed within the lens barrel assembly.

In an exemplary implementation, the optical system 10 may satisfy: OBJmin≥10 cm, where OBJmin is a minimal value of an object distance of the optical system 10. The object distance may be, for example, the distance between the photographed object and the optical system 10. As an example, 10 cm≤OBJmin<20 cm. By controlling the above conditional expression, the optical system 10 can be enabled to form images with good imaging quality under conditions where the object distance is greater than or equal to 10 cm.

In an exemplary implementation, a magnification of the optical system 10 may be greater than or equal to 2.5× and smaller than or equal to 10×.

In an exemplary implementation, the optical system 10 may satisfy: 0.85<|FG12/FG3|<1.1, where, FG12 is a combined focal length of the first element group G1 and the second element group G2, and FG3 is the effective focal length of the third element group G3. By reasonably distributing the effective focal lengths of the first element group G1, the second element group G2 and the third element group G3, on the one hand, the first lens E1 in the first element group G1 may have strong light convergence capability and a strong effect on aperture expansion, contributing to the achievement of a large aperture. On the other hand, it allows for a smooth transition of light passing through the first lens group G1 into the second lens group G2 and the third lens group G3, which is conducive to controlling the aberration produced by the light the first element group G1, the second element group G2 and the third element group G3., so that the second element group G2 and the third element group G3 can correct the aberration, thereby contributing to improving the imaging quality of the optical system 10. If |FG12/FG3|<0.85, the processing of the first lens in the first element group G1 is more difficult and is not conducive to the machinability of the first lens. If |FG12/FG3|>1.1, the light passing through the first lens group G1 may not transition smoothly into the second lens group G2 and the third lens group G3, affecting the imaging effect. As an example, 0.9<|FG12/FG3|<1.1.

Further, by controlling the ratio of the combined focal length of the first element group G1 and the second element group G2 to the effective focal length of the third element group G3, the refractive powers of the fixed element groups (e.g., the first element group G1 and the second element group G2) and the movable element group (e.g., the third element group G3) can be reasonably distributed, to improve the imaging performance of the optical system 10 for objects close to the optical system 10, and to broaden the range of object distances that can be imaged by the optical system 10.

In an exemplary implementation, when light enters the optical system 10, due to the converging effect of the first lens E1 on the light, the light is in a converged state after exiting from the first lens E1, and after being reflected by the reflective element P, is still in the same converged state when reaching the second lens E2. However, due to the diverging effect of the second lens E2 on the light, a convergence angle of the light exiting from the second lens E2 may decrease (for example, the convergence angle of the light after exiting from the second lens E2 is smaller than the convergence angle of the light passing through the first lens E1), and since an interval between the second lens E2 and the third lens E3 is small, the effective diameter of the third lens E3 is relatively close to the effective diameter of the second lens E2. For example, the effective diameter of the third lens E3 is slightly smaller than the effective diameter of the second lens E2. The shoulder height of the rear element group (e.g., the second element group G2 and the third element group G3) is typically related to the maximal effective diameter of the third lens E3 in the second direction, alternatively, to a maximal aperture diameter of the diaphragm STO in the second direction.

FIG. 1B illustrates a schematic diagram of an optical path of light in a first element group. It should be noted that, for case of illustration, the reflective element P is omitted from FIG. 1B, and the first lens E1 is rotated on the optical axis II. An actual structural diagram of the first element group should be similar to FIG. 1A.

As an example, referring to FIG. 1A and FIG. 1B, the optical system 10 may satisfy: 0.1<tan(α)×d12<1.8, where, a is an included angle between emitting light B1 corresponding to the first lens E1 and incident light A1 corresponding to the first lens E1, and d12 is an on-axis distance from the image-side surface of the first lens E1 to the object-side surface of the second lens E2. For example, d12 is a sum of a distance from the image-side surface of the first lens E1 to the reflective element P on the optical axis I and a distance from the reflective element P to the object-side surface of the second lens E2 on the optical axis II. The incident light A1 corresponding to the first lens E1 may be, for example, parallel light. The product of tan(α) and d12 is approximately equal to a difference between the maximal effective aperture radii of the first lens E1 and the second lens E2. The larger the value of α, the better the converging effect of the first lens E1 on the light, and the greater the difference between the maximum effective aperture radii of the first lens E1 and the second lens E2. By controlling the above conditional expression, the first lens E1 can be made to have a strong converging ability for light, ensuring that the light remains in a converged state after being reflected by the reflective element P. This is beneficial for reducing the effective aperture of the second lens E2, further reducing the effective aperture of the lenses within the rear group of elements (e.g., the second group of elements G2 and the third group of elements G3), decreasing the shoulder height of the rear group of elements, and reducing the total height of the optical system 10. It also facilitates the achievement of a large aperture for the optical system 10. For example, 4.8 mm<d12<19.8 mm. As an example, 0.2<tan(α)×d12<1.4.

As an example, referring to FIG. 1A and FIG. 1B, the optical system 10 may satisfy: 0.1<tan(α)×d12+tan(β)×d23<1.8, where, α is the included angle between the emitting light B1 corresponding to the first lens E1 and the incident light A1 corresponding to the first lens E1, d12 is the on-axis distance from the image-side surface of the first lens E1 to the object-side surface of the second lens E2, B is an included angle between emitting light B2 corresponding to the second lens E2 and the incident light A1 corresponding to the first lens E1, and d23 is an on-axis distance from the image-side surface of the second lens E2 to an object-side surface of the third lens E3 (such as distance on the optical axis II). The incident light A1 corresponding to the first lens E1 may be, for example, parallel light rays. The product of tan(α) and d12 is approximately equal to the difference between the maximal effective aperture radii of the first lens E1 and the second lens E2. The larger the value of a, the better the converging effect of the first lens E1 on the light, and the greater the difference between the maximal effective aperture radii of the first lens E1 and the second lens E2. The product of tan(β) and d23 is approximately equal to a difference between the maximal effective aperture radii of the second lens E2 and the third lens E3. On the basis of not compromising the image stabilization performance, by adjusting the diverging ability of the second lens E2, there may be still a certain included angle between the light diverged by the second lens E2 and the optical axis II, thereby reducing the shoulder height of the rear element group (e.g., the second element group G2 and the third element group G3). By constraining tan(α)×d12+tan(β)×d23 within the range of 0.1 to 1.8, the first lens E1 can have a strong converging ability for light, ensuring that the light remains in a converged state after being reflected by the reflective element P, which is conducive to reducing the effective diameter of the second lens E2; at the same time, the second lens E2 has a weak diverging ability for light, and the effective diameter of the third lens E3 may be further reduced, reducing the shoulder height of the rear element group, thereby reducing the total height of the optical system 10. For example, 4.8 mm<d12<19.8 mm, 1.0 mm<d23<3.1 mm. As an example, 0.2<tan(α)×d12+tan(β) xd23<1.5. As an example, 0.1<tan(α)×d12+tan(β)×d23<1.7.

In an exemplary implementation, referring to FIG. 1A, the optical system 10 may satisfy: 1.1< (d1P+dP2)/SH<1.6, where, d1P is an on-axis distance from the object-side surface of the first lens E1 to the reflective element P (such as distance on the optical axis I), dP2 is an on-axis distance from the reflective element P to the image-side surface of the second lens E2 (such as distance on the optical axis II), and SH is the total height of the optical system 10. Here, d1P, dP2 are related to the light-converging ability of the first element group G1. Generally speaking, the larger the value of d1P+dP2, the stronger the light-converging ability of the first element group G1. Controlling the above conditional expression is conducive to ensuring that the first element group G1 has a good converging ability for light, and by reasonably arranging the positions of the first lens E1, the reflective element P, and the second lens E2, interference between the reflecting element P, and the first lens E1 and the second lens E2 may be prevented; at the same time, the total height of the optical system 10 may be reduced, while meeting the design requirement for the total length of the optical system 10 and ensuring that there is no interference between the reflective element P and the first lens E1 and the second lens E2. For example, 2.9 mm<d1P<10.4 mm and 3.0 mm<dP2<13.7 mm.

When the value of (d1P+dP2)/SH is smaller than 1.1, the value of d1P+dP2 is too small, resulting in poor light-converging ability of the first element group G1, excessive shoulder height of the rear element group and excessive total height of the optical system 10; or, when the value of (d1P+dP2)/SH is smaller than 1.1, the value of SH is too large, resulting in excessive total height of the optical system 10. When the value of (d1P+dP2)/SH is greater than 1.6, the value of d1P+dP2 is too large, resulting in excessive total length of the optical system 10. The total height of the optical system 10 and the total length of the optical system 10 are mutually constrained, and by controlling (d1P+dP2)/SH to be within the range of 1.1 to 1.6, it is conducive to reducing the total height and the total length of the optical system 10.

In an exemplary implementation, referring to FIG. 1A, the optical system 10 may satisfy: 0.1<dP2/SL<0.3, where dP2 is the on-axis distance from the reflective element P to the image-side surface of the second lens E2 (such as distance on the optical axis II), and SL is the total length of the optical system 10. By controlling the aforementioned conditional expression, while ensuring that the total length of the optical system 10 meets the design requirements, it is beneficial to ensure that the first element group G1 has good light converging effects, reducing the shoulder height of the rear element group (such as the second element group G2 and the third element group G3), and subsequently reducing the total height of the optical system 10. Here, d1P, dP2 are related to the light-converging ability of the first element group G1. The larger the value of d1P+dP2, the stronger the light-converging ability of the first element group G1. When the value of d1P+dP2 is fixed, as the value of dP2 increases, the value of d1P decreases, which is conducive to reducing the shoulder height of the rear element group and the total height of the optical system 10, while ensuring that the first element group G1 has a good converging effect on the light.

When the value of dP2/SL is smaller than 0.1, the value of dP2 is too small, the value of d1P+dP2 is too small, resulting in poor light-converging ability of the first element group G1, excessive shoulder height of the rear element group and excessive total height of the optical system 10; or, when the value of dP2/SL is smaller than 0.1, the value of dP2 is too small, the value of d1P is too large, resulting in excessive total height of the optical system 10. When the value of dP2/SL is greater than 0.3, the value of dP2 is too large, resulting in excessive total length of the optical system 10. The total height of the optical system 10 and the total length of the optical system 10 are mutually constrained, and by controlling dP2/SL to be within the range of 0.1 to 0.3, it is conducive to reducing the total height and the total length of the optical system 10.

In an exemplary implementation, the optical system 10 may satisfy: 0.6<d1P/dP2<1.1, where, d1P is the on-axis distance from the object-side surface of the first lens E1 to the reflective element P (such as distance on the optical axis I), and dP2 is the on-axis distance from the reflective element P to the image-side surface of the second lens E2 (such as distance on the optical axis II). By controlling the aforementioned conditional expression, while the total length of the optical system 10 meets the design requirements, it is beneficial to ensure that the first element group G1 has good light converging effects; and by reasonably distributing the values of d1P and dP2, the shoulder height of the rear element group (e.g., the second element group G2 and the third element group G3) is reduced, and the total height of the optical system 10 is reduced.

When the value of d1P/dP2 is smaller than 0.6, the value of dP2 is too large, resulting in excessive total length of the optical system 10. When the value of d1P/dP2 is greater than 1.1, the value of dP2 is too small, the value of d1P+dP2 is too small, resulting in poor light-converging ability of the first element group G1, excessive shoulder height of the rear element group and excessive total height of the optical system 10; or, when the value of d1P/dP2 is greater than 1.1, the value of d1P is too large, resulting in excessive total height of the optical system 10. The total height of the optical system 10 and the total length of the optical system 10 are mutually constrained, and by controlling d1P+dP2 to be within the range of 0.6 to 1.1, it is conducive to reducing the total height and the total length of the optical system 10.

In an exemplary implementation, the optical system 10 may satisfy: tan (FOV/2)<0.40, where, FOV is a maximal field-of-view of the optical system 10. As an example, 0.05<tan (FOV/2)<0.40. Reasonably configuring a tangent value of half of the maximal field-of-view of the optical system 10, enables the optical system 10 to have a small field-of-view, which is conducive for the optical system 10 to imaging an object at a long distance, thereby ensuring that the optical system 10 has a good imaging quality when imaging at a long distance.

In an exemplary implementation, the optical system 10 may satisfy: 3.0<D1/CT1<7.0, where, D1 is a maximal effective aperture radius of the first lens E1, and CT1 is a center thickness of the first lens E1 on the optical axis (such as the optical axis I). D1 may be, for example, a maximal value of the effective aperture radius of the object-side surface of the first lens E1 and the effective aperture radius of the image-side surface of the first lens E1. Reasonably configuring the ratio of the maximal effective aperture radius of the first lens E1 to the center thickness of the first lens E1, can reduce the total height of the optical system 10 and make a structure of the optical system 10 more compact, thereby reducing the volume of the optical system 10, while the machinability of the first lens E1 meets the requirements. Additionally, this configuration is conducive to achieving a large aperture for the optical system 10. As an example, 4.2<D1/CT1<6.6.

In an exemplary implementation, the optical system 10 may satisfy: 1.8≤D2/CT2<8.1, where, D2 is a maximal effective aperture radius of the second lens E2, and CT2 is a center thickness of the second lens E2 on the optical axis (such as the optical axis I). D2 may be, for example, a maximal value of the effective aperture radius of the object-side surface of the second lens E2 and the effective aperture radius of the image-side surface of the second lens E2. Reasonably configuring the ratio of the maximal effective aperture radius of the second lens E2 to the center thickness of the second lens E2, while the machinability of the second lens E2 meets the requirements, can reduce the total height of the optical system 10 and make the structure of the optical system 10 more compact, thereby reducing the volume of the optical system 10. Additionally, this configuration is also conducive to improving the optical image stabilization performance of the optical system 10. As an example, 2.2<D2/CT2<6.8.

In an exemplary implementation, the optical system 10 may satisfy: |f1/f2|≤1.0, where, f1 is an effective focal length of the first lens E1, and f2 is an effective focal length of the second lens E2. By reasonably configurating the ratio of the effective focal length of the first lens E1 to the effective focal length of the second lens E2, the first lens E1 can have a strong converging ability for light, a significant enlargement effect on the aperture, to ensure that the light is still in a converged state after being reflected by the reflective element P, which is conducive to reducing the diameter of the second lens E2, thereby reducing the aperture diameters of the lenses within the rear element group (e.g., the second element group G2 and the third element group G3), and reducing the shoulder height of the rear element group. Furthermore, it allows the angle between the light exiting the second lens E2 and the optical axis II to remain within a small range, thereby improving the optical image stabilization performance of the optical system 10.

In an exemplary implementation, the optical system 10 may satisfy: 0.55≤|FG12/EFL|≤0.67, where, FG12 is the combined focal length of the first element group G1 and the second element group G2, and EFL is the effective focal length of the optical system 10. By reasonably configuring the ratio of the combined focal length of the first element group G1 and the second element group G2 to the effective focal length of the optical system 10, it enables the optical system 10 to image objects that are in close proximity to the optical system 10, ensuring that the optical system 10 has a large range of imaging object distances; at the same time, the first element group G1 can have a certain converging ability for light, which is conducive to reducing the shoulder height of the second element group G2 and ensuring that the light enters the second element group G2 at a small angle relative to the optical axis II after passing through the first element group G1, thereby improving the optical image stabilization performance of the optical system 10.

In an exemplary implementation, the optical system 10 may satisfy: 15.5 mm<|EFL/(FG12/FG3)|<35 mm, where, FG12 is the combined focal length of the first element group G1 and the second element group G2, FG3 is the effective focal length of the third element group G3, and EFL is the effective focal length of the optical system 10. By controlling the above conditional expression, the refractive powers of the fixed element groups (e.g., the first element group G1 and the second element group G2) and the movable element group (e.g., the third element group G3) can be reasonably distributed, to ensure that the optical system 10 can achieve optimal focusing through finite movement of the movable element group when photographing objects at different object distances, and that the optical system 10 has good imaging performance at different object distances, thereby increasing the range of imaging object distances of the optical system 10. As an example, 16.0 mm<|EFL/(FG12/FG3)|<34.0 mm.

In an exemplary implementation, at least one of the first lens E1 to the eighth lens E8 may be a cut-edge lens. Effective aperture radii of the cut-edge lens in the first direction and the second direction may be different. By arranging the cut-edge lens, a total width of the rear element group (e.g., the second element group G2 and the third element group G3) in the first direction or the shoulder height of the rear element group may be further reduced, thereby reducing a total width of the optical system 10 in the first direction or the total height of the optical system 10.

In an exemplary implementation, the optical system 10 may satisfy: 0.02 mm⁻¹≤D2x/EPDx/d12<0.15 mm⁻¹, where, D2x is a maximal effective aperture radius of the second lens E2 in the first direction, EPDx is an entrance pupil diameter of the optical system 10 in the first direction, and d12 is the on-axis distance from the image-side surface of the first lens E1 to the object-side surface of the second lens E2. D2x may be, for example, a maximal value of the effective aperture radius of the object-side surface of the second lens E2 and the effective aperture radius of the image-side surface of the second lens E2 in the first direction. As described above, the first direction may be, for example, the direction perpendicular to the plane formed by the optical axis I and the optical axis II. By controlling the above conditional expression, the effective aperture of the second lens E2 can be constrained within a reasonable range while satisfying the large aperture requirement for the optical system 10, which is conducive to reducing the total width of the rear element group (e.g., the second element group G2 and the third element group G3) in the first direction, thereby reducing the total width of the optical system 10 in the first direction. As an example, 0.02 mm⁻¹<D2x/EPDx/d12≤0.10 mm⁻¹.

In an exemplary implementation, the optical system 10 may satisfy: 0.02 mm⁻¹<D2y/EPDy/d12<0.15 mm⁻¹, where, D2y is a maximal effective aperture radius of the second lens E2 in the second direction, EPDy is an entrance pupil diameter of the optical system 10 in the second direction, and d12 is the on-axis distance from the image-side surface of the first lens E1 to the object-side surface of the second lens E2. D2y may be, for example, a maximal value of the effective aperture radius of the object-side surface of the second lens E2 and the effective aperture radius of the image-side surface of the second lens E2 in the second direction. As described above, the second direction may be, for example, the direction parallel to the optical axis I. By controlling the above conditional expression, the effective diameter of the second lens E2 can be constrained within a reasonable range while satisfying the large aperture requirement for the optical system 10, which is conducive to reducing the shoulder height of the rear element group (e.g., the second element group G2 and the third element group G3), thereby reducing the total height of the optical system 10. As an example, 0.02 mm−1≤D2y/EPDy/d12≤0.10 mm⁻¹.

In an exemplary implementation, the optical system 10 may satisfy: −0.60<fs1/fs2<1.85, where, fs1 is an effective focal length of the object-side surface of the first lens E1, and fs2 is an effective focal length of the image-side surface of the first lens E1 By reasonably configuring the ratio of the effective focal lengths of the object-side surface and the image-side surface of the first lens E1, the first lens E1 can have sufficient converging ability, and surface profiles of the object-side surface and the image-side surface of the first lens E1 can be restricted, thereby reducing the shoulder height of the rear element group (e.g., the second element group G2 and the third element group G3), and reducing the total height of the optical system 10.

In an exemplary implementation, the optical system 10 may satisfy: 0.56<EFL/SL<1.0, where, EFL is the effective focal length of the optical system 10, and SL is the total length of the optical system 10. Reasonably configuring the ratio of the effective focal length of the optical system 10 to the total length of the optical system 10, is conducive to shortening the total length of the optical system 10, thereby reducing the volume of the optical system 10, when the optical system 10 achieves the characteristics such as telephoto, large aperture, or certain image plane size. As an example, 0.6<EFL/SL<0.8.

In an exemplary implementation, the optical system 10 may satisfy: 0.95≤SD1/SD2≤1.12, where, SD1 is a maximal effective aperture radius of a lens closest to the object side in the second element group G2, and SD2 is a maximal effective aperture radius of another lens adjacent to the lens closest to the object side in the second element group G2. SD1 may be, for example, a maximal effective aperture radius of the third lens E3, SD2 may be, for example, a maximal effective aperture radius of the fourth lens E4, and the maximal effective aperture radius of a lens may be, for example, a maximal value of the effective aperture radius of the object-side surface of the lens and the effective aperture radius of the image-side surface of the lens. Reasonably configuring the ratio of the maximal effective aperture radius of the third lens E3 to the fourth lens E4 in the second element group G2 is conducive to reducing the total height of the optical system 10, while ensuring the performance of the optical system 10.

The optical system 10 according to the above implementations of the present disclosure, by reasonably distributing the optical parameters of each lens and the reflective element, under the condition that the size of the optical system 10 satisfying the requirements, it is conducive for the optical system 10 to achieving the characteristics such as telephoto or large aperture, to improving the imaging quality and the optical image stabilization performance of the optical system 10, and to reducing the weight of the optical system 10.

In the present disclosure, referring to FIG. 1A, SL represents the total length of the optical system 10, in particular, SL is a distance between the first lens E1 and the image plane IMA on the optical axis II. GH represents the shoulder height of the rear element group (e.g., the second element group G2 and the third element group G3), in particular, GH is determined by the maximal effective aperture in the lenses within the second element group G2 and the third element group G3 in the second direction (e.g., the direction parallel to the optical axis I). SH represents the total height of the optical system 10, in particular, SH is the total height of the optical system 10 in the second direction (e.g., the direction parallel to the optical axis I). Modulation Transfer Function (MTF) is an important metric describing the imaging quality of the optical system 10, and the MTF may be derived by simulation. Optical Image Stabilizer (OIS) sensitivity refers to a drop value of the MTF, representing a difference between the MTF per unit jitter angle and a static MTF design value.

It should be understood by those skilled in the art that the various results and advantages described in this specification may be obtained by changing the number of the lenses constituting the optical system 10 without departing from the technical solution claimed by the present disclosure.

Detailed embodiments of the optical system 10 that may be applicable to the above implementations are further described below with reference to the accompanying drawings.

### Embodiment 1

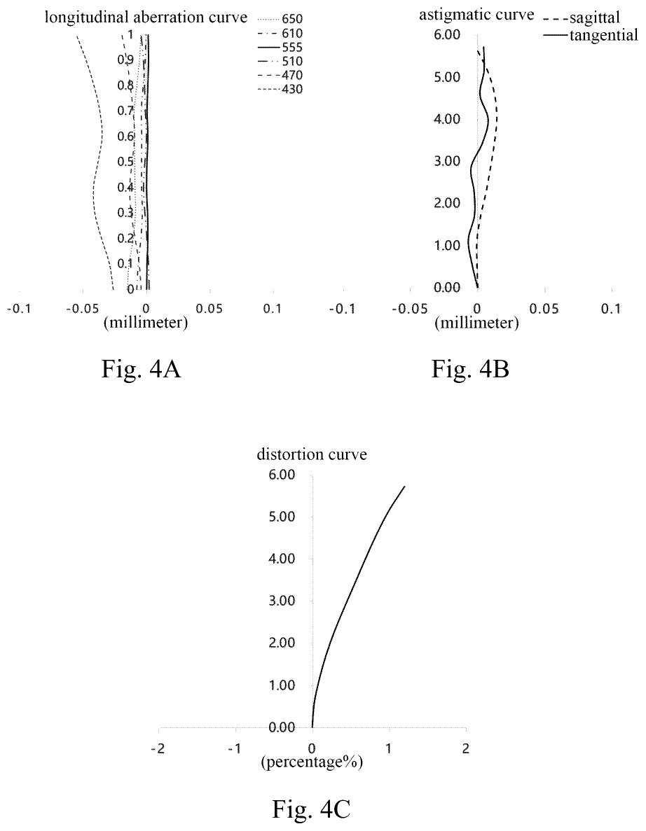

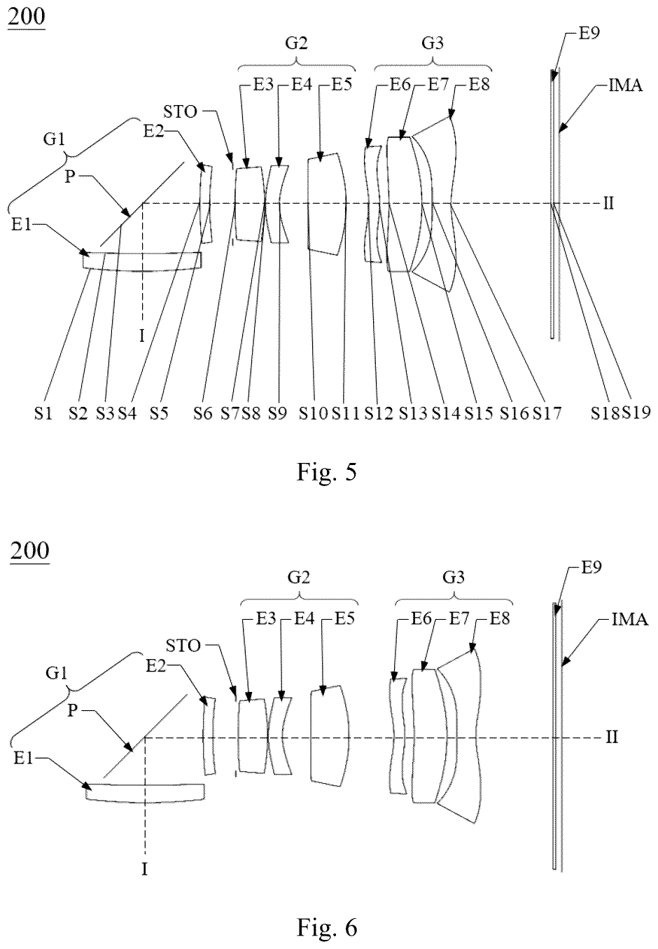

An optical system according to Embodiment 1 is described below with reference to FIG. 2, FIG. 3, FIG. 4A, FIG. 4B, and FIG. 4C.

As shown in FIG. 2 and FIG. 3, the optical system 100 may include a first element group G1, a second element group G2 and a third element group G3 arranged sequentially from an object side to an image side. The image side may be provided with, for example, an image plane IMA. The imageable object distance range of the optical system 100 may be from 17 cm to infinity. A magnification of the optical system 100 may be 2.5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 100 is decreased, adjusting the distance between the third element group G3 and the second element group G2 on the optical axis II enables the optical system 100 to switch between a first state and a second state to achieve a focusing function of the optical system 100. During the focusing process of the optical system 100, a maximal travelling distance of the third element group G3 may be 1.0898 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a convex surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a concave surface, and an image-side surface S11 of the fifth lens E5 is a convex surface. The sixth lens E6 may have a positive refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 1 shows a table of basic parameters of the optical system 100 in Embodiment 1. Here, the units of the radius of curvature and the thickness/distance are millimeters (mm).

TABLE 1

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 20.3245 | 0.7705 | plastic | 1.545 | 55.959 |
| S2 | | aspheric | 54.6116 | 2.7294 | | | |
| S3 | reflective | spherical | infinite | −3.0417 | glass | | |
| | element | | | | | | |
| S4 | second | aspheric | −16.6251 | −0.4500 | plastic | 1.539 | 56.159 |
| | lens | | | | | | |
| S5 | | aspheric | −14.5345 | −1.0105 | | | |
| STO | aperture | spherical | infinite | −0.0095 | | | |
| S6 | third lens | aspheric | −23.1280 | −1.5188 | plastic | 1.545 | 55.959 |
| S7 | | aspheric | 7.3302 | −0.0240 | | | |
| S8 | fourth lens | aspheric | −4.0262 | −0.6632 | plastic | 1.665 | 19.896 |
| S9 | | aspheric | −2.6396 | −1.0753 | | | |
| S10 | fifth lens | aspheric | 92.9072 | −1.7500 | plastic | 1.545 | 55.959 |
| S11 | | aspheric | 6.0621 | W1 | | | |
| S12 | sixth lens | aspheric | 3.7756 | −0.5000 | plastic | 1.610 | 24.945 |
| S13 | | aspheric | 3.8377 | −0.4754 | | | |
| S14 | seventh | aspheric | 10.2762 | −1.3742 | plastic | 1.671 | 19.400 |
| | lens | | | | | | |
| S15 | | aspheric | 7.9575 | −0.4580 | | | |
| S16 | eighth | aspheric | −86.4184 | −0.8126 | plastic | 1.530 | 48.633 |
| | lens | | | | | | |
| S17 | | aspheric | −4.4235 | W2 | | | |
| S18 | optical | spherical | infinite | −0.1343 | glass | 1.517 | 64.210 |
| | filter | | | | | | |
| S19 | | spherical | infinite | −0.2708 | | | |
| IMA | image | spherical | infinite | | | | |
| | plane | | | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 2 and FIG. 3.

Here, an on-axis distance W1 from the second element group G2 to the third element group G3, and an on-axis distance W2 from the third element group G3 to the optical filter E9 are variables, which may change as the distance between the photographed object and the optical system 100 changes.

When the photographed object is at infinity from the optical system 100, the optical system 100 is in the first state, and a structural diagram of the optical system 100 may be referred to in FIG. 2, where, W1=−1.0163 mm, W2=−4.5910 mm, an effective focal length of the optical system 100 EFL=15.20 mm, a maximal field-of-view of the optical system 100 FOV=41.72°, an aperture value of the optical system 100 in a first direction Fnox=2.34, and an aperture value of the optical system 100 in a second direction Fnoy=3.35. When the photographed object is at a preset distance from the optical system 100, the optical system 100 is in the second state, and a structural diagram of the optical system 100 may be referred to in FIG. 3.

In this embodiment, the object-side surface and the image-side surface of any lens in the first lens E1 to the eighth lens E8 are both aspheric surfaces, and the surface type of each aspheric lens may be defined using, but not limited to, the following aspheric formula:

$$X ( Y ) = \frac{( {Y}^{2} / R )}{1 + \sqrt{1 - ( 1 + K ) \cdot ( {Y}^{2} / {R}^{2} )}} + {( u )}^{4} {\sum }_{m = 0}^{8} {A}_{m} {Q}_{m}^{con} ( {u}^{2} ) \qquad ( 1 )$$

Here, X(Y) represents the relative distance between a point on the aspherical surface with a distance Y from the optical axis, and the tangent plane at the intersection point of the optical axis and the aspherical surface; Y represents the perpendicular distance between a point on an aspheric curve and the optical axis; R represents the radius of curvature; K represents the conic coefficient; Aₘ represents the Qcon aspheric coefficient of an i-th order; u=(Y/NR), where NR represents the normalized radius of curvature of the Qcon aspheric surface; and Qₘ^{con} represents the Qcon polynomial of an m-th order. Table 2 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 1.

TABLE 2

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −18.619 | −5.04E−02 | −9.00E−03 | −1.75E−04 | −7.50E−05 | −1.50E−05 | 2.00E−06 | 3.00E−06 | 9.00E−06 | −6.00E−06 |
| S2 | 90.000 | −1.27E−01 | −8.75E−03 | −4.22E−04 | −1.14E−04 | −1.00E−05 | −4.00E−06 | −4.00E−06 | −8.00E−06 | −1.40E−05 |
| S4 | −90.000 | −6.35E−03 | 1.22E−02 | −2.60E−03 | 5.02E−04 | −8.50E−05 | 2.20E−05 | −1.00E−05 | 3.00E−06 | −4.00E−06 |
| S5 | −47.456 | −9.36E−03 | 9.02E−03 | −1.81E−03 | 3.11E−04 | −4.10E−05 | 1.40E−05 | −9.00E−06 | 5.00E−06 | −4.00E−06 |
| S6 | −90.000 | −1.38E−01 | 1.23E−02 | −1.20E−05 | 4.85E−04 | −8.40E−05 | 6.30E−05 | −1.80E−05 | 1.00E−05 | −3.00E−06 |
| S7 | 0.330 | −2.94E−01 | 3.21E−02 | −1.31E−03 | 3.89E−04 | 1.57E−04 | −2.00E−05 | 4.00E−06 | −1.00E−06 | −4.00E−06 |
| S8 | 0.056 | 7.54E−01 | −1.93E−02 | 7.53E−03 | −2.05E−03 | 6.66E−04 | −6.30E−05 | −9.00E−06 | 2.90E−07 | −5.00E−06 |
| S9 | −2.338 | 4.66E−01 | −3.90E−02 | 8.86E−03 | −3.51E−03 | 9.07E−04 | −1.70E−04 | 1.00E−06 | −7.00E−06 | −6.00E−06 |
| S10 | 82.262 | −8.76E−02 | 8.70E−04 | −2.11E−03 | −1.06E−03 | −1.25E−04 | 6.30E−05 | −1.10E−05 | −8.00E−06 | −6.00E−06 |
| S11 | −0.460 | −6.76E−02 | −1.18E−02 | −2.79E−03 | −7.41E−04 | −1.25E−04 | −2.30E−05 | −4.00E−06 | −3.00E−06 | −4.00E−06 |
| S12 | 0.110 | −1.64E+00 | 1.46E−01 | −3.86E−02 | 7.13E−03 | −2.49E−03 | 4.65E−04 | −7.00E−06 | −2.80E−05 | −3.00E−06 |
| S13 | −0.248 | −1.79E+00 | 1.97E−01 | −4.53E−02 | 1.22E−02 | −3.84E−03 | 9.07E−04 | 2.70E−05 | 6.20E−05 | −2.40E−05 |
| S14 | −90.000 | −1.75E−01 | 3.45E−03 | −1.88E−02 | 5.14E−03 | −3.11E−03 | 7.85E−04 | −9.30E−05 | 1.75E−04 | −2.30E−05 |
| S15 | −0.658 | −4.29E−03 | −1.23E−02 | −5.23E−03 | −1.07E−03 | −2.37E−03 | −5.80E−05 | −1.66E−04 | 1.26E−04 | 9.00E−06 |
| S16 | −90.000 | 1.15E+00 | −1.12E−01 | 3.44E−02 | −7.82E−03 | 6.98E−04 | −3.30E−04 | −7.40E−05 | 1.25E−04 | −9.00E−06 |
| S17 | 0.026 | 2.79E+00 | −2.05E−01 | 1.08E−01 | −1.73E−02 | 1.15E−02 | −2.07E−03 | 1.35E−03 | −2.28E−04 | 1.23E−04 |

FIG. 4A illustrates a longitudinal aberration curve of the optical system 100 in the first state in Embodiment 1, representing deviations of focal points of light of different wavelengths converged after passing through the optical system 100. FIG. 4B illustrates an astigmatic curve of the optical system 100 in the first state in Embodiment 1, representing a curvature of a tangential image plane and a curvature of a sagittal image plane corresponding to different image heights. FIG. 4C illustrates a distortion curve of the optical system 100 in the first state in Embodiment 1, representing amounts of distortion corresponding to different image heights. It can be seen from FIG. 4A, FIG. 4B and FIG. 4C that the optical system 100 in Embodiment 1 can achieve a good imaging quality in the first state.

### Embodiment 2

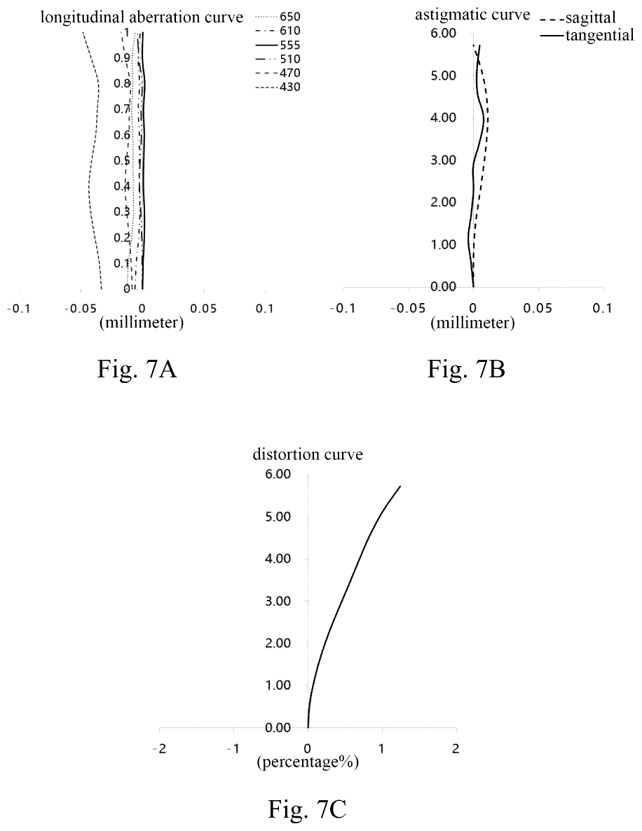

An optical system according to Embodiment 2 is described below with reference to FIG. 5, FIG. 6, FIG. 7A, FIG. 7B, and FIG. 7C.

As shown in FIG. 5 and FIG. 6, the optical system 200 may include a first element group G1, a second element group G2 and a third element group G3 arranged sequentially from an object side to an image side. The image side may be provided with, for example, an image plane IMA. The imageable object distance range of the optical system 200 may be from 17 cm to infinity. A magnification of the optical system 200 may be 2.5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 200 is decreased, adjusting the distance between the third element group G3 and the second element group G2 on the optical axis II enables the optical system 200 to switch between a first state and a second state to achieve a focusing function of the optical system 200. During the focusing process of the optical system 200, a maximal travelling distance of the third element group G3 may be 1.0216 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a convex surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a concave surface, and an image-side surface S11 of the fifth lens E5 is a convex surface. The sixth lens E6 may have a positive refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 3 shows a table of basic parameters of the optical system 200 in Embodiment 2. Here, the units of the radius of curvature and the thickness/distance are millimeters (mm).

TABLE 3

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 20.4211 | 0.8053 | plastic | 1.545 | 55.959 |
| S2 | | aspheric | 53.6398 | 2.2351 | | | |
| S3 | reflective | spherical | infinite | −2.6410 | glass | | |
| | element | | | | | | |
| S4 | second | aspheric | −15.0673 | −0.4500 | plastic | 1.561 | 44.050 |
| | lens | | | | | | |
| S5 | | aspheric | −12.1437 | −1.0483 | | | |
| STO | aperture | spherical | infinite | −0.1072 | | | |
| S6 | third lens | aspheric | −21.2267 | −1.3566 | plastic | 1.545 | 55.959 |
| S7 | | aspheric | 7.0586 | −0.0275 | | | |
| S8 | fourth lens | aspheric | −4.0695 | −0.6432 | plastic | 1.651 | 21.370 |
| S9 | | aspheric | −2.6604 | −1.2965 | | | |
| S10 | fifth lens | aspheric | 570.2050 | −1.7500 | plastic | 1.545 | 55.959 |
| S11 | | aspheric | 6.4135 | W1 | | | |
| S12 | sixth lens | aspheric | 3.7482 | −0.5000 | plastic | 1.611 | 24.728 |
| S13 | | aspheric | 3.8114 | −0.4222 | | | |
| S14 | seventh | aspheric | 10.1983 | −1.5000 | plastic | 1.671 | 19.400 |
| | lens | | | | | | |
| S15 | | aspheric | 8.1817 | −0.4683 | | | |
| S16 | eighth | aspheric | −80.7091 | −0.8622 | plastic | 1.539 | 45.148 |
| | lens | | | | | | |
| S17 | | aspheric | −4.4268 | W2 | | | |
| S18 | optical | spherical | infinite | −0.1343 | glass | 1.517 | 64.210 |
| | filter | | | | | | |
| S19 | | spherical | infinite | −0.2708 | | | |
| IMA | image | spherical | infinite | | | | |
| | plane | | | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 5 and FIG. 6.

Here, an on-axis distance W1 from the second element group G2 to the third element group G3, and an on-axis distance W2 from the third element group G3 to the optical filter E9 are variables, which may change as the distance between the photographed object and the optical system 200 changes.

When the photographed object is at infinity from the optical system 200, the optical system 200 is in the first state, and a structural diagram of the optical system 200 may be referred to in FIG. 5, where, W1=−1.0345 mm, W2=−4.5505 mm, an effective focal length of the optical system 200 EFL=15.19 mm, a maximal field-of-view of the optical system 200 FOV=41.72°, an aperture value of the optical system 200 in a first direction Fox=3.0, and an aperture value of the optical system 200 in a second direction Fnoy=4.25. When the photographed object is at a preset distance from the optical system 200, the optical system 200 is in the second state, and a structural diagram of the optical system 200 may be referred to in FIG. 6.

In this embodiment, the object-side surface and the image-side surface of any lens in the first lens E1 to the eighth lens E8 are both aspheric surfaces. Table 4 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 2.

TABLE 4

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −20.360 | −2.95E−02 | 4.11E−03 | 2.11E−04 | −2.40E−05 | −2.00E−06 | 2.00E−06 | 4.00E−06 | 1.00E−06 | −3.00E−06 |
| S2 | 90.000 | −9.59E−02 | 4.18E−03 | −6.40E−05 | −2.74E−04 | −1.64E−04 | −1.22E−04 | −7.30E−05 | −4.10E−05 | −1.30E−05 |
| S4 | −90.000 | −9.52E−03 | 6.14E−03 | −1.29E−03 | 2.16E−04 | −2.70E−05 | 1.30E−05 | −4.00E−06 | 2.00E−06 | −1.00E−06 |
| S5 | −42.684 | −1.36E−02 | 4.47E−03 | −8.37E−04 | 1.13E−04 | −1.20E−05 | 6.00E−06 | −3.00E−06 | 2.00E−06 | −6.15E−08 |
| S6 | −90.000 | −6.98E−02 | 4.46E−03 | −2.28E−04 | 1.44E−04 | −4.00E−05 | 9.00E−06 | −5.00E−06 | 4.00E−06 | 1.00E−06 |
| S7 | 0.535 | −1.55E−01 | 1.28E−02 | −3.69E−04 | −3.70E−05 | 6.60E−05 | −4.30E−05 | 2.40E−05 | −4.00E−06 | 3.00E−06 |
| S8 | 0.055 | 3.83E−01 | −1.28E−02 | 3.83E−03 | −8.86E−04 | 1.78E−04 | −5.30E−05 | 2.60E−05 | 1.00E−06 | 2.00E−06 |
| S9 | −2.344 | 2.52E−01 | −2.22E−02 | 5.27E−03 | −1.25E−03 | 2.38E−04 | −3.80E−05 | 1.80E−05 | 4.00E−06 | −2.00E−06 |
| S10 | 63.217 | −4.82E−02 | 6.13E−04 | 3.43E−04 | −1.40E−05 | −2.20E−05 | 2.00E−06 | 3.00E−06 | 4.00E−06 | 4.67E−07 |
| S11 | −0.520 | −3.93E−02 | −3.57E−03 | −1.42E−04 | −1.70E−05 | 9.00E−06 | −5.00E−06 | 3.00E−06 | 1.00E−06 | −4.36E−07 |
| S12 | 0.102 | −1.31E+00 | 1.15E−01 | −2.58E−02 | 5.66E−03 | −1.51E−03 | 1.72E−04 | 7.80E−05 | −4.70E−05 | 3.00E−06 |
| S13 | −0.247 | −1.48E+00 | 1.58E−01 | −3.51E−02 | 1.00E−02 | −2.80E−03 | 2.02E−04 | 5.00E−05 | 2.30E−05 | −1.70E−05 |
| S14 | −90.000 | −1.45E−01 | 9.26E−03 | −1.50E−02 | 4.77E−03 | −2.24E−03 | 6.70E−05 | −1.65E−04 | 1.16E−04 | −4.00E−06 |
| S15 | −1.083 | −9.45E−03 | −1.23E−02 | −3.75E−03 | −4.84E−04 | −1.03E−03 | −6.18E−04 | −4.25E−04 | 1.20E−05 | 5.00E−06 |
| S16 | −90.000 | 1.09E+00 | −1.08E−01 | 2.90E−02 | −5.83E−03 | 1.53E−03 | −7.60E−04 | −4.36E−04 | −1.90E−05 | −2.50E−05 |
| S17 | 0.015 | 2.80E+00 | −2.13E−01 | 1.06E−01 | −1.66E−02 | 1.08E−02 | −2.15E−03 | 1.39E−03 | −2.05E−04 | 1.14E−04 |

FIG. 7A illustrates a longitudinal aberration curve of the optical system 200 in the first state in Embodiment 2, representing deviations of focal points of light of different wavelengths converged after passing through the optical system 200. FIG. 7B illustrates an astigmatic curve of the optical system 200 in the first state in Embodiment 2, representing a curvature of a tangential image plane and a curvature of a sagittal image plane corresponding to different image heights. FIG. 7C illustrates a distortion curve of the optical system 200 in the first state in Embodiment 2, representing amounts of distortion corresponding to different image heights. It can be seen from FIG. 7A, FIG. 7B and FIG. 7C that the optical system 200 in Embodiment 2 can achieve a good imaging quality in the first state.

### Embodiment 3

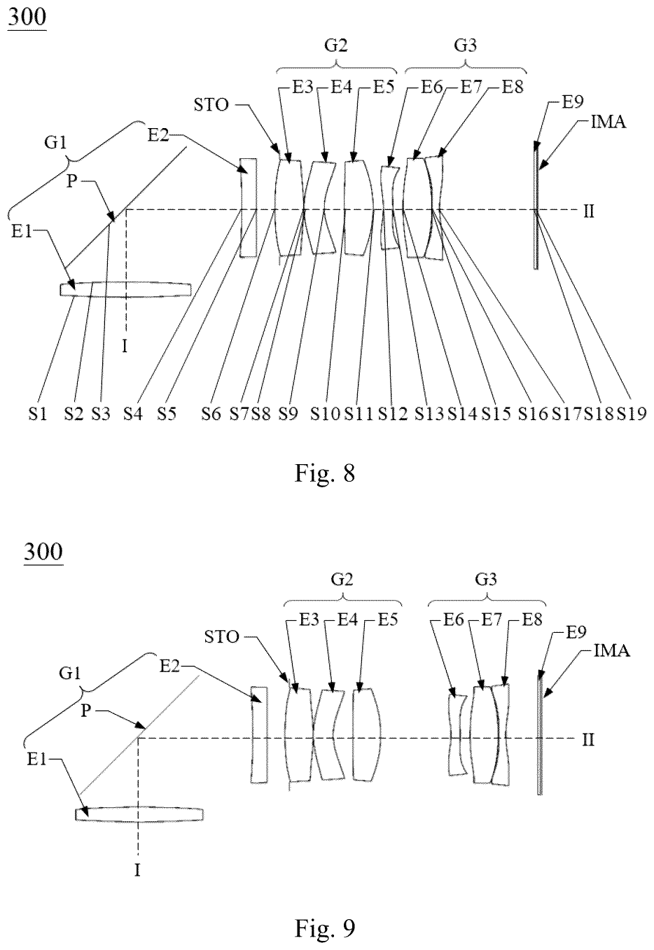

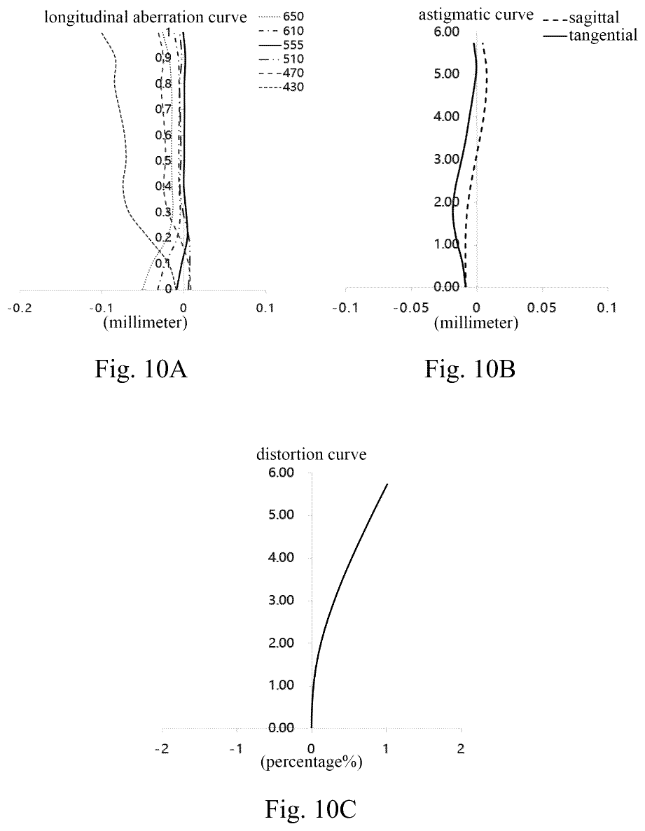

An optical system according to Embodiment 3 is described below with reference to FIG. 8, FIG. 9, FIG. 10A, FIG. 10B, and FIG. 10C.

As shown in FIG. 8 and FIG. 9, the optical system 300 may include a first element group G1, a second element group G2 and a third element group G3 arranged sequentially from an object side to an image side. The image side may be provided with, for example, an image plane IMA. The imageable object distance range of the optical system 300 may be from 10 cm to infinity. A magnification of the optical system 300 may be 5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 300 is decreased, adjusting the distance between the third element group G3 and the second element group G2 on the optical axis II enables the optical system 300 to switch between a first state and a second state to achieve a focusing function of the optical system 300. During the focusing of the optical system 300, a maximal travelling distance of the third element group G3 may be 6.4288 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a convex surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 5 shows a table of basic parameters of the optical system 300 in Embodiment 3. Here, the units of the radius of curvature and the thickness/distance are millimeters (mm).

TABLE 5

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 92.3130 | 1.5838 | plastic | 1.543 | 56.021 |
| S2 | | aspheric | −103.1260 | 7.6799 | | | |
| S3 | reflective | spherical | infinite | −12.0882 | glass | | |
| | element | | | | | | |
| S4 | second | aspheric | 71.2641 | −1.5300 | plastic | 1.671 | 19.400 |
| | lens | | | | | | |
| S5 | | aspheric | −3104.7700 | −2.4197 | | | |
| STO | aperture | spherical | infinite | 1.1668 | | | |
| S6 | third lens | aspheric | −37.4329 | −3.0000 | plastic | 1.545 | 55.959 |
| S7 | | aspheric | 16.7353 | −0.0300 | | | |
| S8 | fourth lens | aspheric | −7.9781 | −2.1103 | plastic | 1.671 | 19.400 |
| S9 | | aspheric | −5.2090 | −2.0777 | | | |
| S10 | fifth lens | aspheric | −61.1234 | −3.0000 | plastic | 1.545 | 55.959 |
| S11 | | aspheric | 11.6270 | W1 | | | |
| S12 | sixth lens | aspheric | 6.9703 | −0.9838 | plastic | 1.633 | 24.273 |
| S13 | | aspheric | 17.9470 | −1.0531 | | | |
| S14 | seventh | aspheric | −20.3522 | −3.0000 | plastic | 1.671 | 19.400 |
| | lens | | | | | | |
| S15 | | aspheric | 20.4668 | −0.0525 | | | |
| S16 | eighth | aspheric | −55.7231 | −0.7530 | plastic | 1.538 | 42.586 |
| | lens | | | | | | |
| S17 | | aspheric | −7.5258 | W2 | | | |
| S18 | optical | spherical | infinite | −0.2801 | glass | 1.517 | 64.210 |
| | filter | | | | | | |
| S19 | | spherical | infinite | −0.1245 | | | |
| IMA | image | spherical | infinite | | | | |
| | plane | | | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 8 and FIG. 9.

Here, an on-axis distance W1 from the second element group G2 to the third element group G3, and an on-axis distance W2 from the third element group G3 to the optical filter E9 are variables, which may change as the distance between the photographed object and the optical system 300 changes.

When the photographed object is at infinity from the optical system 300, the optical system 300 is in the first state, and a structural diagram of the optical system 300 may be referred to in FIG. 8, where, W1=−1.0671 mm, W2=−9.8559 mm, an effective focal length of the optical system 300 EFL=31.70 mm, a maximal field-of-view of the optical system 300 FOV=20.3122°, an aperture value of the optical system 300 in a first direction Fnox=1.71, and an aperture value of the optical system 300 in a second direction Fnoy=2.44. When the photographed object is at a preset distance from the optical system 300, the optical system 300 is in the second state, and a structural diagram of the optical system 300 may be referred to in FIG. 9.

In this embodiment, the object-side surface and the image-side surface of any lens in the first lens E1 to the eighth lens E8 are both aspheric surfaces. Table 6 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 3.

TABLE 6

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −26.287 | −2.94E−01 | −7.01E−02 | −1.40E−02 | −2.94E−03 | −7.75E−04 | −1.25E−04 | −4.40E−05 | −2.20E−05 | −1.30E−05 |
| S2 | 90.000 | −1.65E−01 | −5.69E−02 | −1.03E−02 | −2.04E−03 | −4.82E−04 | −4.70E−05 | −2.10E−05 | −1.80E−05 | −6.00E−06 |
| S4 | −90.000 | 6.40E−02 | 3.60E−04 | −1.53E−03 | 8.66E−04 | −3.30E−04 | −1.25E−04 | 3.20E−05 | 3.70E−05 | 1.00E−06 |
| S5 | 90.000 | −2.28E−02 | 4.24E−03 | −1.65E−03 | 8.16E−04 | −2.16E−04 | −1.08E−04 | 6.00E−06 | 2.50E−05 | −1.00E−06 |
| S6 | −90.000 | −1.00E+00 | 2.12E−01 | 2.47E−02 | 1.51E−02 | −1.58E−04 | 9.90E−05 | −5.49E−04 | −3.37E−08 | −7.20E−05 |
| S7 | −0.027 | −1.32E+00 | 3.22E−01 | 5.52E−03 | 7.55E−03 | −4.44E−03 | −1.26E−03 | 3.81E−04 | 1.62E−04 | −1.18E−04 |
| S8 | 0.056 | 3.27E+00 | 3.38E−02 | 3.44E−02 | −5.21E−03 | 3.29E−03 | −1.16E−03 | 1.31E−03 | 3.86E−04 | −2.07E−04 |
| S9 | −2.447 | 1.64E+00 | −1.88E−01 | 2.67E−02 | −1.92E−02 | 5.31E−03 | −1.20E−03 | 1.56E−03 | −2.74E−04 | −2.64E−04 |
| S10 | −90.000 | 3.95E−02 | −1.67E−01 | −2.80E−02 | −1.27E−02 | 7.73E−04 | 2.00E−03 | 6.14E−04 | −3.12E−04 | −2.90E−04 |
| S11 | −0.549 | −3.38E−01 | −1.22E−01 | −2.39E−02 | −9.04E−03 | −1.44E−03 | 1.23E−04 | 1.57E−04 | −7.20E−05 | 6.10E−05 |
| S12 | −0.249 | −3.13E+00 | 3.86E−01 | −9.76E−02 | 2.01E−02 | −6.25E−03 | 1.10E−03 | −4.52E−04 | −7.80E−05 | 4.00E−06 |
| S13 | −12.361 | −2.07E+00 | 1.77E−01 | −3.64E−02 | 5.98E−03 | −1.12E−03 | −1.14E−04 | −1.08E−04 | −1.08E−04 | −3.80E−05 |
| S14 | −90.000 | −1.60E−01 | 7.78E−02 | 2.55E−02 | 1.40E−02 | 3.73E−03 | 1.81E−03 | 4.05E−04 | 1.58E−04 | 2.40E−05 |
| S15 | 7.032 | 1.39E−01 | −1.93E−02 | 1.53E−02 | −6.87E−03 | −1.03E−03 | −2.39E−04 | −9.39E−04 | 5.75E−04 | −5.40E−05 |
| S16 | −90.000 | 1.31E+00 | −4.17E−01 | 2.01E−02 | −2.65E−02 | 6.55E−03 | 8.14E−04 | −2.97E−04 | 8.54E−04 | −2.95E−04 |
| S17 | 0.028 | 2.32E+00 | −3.19E−01 | 5.61E−02 | −2.39E−02 | 3.74E−03 | −2.76E−03 | −1.03E−04 | −3.27E−04 | −1.75E−04 |

FIG. 10A illustrates a longitudinal aberration curve of the optical system 300 in the first state in Embodiment 3, representing deviations of focal points of light of different wavelengths converged after passing through the optical system 300. FIG. 10B illustrates an astigmatic curve of the optical system 300 in the first state in Embodiment 3, representing a curvature of a tangential image plane and a curvature of a sagittal image plane corresponding to different image heights. FIG. 10C illustrates a distortion curve of the optical system 300 in the first state in Embodiment 3, representing amounts of distortion corresponding to different image heights. It can be seen from FIG. 10A, FIG. 10B and FIG. 10C that the optical system 300 in Embodiment 3 can achieve a good imaging quality in the first state.

### Embodiment 4

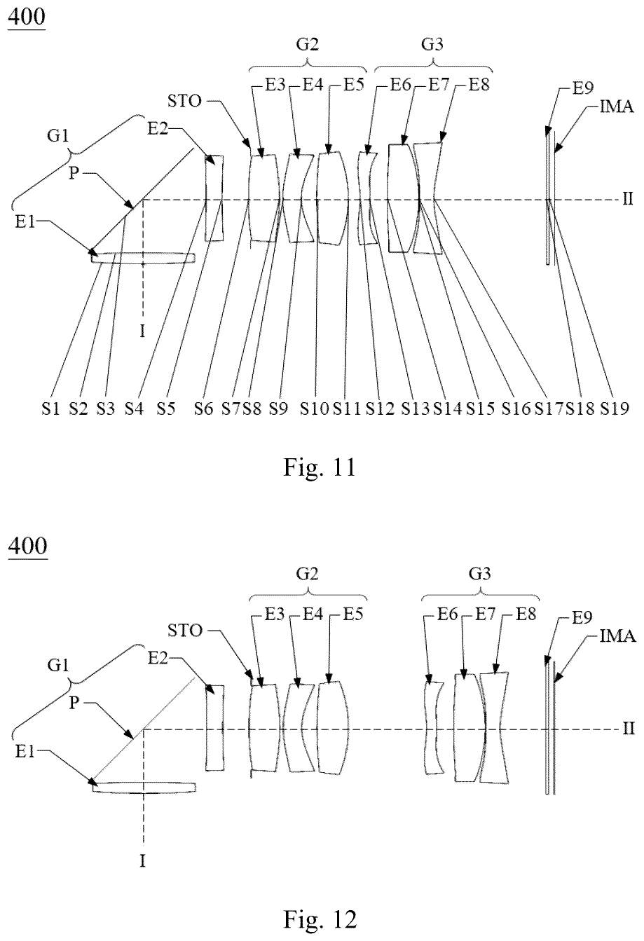

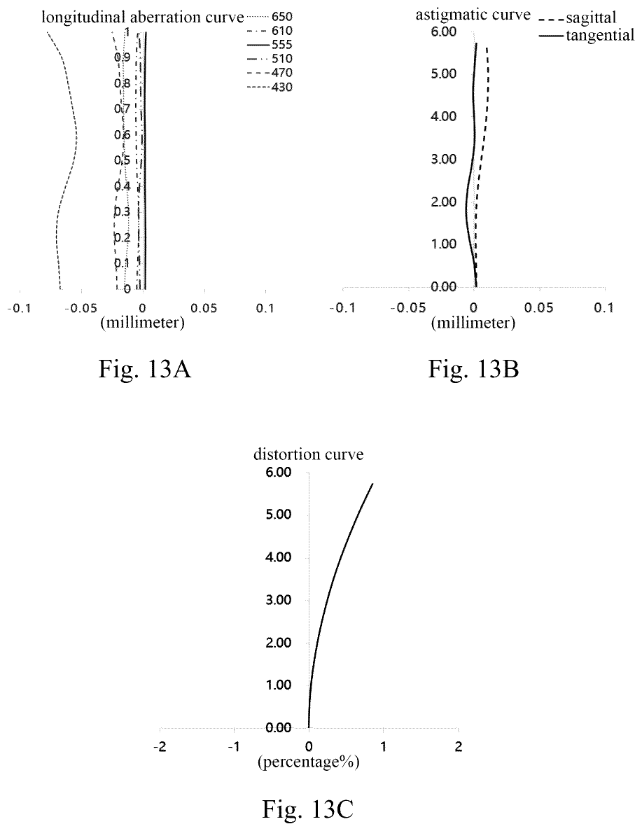

An optical system according to Embodiment 4 is described below with reference to FIG. 11, FIG. 12, FIG. 13A, FIG. 13B, and FIG. 13C.

As shown in FIG. 11 and FIG. 12, the optical system 400 may include a first element group G1, a second element group G2 and a third element group G3 arranged sequentially from an object side to an image side. The image side may be provided with, for example, an image plane IMA. The imageable object distance range of the optical system 400 may be from 10 cm to infinity. A magnification of the optical system 400 may be 5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 400 is decreased, adjusting the distance between the third element group G3 and the second element group G2 on the optical axis II enables the optical system 400 to switch between a first state and a second state to achieve a focusing function of the optical system 400. During the focusing of the optical system 400, a maximal travelling distance of the third element group G3 may be 6.3414 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a convex surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 7 shows a table of basic parameters of the optical system 400 in Embodiment 4. Here, the units of the radius of curvature and the thickness/distance are millimeters (mm).

TABLE 7

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 62.7938 | 1.0529 | plastic | 1.544 | 55.990 |
| S2 | | aspheric | −127.2400 | 5.1782 | | | |
| S3 | reflective element | spherical | infinite | −5.9696 | glass | | |
| S4 | second lens | aspheric | 129.0150 | −1.5300 | plastic | 1.560 | 44.576 |
| S5 | | aspheric | −66.9068 | −2.7045 | | | |
| STO | aperture | spherical | infinite | 0.4092 | | | |
| S6 | third lens | aspheric | −30.7474 | −2.9567 | plastic | 1.534 | 56.329 |
| S7 | | aspheric | 13.7363 | −0.3135 | | | |
| S8 | fourth lens | aspheric | −8.4430 | −1.7602 | plastic | 1.640 | 23.263 |
| S9 | | aspheric | −4.5737 | −1.4651 | | | |
| S10 | fifth lens | aspheric | −32.6528 | −3.0000 | plastic | 1.543 | 56.014 |
| S11 | | aspheric | 11.6365 | W1 | | | |
| S12 | sixth lens | aspheric | 8.1650 | −0.9520 | plastic | 1.596 | 31.059 |
| S13 | | aspheric | 14.3544 | −1.6415 | | | |
| S14 | seventh lens | aspheric | −255.2270 | −3.0000 | plastic | 1.671 | 19.400 |
| S15 | | aspheric | 12.6167 | −0.0500 | | | |
| S16 | eighth lens | aspheric | −126.0100 | −1.3686 | plastic | 1.570 | 31.760 |
| S17 | | aspheric | −7.0880 | W2 | | | |
| S18 | optical filter | spherical | infinite | −0.2801 | glass | 1.517 | 64.210 |
| S19 | | spherical | infinite | −0.5130 | | | |
| IMA | image plane | spherical | infinite | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 11 and FIG. 12.

Here, an on-axis distance W1 from the second element group G2 to the third element group G3, and an on-axis distance W2 from the third element group G3 to the optical filter E9 are variables, which may change as the distance between the photographed object and the optical system 400 changes.

When the photographed object is at infinity from the optical system 400, the optical system 400 is in the first state, and a structural diagram of the optical system 400 may be referred to in FIG. 11, where, W1=−1.1220 mm, W2=−10.7125 mm, an effective focal length of the optical system 400 EFL=31.70 mm, a maximal field-of-view of the optical system 400 FOV=20.3122°, an aperture value of the optical system 400 in a first direction Fnox=2.34, and an aperture value of the optical system 400 in a second direction Fnoy=3.35. When the photographed object is at a preset distance from the optical system 400, the optical system 400 is in the second state, and a structural diagram of the optical system 400 may be referred to in FIG. 12.

In this embodiment, the object-side surface and the image-side surface of any lens in the first lens E1 to the eighth lens E8 are both aspheric surfaces. Table 8 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 4.

TABLE 8

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −52.355 | −5.20E−02 | −1.03E−02 | −1.12E−03 | −2.90E−04 | −9.80E−05 | −1.30E−05 | −8.00E−06 | 6.00E−06 | −3.61E−08 |
| S2 | 90.000 | −6.18E−02 | −7.99E−03 | −1.14E−03 | −2.88E−04 | −9.30E−05 | −1.10E−05 | −5.00E−06 | 6.00E−06 | −1.00E−06 |
| S4 | −90.000 | 3.64E−02 | 2.36E−04 | −3.01E−04 | 9.00E−06 | 6.80E−05 | −3.10E−05 | 3.51E−07 | 4.00E−06 | −3.00E−06 |
| S5 | −52.916 | −8.86E−03 | 1.30E−03 | −3.53E−04 | 4.20E−05 | 4.90E−05 | −3.90E−05 | 1.00E−06 | 1.00E−06 | −1.00E−06 |
| S6 | −90.000 | −4.06E−01 | 6.00E−02 | −2.93E−03 | 3.29E−03 | −4.16E−04 | 2.51E−04 | −2.10E−05 | −6.00E−06 | 4.00E−06 |
| S7 | 0.274 | −7.44E−01 | 1.06E−01 | −8.77E−03 | 6.05E−03 | −1.23E−03 | 5.71E−04 | −1.83E−04 | 1.70E−05 | 2.00E−06 |
| S8 | 0.057 | 1.62E+00 | −5.64E−02 | 1.81E−02 | −2.18E−03 | 1.40E−03 | −3.40E−04 | −1.20E−04 | 3.00E−05 | −1.10E−05 |
| S9 | −2.336 | 9.48E−01 | −9.59E−02 | 3.00E−02 | −1.15E−02 | 3.95E−03 | −2.02E−03 | 3.48E−04 | 3.20E−05 | −5.00E−06 |
| S10 | −79.556 | −9.55E−02 | −2.18E−02 | −1.38E−02 | −9.45E−03 | 7.00E−06 | −6.49E−04 | −8.10E−05 | 1.81E−04 | −2.10E−05 |
| S11 | −0.293 | −7.20E−02 | −4.99E−02 | −1.71E−02 | −7.05E−03 | −1.53E−03 | −5.16E−04 | −1.07E−04 | −1.00E−06 | −1.40E−05 |
| S12 | −0.041 | −2.42E+00 | 2.94E−01 | −6.46E−02 | 1.44E−02 | −3.06E−03 | 4.67E−04 | −1.01E−04 | −1.10E−05 | 8.00E−06 |
| S13 | −9.564 | −2.05E+00 | 2.02E−01 | −4.47E−02 | 7.30E−03 | −5.89E−04 | −9.00E−05 | −5.40E−05 | −4.10E−05 | −1.10E−05 |
| S14 | −90.000 | −1.61E−01 | 1.02E−01 | 1.60E−03 | 5.27E−03 | 8.60E−05 | 2.34E−04 | −2.10E−04 | −8.00E−06 | −2.60E−05 |
| S15 | −0.491 | −2.58E−02 | 4.68E−02 | 7.07E−04 | −5.76E−03 | 1.57E−03 | −2.30E−03 | 2.40E−04 | 2.38E−04 | −6.00E−05 |
| S16 | −90.000 | 9.49E−01 | −3.49E−01 | 3.37E−02 | −2.05E−02 | 7.24E−03 | −2.99E−03 | 1.43E−03 | 2.10E−04 | −2.21E−04 |
| S17 | 0.095 | 2.09E+00 | −2.27E−01 | 5.97E−02 | −1.59E−02 | 4.01E−03 | −1.68E−03 | 3.84E−04 | −1.15E−04 | −9.00E−06 |

FIG. 13A illustrates a longitudinal aberration curve of the optical system 400 in the first state in Embodiment 4, representing deviations of focal points of light of different wavelengths converged after passing through the optical system 400. FIG. 13B illustrates an astigmatic curve of the optical system 400 in the first state in Embodiment 4, representing a curvature of a tangential image plane and a curvature of a sagittal image plane corresponding to different image heights. FIG. 13C illustrates a distortion curve of the optical system 400 in the first state in Embodiment 4, representing amounts of distortion corresponding to different image heights. It can be seen from FIG. 13A, FIG. 13B and FIG. 13C that the optical system 400 in Embodiment 4 can achieve a good imaging quality in the first state.

### Embodiment 5

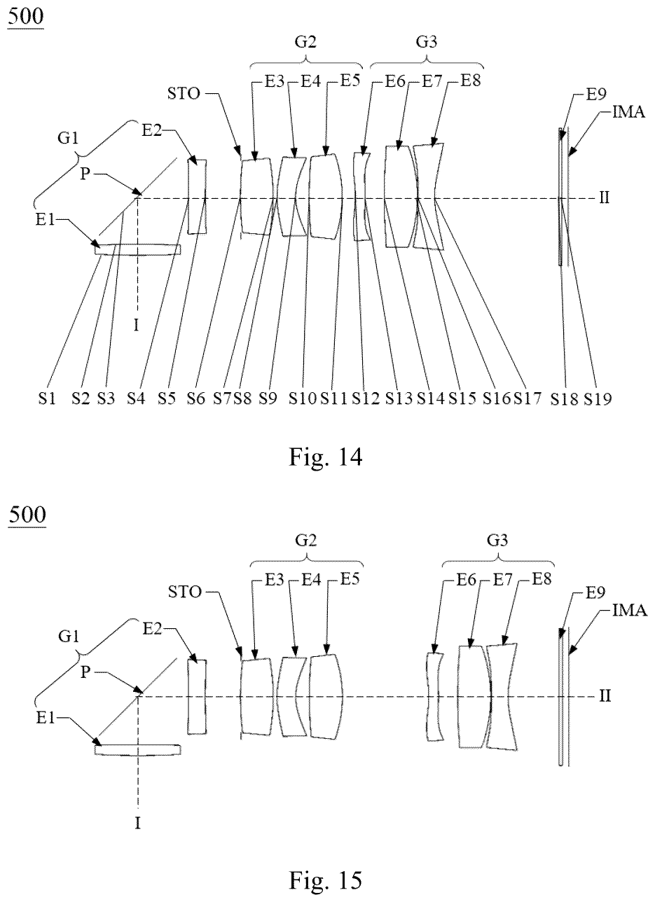

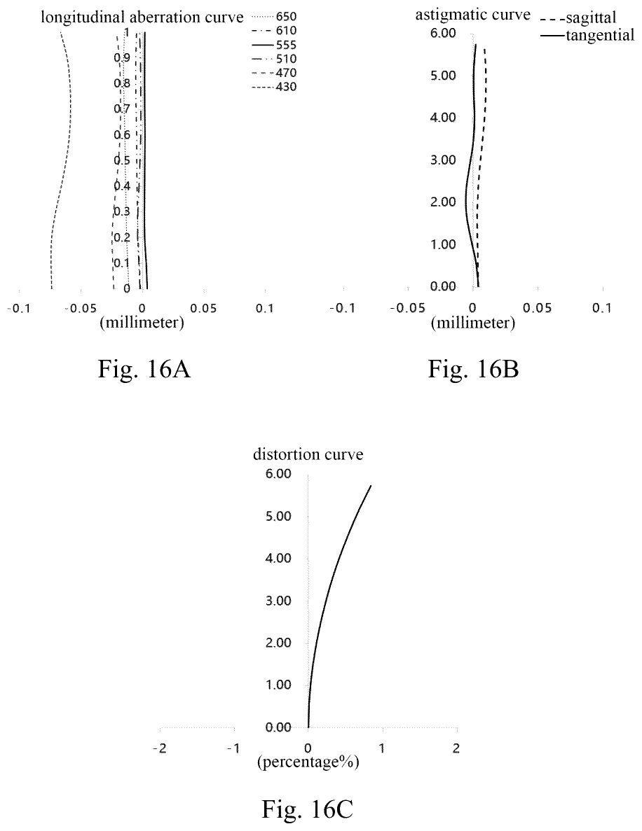

An optical system according to Embodiment 5 is described below with reference to FIG. 14, FIG. 15, FIG. 16A, FIG. 16B, and FIG. 16C.

As shown in FIG. 14 and FIG. 15, the optical system 500 may include a first element group G1, a second element group G2 and a third element group G3 arranged sequentially from an object side to an image side. The image side may be provided with, for example, an image plane IMA. The imageable object distance range of the optical system 500 may be from 10 cm to infinity. A magnification of the optical system 500 may be 5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 500 is decreased, adjusting the distance between the third element group G3 and the second element group G2 on the optical axis II enables the optical system 500 to switch between a first state and a second state to achieve a focusing function of the optical system 500. During the focusing of the optical system 500, a maximal travelling distance of the third element group G3 may be 6.6345 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a convex surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 9 shows a table of basic parameters of the optical system 500 in Embodiment 5. Here, the units of the radius of curvature and the thickness/distance are millimeters (mm).

TABLE 9

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 63.1698 | 1.0000 | plastic | 1.531 | 56.444 |
| S2 | | aspheric | −125.2830 | 4.3424 | | | |
| S3 | reflective element | spherical | infinite | −4.6075 | glass | | |
| S4 | second lens | aspheric | 142.6930 | −1.5300 | plastic | 1.535 | 56.292 |
| S5 | | aspheric | −69.7481 | −3.2428 | | | |
| STO | aperture | spherical | infinite | 0.1547 | | | |
| S6 | third lens | aspheric | −30.5929 | −2.9877 | plastic | 1.527 | 56.594 |
| S7 | | aspheric | 13.7406 | −0.3450 | | | |
| S8 | fourth lens | aspheric | −8.6004 | −1.6886 | plastic | 1.638 | 23.565 |
| S9 | | aspheric | −4.5616 | −1.2331 | | | |
| S10 | fifth lens | aspheric | −36.1566 | −3.0000 | plastic | 1.539 | 56.149 |
| S11 | | aspheric | 11.3703 | W1 | | | |
| S12 | sixth lens | aspheric | 8.3550 | −0.8829 | plastic | 1.597 | 30.761 |
| S13 | | aspheric | 13.8767 | −1.7513 | | | |
| S14 | seventh lens | aspheric | −264.6680 | −3.0000 | plastic | 1.669 | 19.546 |
| S15 | | aspheric | 12.2423 | −0.0500 | | | |
| S16 | eighth lens | aspheric | −105.6970 | −1.5127 | plastic | 1.580 | 30.765 |
| S17 | | aspheric | −6.8457 | W2 | | | |
| S18 | optical filter | spherical | infinite | −0.2801 | glass | 1.517 | 64.210 |
| S19 | | spherical | infinite | −0.5808 | | | |
| IMA | image plane | spherical | infinite | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 14 and FIG. 15.

Here, an on-axis distance W1 from the second element group G2 to the third element group G3, and an on-axis distance W2 from the third element group G3 to the optical filter E9 are variables, which may change as the distance between the photographed object and the optical system 500 changes.

When the photographed object is at infinity from the optical system 500, the optical system 500 is in the first state, and a structural diagram of the optical system 500 may be referred to in FIG. 14, where, W1=−1.2040 mm, W2=−11.2879 mm, an effective focal length of the optical system 500 EFL=31.70 mm, a maximal field-of-view of the optical system 500 FOV=20.3122°, an aperture value of the optical system 500 in a first direction Fnox=3.00, and an aperture value of the optical system 500 in a second direction Fnoy=4.25. When the photographed object is at a preset distance from the optical system 500, the optical system 500 is in the second state, and a structural diagram of the optical system 500 may be referred to in FIG. 15.

In this embodiment, the object-side surface and the image-side surface of any lens in the first lens E1 to the eighth lens E8 are both aspheric surfaces. Table 10 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 5.

TABLE 10

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −60.821 | −1.53E−02 | −1.26E−03 | −6.50E−05 | 1.10E−05 | −1.10E−05 | −2.00E−06 | −1.28E−07 | 1.00E−06 | 1.00E−06 |
| S2 | 90.000 | −2.08E−02 | −4.24E−04 | −9.70E−05 | 1.30E−05 | −1.10E−05 | −2.00E−06 | 1.00E−06 | 1.37E−08 | 1.00E−06 |
| S4 | −90.000 | 1.04E−02 | −2.78E−04 | 1.69E−04 | −8.10E−05 | 2.40E−05 | −1.10E−05 | −2.00E−06 | −1.00E−06 | 2.00E−06 |
| S5 | −45.563 | −8.93E−03 | 1.46E−04 | 1.14E−04 | −7.50E−05 | 1.50E−05 | −1.10E−05 | 1.00E−06 | −1.00E−06 | 4.00E−06 |
| S6 | −90.000 | −2.10E−01 | 2.26E−02 | −2.69E−03 | 8.69E−04 | −2.38E−04 | 6.30E−05 | 9.00E−06 | −5.00E−06 | 1.00E−06 |
| S7 | 0.269 | −4.39E−01 | 4.77E−02 | −6.79E−03 | 2.33E−03 | −7.78E−04 | 4.32E−04 | −6.10E−05 | −1.70E−05 | 2.00E−06 |
| S8 | 0.040 | 9.31E−01 | −4.03E−02 | 8.34E−03 | −1.57E−03 | 5.76E−04 | 9.10E−05 | −1.64E−04 | −6.90E−05 | −2.00E−06 |
| S9 | −2.354 | 6.03E−01 | −6.48E−02 | 2.05E−02 | −6.49E−03 | 2.80E−03 | −1.14E−03 | −4.90E−05 | −3.80E−05 | 2.10E−05 |
| S10 | −67.816 | −6.96E−02 | −1.13E−02 | 1.41E−03 | −3.44E−03 | 1.22E−03 | −5.53E−04 | −1.72E−04 | 4.60E−05 | −1.70E−05 |
| S11 | −0.503 | −3.76E−02 | −2.15E−02 | −4.91E−03 | −1.83E−03 | 4.90E−05 | −3.20E−05 | 6.80E−05 | 5.70E−05 | −2.00E−06 |
| S12 | −0.042 | −1.84E+00 | 2.14E−01 | −4.06E−02 | 8.49E−03 | −1.28E−03 | −1.06E−04 | −3.00E−05 | −7.00E−05 | −1.00E−06 |
| S13 | −9.193 | −1.65E+00 | 1.62E−01 | −3.04E−02 | 4.98E−03 | 3.88E−04 | −2.62E−04 | −2.50E−05 | −7.70E−05 | −2.50E−05 |
| S14 | −90.000 | −1.72E−01 | 7.76E−02 | −3.81E−03 | 3.83E−03 | 8.21E−04 | 3.20E−04 | −6.10E−05 | −2.40E−05 | −2.90E−05 |
| S15 | −0.604 | −4.25E−02 | 3.87E−02 | 1.35E−03 | −2.68E−03 | 2.58E−03 | −1.85E−03 | 3.20E−05 | −5.50E−05 | −6.00E−06 |
| S16 | −90.000 | 8.46E−01 | −2.50E−01 | 3.09E−02 | −1.43E−02 | 4.38E−03 | −2.63E−03 | 4.94E−04 | 4.50E−05 | −1.50E−05 |
| S17 | 0.069 | 1.83E+00 | −1.78E−01 | 4.91E−02 | −1.11E−02 | 2.86E−03 | −9.49E−04 | 2.05E−04 | −4.30E−05 | −1.10E−05 |

FIG. 16A illustrates a longitudinal aberration curve of the optical system 500 in the first state in Embodiment 5, representing deviations of focal points of light of different wavelengths converged after passing through the optical system 500. FIG. 16B illustrates an astigmatic curve of the optical system 500 in the first state in Embodiment 5, representing a curvature of a tangential image plane and a curvature of a sagittal image plane corresponding to different image heights. FIG. 16C illustrates a distortion curve of the optical system 500 in the first state in Embodiment 5, representing amounts of distortion corresponding to different image heights. It can be seen from FIG. 16A, FIG. 16B and FIG. 16C that the optical system 500 in Embodiment 5 can achieve a good imaging quality in the first state.

### Embodiment 6

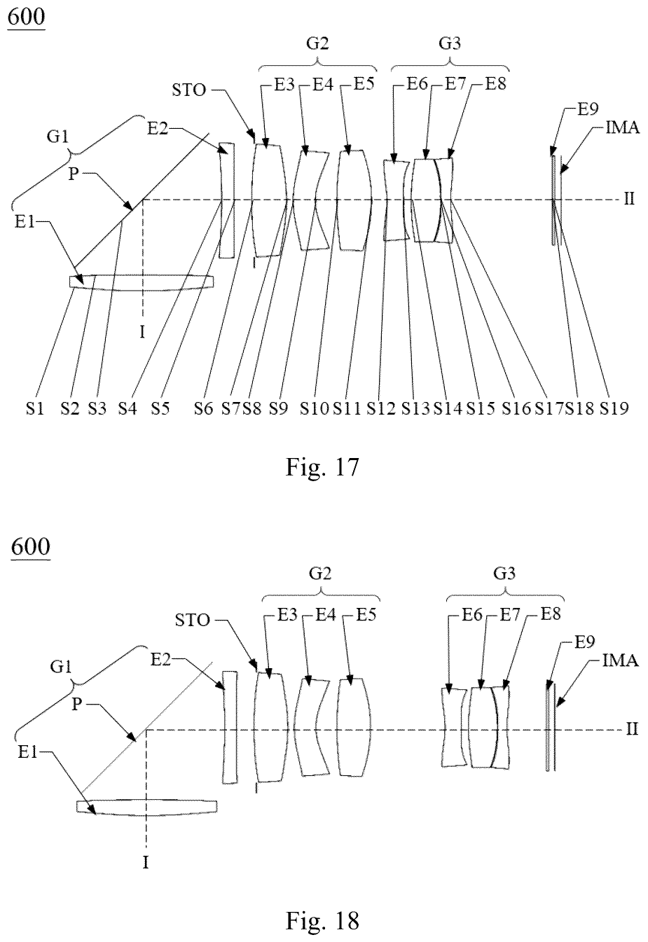

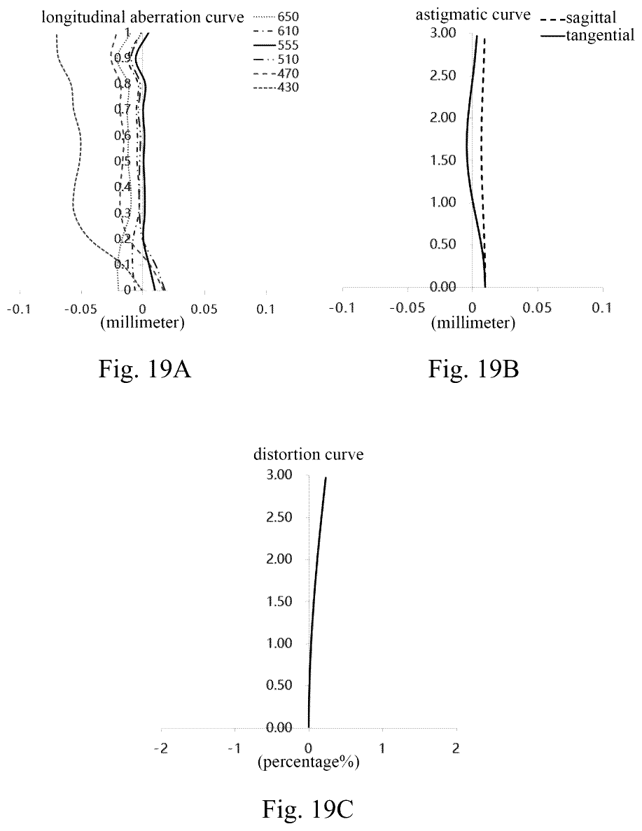

An optical system according to Embodiment 6 is described below with reference to FIG. 17, FIG. 18, FIG. 19A, FIG. 19B, and FIG. 19C.

As shown in FIG. 17 and FIG. 18, the optical system 600 may include a first element group G1, a second element group G2 and a third element group G3 arranged sequentially from an object side to an image side. The image side may be provided with, for example, an image plane IMA. The imageable object distance range of the optical system 600 may be from 10 cm to infinity. A magnification of the optical system 600 may be 8×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 600 is decreased, adjusting the distance between the third element group G3 and the second element group G2 on the optical axis II enables the optical system 600 to switch between a first state and a second state to achieve a focusing function of the optical system 600. During the focusing of the optical system 600, a maximal travelling distance of the third element group G3 may be 4.9412 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a convex surface, and an image-side surface S15 of the seventh lens E7 is a convex surface. The eighth lens E8 may have a negative refractive power, an object-side surface S16 of the eighth lens E8 is a concave surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 11 shows a table of basic parameters of the optical system 600 in Embodiment 6. Here, the units of the radius of curvature and the thickness/distance are millimeters (mm).

TABLE 11

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 44.9365 | 1.3000 | plastic | 1.545 | 55.959 |
| S2 | | aspheric | −192.9740 | 5.9881 | | | |
| S3 | reflective element | spherical | infinite | −6.4518 | glass | | |
| S4 | second lens | aspheric | 46.6005 | −1.0000 | plastic | 1.573 | 31.104 |
| S5 | | aspheric | 380.5280 | −1.6334 | | | |
| STO | aperture | spherical | infinite | 0.3834 | | | |
| S6 | third lens | aspheric | −43.4271 | −2.8000 | plastic | 1.545 | 55.959 |
| S7 | | aspheric | 11.9330 | −0.5371 | | | |
| S8 | fourth lens | aspheric | −7.2353 | −1.7890 | plastic | 1.647 | 21.186 |
| S9 | | aspheric | −4.0512 | −1.7356 | | | |
| S10 | fifth lens | aspheric | −21.2986 | −2.8000 | plastic | 1.545 | 55.959 |
| S11 | | aspheric | 11.2934 | W1 | | | |
| S12 | sixth lens | aspheric | 6.7636 | −1.3415 | plastic | 1.595 | 27.696 |
| S13 | | aspheric | 36.6210 | −0.6169 | | | |
| S14 | seventh lens | aspheric | −20.0133 | −2.3863 | plastic | 1.671 | 19.400 |
| S15 | | aspheric | 9.8665 | −0.0300 | | | |
| S16 | eighth lens | aspheric | 24.5430 | −0.7733 | plastic | 1.578 | 30.008 |
| S17 | | aspheric | −9.0249 | W2 | | | |
| S18 | optical filter | spherical | infinite | −0.2100 | glass | 1.517 | 64.210 |
| S19 | | spherical | infinite | −0.4941 | | | |
| IMA | image plane | spherical | infinite | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 17 and FIG. 18.

Here, an on-axis distance W1 from the second element group G2 to the third element group G3, and an on-axis distance W2 from the third element group G3 to the optical filter E9 are variables, which may change as the distance between the photographed object and the optical system 600 changes.

When the photographed object is at infinity from the optical system 600, the optical system 600 is in the first state, and a structural diagram of the optical system 600 may be referred to in FIG. 17, where, W1=−1.2363 mm, W2=−8.1944 mm, an effective focal length of the optical system 600 EFL=27.73 mm, a maximal field-of-view of the optical system 600 FOV=12.3122°, an aperture value of the optical system 600 in a first direction Fnox=1.71, and an aperture value of the optical system 600 in a second direction Fnoy=2.44. When the photographed object is at a preset distance from the optical system 600, the optical system 600 is in the second state, and a structural diagram of the optical system 600 may be referred to in FIG. 18.

In this embodiment, the object-side surface and the image-side surface of any lens in the first lens E1 to the eighth lens E8 are both aspheric surfaces. Table 12 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 6.

TABLE 12

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −28.924 | −2.30E−01 | −9.61E−02 | −2.37E−02 | −5.44E−03 | −1.84E−03 | −6.16E−04 | −3.39E−04 | −1.66E−04 | −3.70E−05 |
| S2 | 90.000 | −3.26E−01 | −9.11E−02 | −2.32E−02 | −4.84E−03 | −1.74E−03 | −5.70E−04 | −3.13E−04 | −1.37E−04 | −1.40E−05 |
| S4 | −90.000 | −1.02E−02 | −4.50E−03 | 1.75E−03 | −2.12E−03 | 1.25E−03 | −4.87E−04 | 1.71E−04 | −2.30E−05 | −2.00E−05 |
| S5 | −90.000 | −1.85E−01 | 8.07E−03 | 1.00E−05 | −1.68E−03 | 1.11E−03 | −4.41E−04 | 1.53E−04 | −2.70E−05 | −2.10E−05 |
| S6 | −90.000 | −4.51E−01 | 1.47E−01 | −9.65E−03 | −1.64E−03 | −3.99E−03 | 1.57E−04 | −6.40E−05 | 3.10E−05 | −1.30E−05 |
| S7 | 0.244 | −1.07E+00 | 1.88E−01 | −3.70E−02 | 4.97E−04 | −3.13E−03 | 4.42E−04 | −6.80E−05 | −6.20E−05 | −1.10E−05 |
| S8 | 0.052 | 2.45E+00 | −8.93E−02 | 2.00E−02 | −6.70E−03 | 4.12E−03 | −2.47E−04 | 1.53E−04 | 1.10E−04 | −5.90E−05 |
| S9 | −2.403 | 1.13E+00 | −1.55E−01 | 2.28E−02 | −1.40E−02 | 4.73E−03 | −8.66E−04 | 6.64E−04 | 1.69E−04 | −4.90E−05 |
| S10 | −90.000 | −2.85E−01 | −6.22E−02 | −3.54E−02 | −1.05E−02 | −3.40E−03 | 3.05E−04 | −3.20E−05 | 2.45E−04 | −3.50E−05 |
| S11 | −0.685 | −1.71E−01 | −6.91E−02 | −1.73E−02 | −8.78E−03 | −3.38E−03 | −1.22E−03 | −4.14E−04 | −1.12E−04 | 3.40E−05 |
| S12 | 0.147 | −1.44E+00 | 1.55E−01 | −3.16E−02 | 5.71E−03 | −1.30E−03 | 2.42E−04 | 2.30E−05 | −2.20E−05 | 5.00E−06 |
| S13 | −46.615 | −1.10E+00 | 9.80E−02 | −1.28E−02 | 1.06E−03 | −1.89E−03 | −5.60E−04 | −1.64E−04 | −1.80E−05 | −2.20E−05 |
| S14 | −90.000 | −1.33E−01 | 5.59E−02 | −4.51E−04 | 1.24E−03 | −2.06E−03 | −5.34E−04 | −1.99E−04 | 2.00E−05 | −2.00E−06 |
| S15 | 0.601 | 1.09E−02 | 2.47E−02 | −6.32E−04 | 1.08E−04 | −3.01E−03 | 3.88E−04 | −3.10E−05 | 2.15E−04 | −1.52E−04 |
| S16 | −23.672 | 5.43E−01 | −5.73E−02 | 1.40E−02 | −3.72E−03 | −2.44E−03 | 2.31E−04 | −7.70E−05 | 8.80E−05 | −2.57E−04 |
| S17 | −0.096 | 7.64E−01 | −6.89E−02 | 1.84E−02 | −3.63E−03 | 9.25E−04 | −3.31E−04 | 9.30E−05 | −2.00E−05 | 1.00E−06 |

FIG. 19A illustrates a longitudinal aberration curve of the optical system 600 in the first state in Embodiment 6, representing deviations of focal points of light of different wavelengths converged after passing through the optical system 600. FIG. 19B illustrates an astigmatic curve of the optical system 600 in the first state in Embodiment 6, representing a curvature of a tangential image plane and a curvature of a sagittal image plane corresponding to different image heights. FIG. 19C illustrates a distortion curve of the optical system 600 in the first state in Embodiment 6, representing amounts of distortion corresponding to different image heights. It can be seen from FIG. 19A, FIG. 19B and FIG. 19C that the optical system 600 in Embodiment 6 can achieve a good imaging quality in the first state.

### Embodiment 7

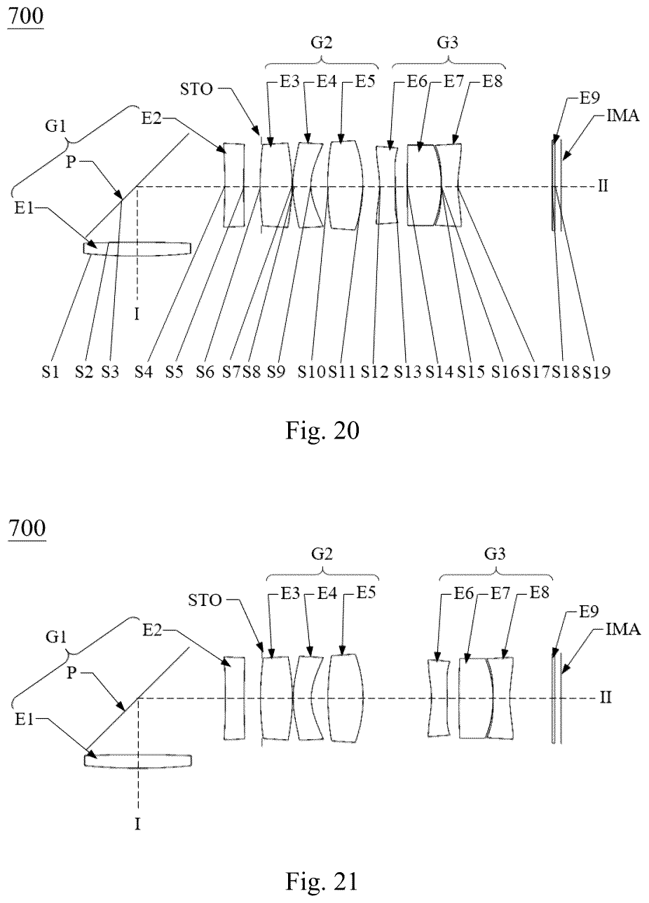

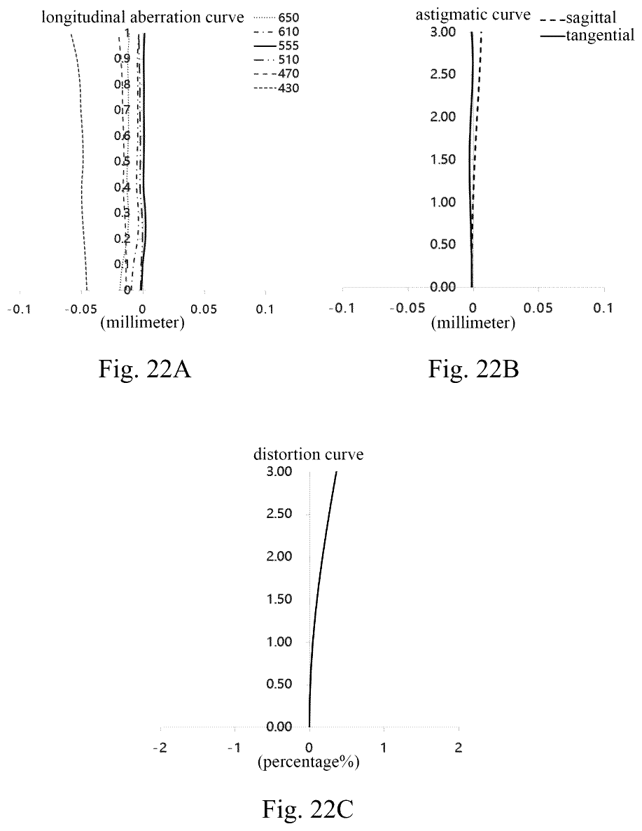

An optical system according to Embodiment 7 is described below with reference to FIG. 20, FIG. 21, FIG. 22A, FIG. 22B, and FIG. 22C.

As shown in FIG. 20 and FIG. 21, the optical system 700 may include a first element group G1, a second element group G2 and a third element group G3 arranged sequentially from an object side to an image side. The image side may be provided with, for example, an image plane IMA. The imageable object distance range of the optical system 700 may be from 10 cm to infinity. A magnification of the optical system 700 may be 8×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 700 is decreased, adjusting the distance between the third element group G3 and the second element group G2 on the optical axis II enables the optical system 700 to switch between a first state and a second state to achieve a focusing function of the optical system 700. During the focusing of the optical system 700, a maximal travelling distance of the third element group G3 may be 4.1221 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a concave surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 13 shows a table of basic parameters of the optical system 700 in Embodiment 7. Here, the units of the radius of curvature and the thickness/distance are millimeters (mm).

TABLE 13

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 39.5481 | 1.0918 | plastic | 1.545 | 55.959 |
| S2 | | aspheric | −123.8410 | 4.4950 | | | |
| S3 | reflective element | spherical | infinite | −6.9645 | glass | | |
| S4 | second lens | aspheric | 52.4698 | −1.5000 | plastic | 1.551 | 40.320 |
| S5 | | aspheric | −129.7890 | −1.4028 | | | |
| STO | aperture | spherical | infinite | 0.1528 | | | |
| S6 | third lens | aspheric | −27.1640 | −2.5396 | plastic | 1.545 | 55.959 |
| S7 | | aspheric | 11.8300 | −0.0519 | | | |
| S8 | fourth lens | aspheric | −7.4324 | −1.4432 | plastic | 1.630 | 24.225 |
| S9 | | aspheric | −3.9012 | −1.3268 | | | |
| S10 | fifth lens | aspheric | −19.0257 | −2.8000 | plastic | 1.545 | 55.959 |
| S11 | | aspheric | 10.2746 | W1 | | | |
| S12 | sixth lens | aspheric | 6.6430 | −1.2580 | plastic | 1.602 | 29.685 |
| S13 | | aspheric | 14.9588 | −0.9443 | | | |
| S14 | seventh lens | aspheric | 217.4560 | −2.7000 | plastic | 1.671 | 19.400 |
| S15 | | aspheric | 8.3418 | −0.0147 | | | |
| S16 | eighth lens | aspheric | 25.3386 | −1.3107 | plastic | 1.567 | 35.401 |
| S17 | | aspheric | −7.7922 | W2 | | | |
| S18 | optical filter | spherical | infinite | −0.2100 | glass | 1.517 | 64.210 |
| S19 | | spherical | infinite | −0.4941 | | | |
| IMA | image plane | spherical | infinite | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 20 and FIG. 21.

Here, an on-axis distance W1 from the second element group G2 to the third element group G3, and an on-axis distance W2 from the third element group G3 to the optical filter E9 are variables, which may change as the distance between the photographed object and the optical system 700 changes.

When the photographed object is at infinity from the optical system 700, the optical system 700 is in the first state, and a structural diagram of the optical system 700 may be referred to in FIG. 20, where, W1=−1.3278 mm, W2=−7.4926 mm, an effective focal length of the optical system 700 EFL=27.73 mm, a maximal field-of-view of the optical system 700 FOV=12.3122°, an aperture value of the optical system 700 in a first direction Fnox=2.34, and an aperture value of the optical system 700 in a second direction Fnoy=3.35. When the photographed object is at a preset distance from the optical system 700, the optical system 700 is in the second state, and a structural diagram of the optical system 700 may be referred to in FIG. 21.

In this embodiment, the object-side surface and the image-side surface of any lens in the first lens E1 to the eighth lens E8 are both aspheric surfaces. Table 14 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 7.

TABLE 14

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −28.118 | −1.60E−02 | −3.61E−03 | −1.17E−03 | 2.49E−04 | −2.13E−04 | 4.60E−05 | −2.30E−05 | 8.00E−06 | 1.95E−07 |
| S2 | 90.000 | −5.40E−02 | −3.45E−04 | −1.33E−03 | 2.95E−04 | −2.35E−04 | 6.00E−05 | −2.60E−05 | 1.10E−05 | −2.00E−06 |
| S4 | −90.000 | 2.56E−02 | −1.57E−03 | −3.86E−04 | −3.47E−04 | 3.50E−04 | −1.86E−04 | 5.80E−05 | −1.30E−05 | 2.00E−06 |
| S5 | −77.792 | −1.81E−02 | 4.05E−04 | −4.48E−04 | −2.77E−04 | 2.88E−04 | −1.46E−04 | 4.30E−05 | −1.00E−05 | 2.00E−06 |
| S6 | −90.000 | −2.38E−01 | 3.16E−02 | −3.51E−03 | 2.16E−03 | −7.82E−04 | 4.11E−04 | −2.90E−05 | 7.30E−05 | −6.00E−06 |
| S7 | 0.216 | −5.32E−01 | 6.20E−02 | −1.03E−02 | 4.44E−03 | −1.21E−03 | 8.82E−04 | 1.38E−04 | 1.90E−05 | −3.80E−05 |
| S8 | 0.027 | 1.15E+00 | −4.65E−02 | 9.25E−03 | −2.09E−03 | 4.89E−04 | −3.78E−04 | 1.96E−04 | −2.69E−04 | −8.70E−05 |
| S9 | −2.297 | 6.07E−01 | −6.41E−02 | 1.51E−02 | −6.16E−03 | 1.57E−03 | −7.87E−04 | 9.50E−05 | −2.77E−04 | 5.30E−05 |
| S10 | −39.270 | −1.51E−01 | 7.82E−03 | −1.01E−02 | −2.85E−03 | −5.45E−04 | 2.21E−04 | −2.39E−04 | 8.40E−05 | 2.20E−05 |
| S11 | 0.006 | −1.54E−02 | −1.72E−02 | −6.41E−03 | −1.62E−03 | −1.98E−04 | 2.59E−04 | 5.20E−05 | 1.37E−04 | 1.50E−05 |
| S12 | 0.094 | −1.45E+00 | 1.47E−01 | −3.14E−02 | 4.84E−03 | −1.84E−03 | −1.68E−04 | −6.20E−05 | −8.70E−05 | 2.60E−05 |
| S13 | −2.593 | −9.96E−01 | 8.39E−02 | −1.70E−02 | 1.35E−04 | −7.94E−04 | −4.92E−04 | 2.80E−05 | −1.40E−05 | −5.00E−06 |
| S14 | −90.000 | −9.58E−02 | 2.14E−02 | −9.14E−03 | −7.36E−04 | −7.31E−04 | −7.40E−05 | 1.82E−04 | 1.09E−04 | 2.50E−05 |
| S15 | −0.075 | −9.59E−03 | 7.46E−03 | −5.15E−03 | −1.01E−03 | −1.36E−03 | −4.07E−04 | 6.80E−05 | 1.03E−04 | 1.00E−06 |
| S16 | −5.836 | 5.80E−01 | −5.57E−02 | −8.67E−04 | −6.33E−03 | −3.68E−03 | −1.34E−03 | −1.27E−04 | 5.00E−05 | −2.00E−05 |
| S17 | 0.089 | 7.38E−01 | −6.15E−02 | 9.62E−03 | −2.94E−03 | −4.02E−04 | −4.76E−04 | −1.17E−04 | −3.00E−05 | 5.00E−06 |

FIG. 22A illustrates a longitudinal aberration curve of the optical system 700 in the first state in Embodiment 7, representing deviations of focal points of light of different wavelengths converged after passing through the optical system 700. FIG. 22B illustrates an astigmatic curve of the optical system 700 in the first state in Embodiment 7, representing a curvature of a tangential image plane and a curvature of a sagittal image plane corresponding to different image heights. FIG. 22C illustrates a distortion curve of the optical system 700 in the first state in Embodiment 7, representing amounts of distortion corresponding to different image heights. It can be seen from FIG. 22A, FIG. 22B and FIG. 22C that the optical system 700 in Embodiment 7 can achieve a good imaging quality in the first state.

### Embodiment 8

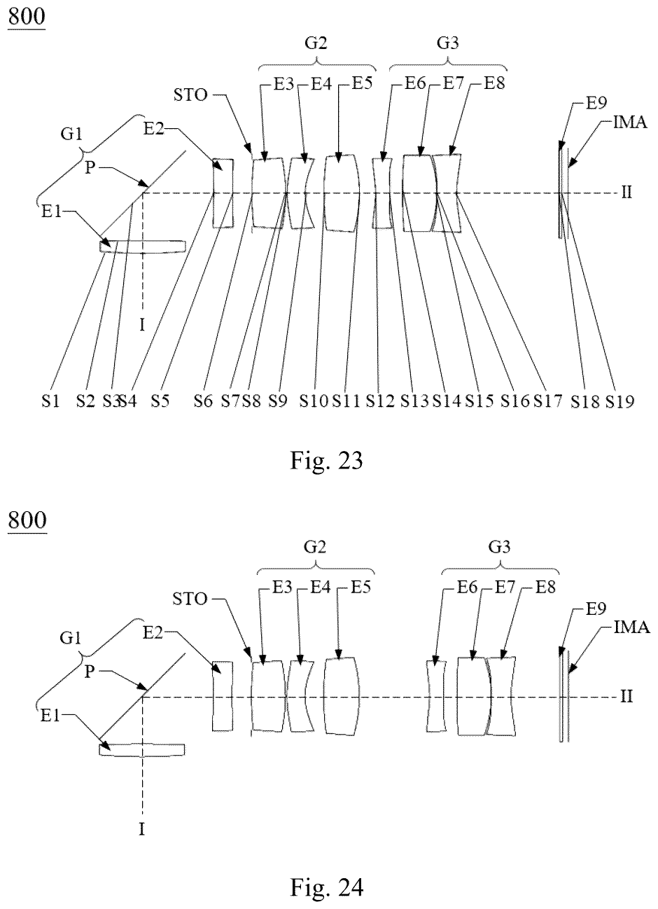

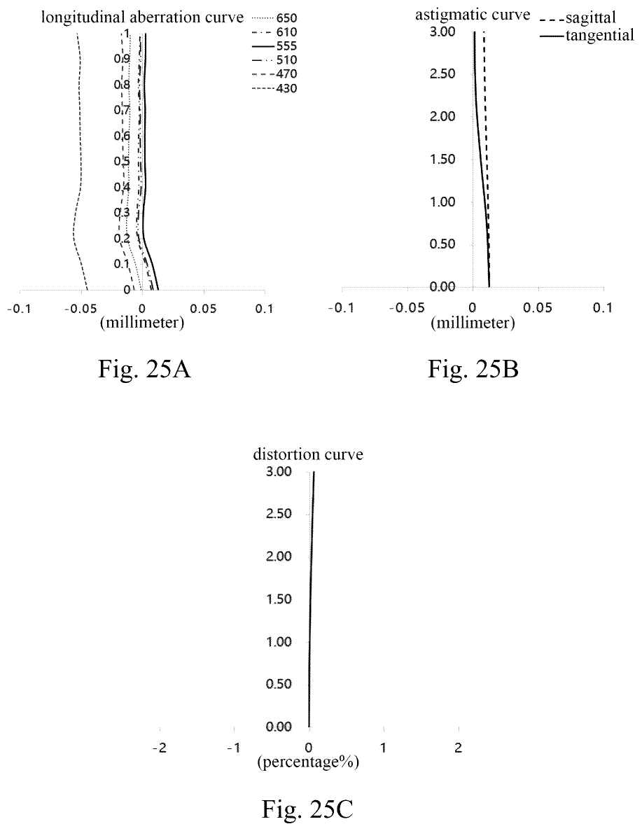

An optical system according to Embodiment 8 is described below with reference to FIG. 23, FIG. 24, FIG. 25A, FIG. 25B, and FIG. 25C.

As shown in FIG. 23 and FIG. 24, the optical system 800 may include a first element group G1, a second element group G2 and a third element group G3 arranged sequentially from an object side to an image side. The image side may be provided with, for example, an image plane IMA. The imageable object distance range of the optical system 800 may be from 10 cm to infinity. A magnification of the optical system 800 may be 8×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 800 is decreased, adjusting the distance between the third element group G3 and the second element group G2 on the optical axis II enables the optical system 800 to switch between a first state and a second state to achieve a focusing function of the optical system 800. During the focusing of the optical system 800, a maximal travelling distance of the third element group G3 may be 4.2639 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a convex surface, and an image-side surface S15 of the seventh lens E7 is a convex surface. The eighth lens E8 may have a negative refractive power, an object-side surface S16 of the eighth lens E8 is a concave surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 15 shows a table of basic parameters of the optical system 800 in Embodiment 8. Here, the units of the radius of curvature and the thickness/distance are millimeters (mm).

TABLE 15

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 37.6579 | 1.0000 | plastic | 1.545 | 55.959 |
| S2 | | aspheric | −158.0100 | 3.7451 | | | |
| S3 | reflective element | spherical | infinite | −5.5973 | glass | | |
| S4 | second lens | aspheric | 57.1772 | −1.5000 | plastic | 1.546 | 55.050 |
| S5 | | aspheric | −104.3480 | −1.5158 | | | |
| STO | aperture | spherical | infinite | 0.2658 | | | |
| S6 | third lens | aspheric | −26.9516 | −2.6670 | plastic | 1.545 | 55.959 |
| S7 | | aspheric | 10.7214 | −0.1246 | | | |
| S8 | fourth lens | aspheric | −7.9911 | −1.4100 | plastic | 1.626 | 24.383 |
| S9 | | aspheric | −3.9701 | −1.4817 | | | |
| S10 | fifth lens | aspheric | −21.0741 | −2.8000 | plastic | 1.545 | 55.959 |
| S11 | | aspheric | 10.8266 | W1 | | | |
| S12 | sixth lens | aspheric | 6.9481 | −1.1240 | plastic | 1.596 | 30.969 |
| S13 | | aspheric | 17.4840 | −1.0101 | | | |
| S14 | seventh lens | aspheric | −89.0544 | −2.7000 | plastic | 1.671 | 19.400 |
| S15 | | aspheric | 8.6531 | −0.0174 | | | |
| S16 | eighth lens | aspheric | 29.1971 | −1.5501 | plastic | 1.588 | 29.905 |
| S17 | | aspheric | −7.3045 | W2 | | | |
| S18 | optical filter | spherical | infinite | −0.2100 | glass | 1.517 | 64.210 |
| S19 | | spherical | infinite | −0.4941 | | | |
| IMA | image plane | spherical | infinite | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 23 and FIG. 24.

Here, an on-axis distance W1 from the second element group G2 to the third element group G3, and an on-axis distance W2 from the third element group G3 to the optical filter E9 are variables, which may change as the distance between the photographed object and the optical system 800 changes.

When the photographed object is at infinity from the optical system 800, the optical system 800 is in the first state, and a structural diagram of the optical system 800 may be referred to in FIG. 23, where, W1=−1.2728 mm, W2=−8.0922 mm, an effective focal length of the optical system 800 EFL=27.73 mm, a maximal field-of-view of the optical system 800 FOV=12.3122°, an aperture value of the optical system 800 in a first direction Fnox=2.96, and an aperture value of the optical system 800 in a second direction Fnoy=4.25. When the photographed object is at a preset distance from the optical system 800, the optical system 800 is in the second state, and a structural diagram of the optical system 800 may be referred to in FIG. 24.

In this embodiment, the object-side surface and the image-side surface of any lens in the first lens E1 to the eighth lens E8 are both aspheric surfaces. Table 16 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 8.

TABLE 16

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −26.100 | −2.28E−03 | −1.21E−03 | −4.60E−05 | 1.03E−04 | −4.70E−05 | 1.60E−05 | −2.00E−06 | 5.00E−06 | −4.23E−07 |
| S2 | 90.000 | −2.08E−02 | −3.36E−04 | −3.80E−05 | 1.13E−04 | −4.90E−05 | 2.30E−05 | −3.59E−07 | 5.00E−06 | −1.00E−06 |
| S4 | −90.000 | 5.49E−03 | −1.45E−04 | 1.71E−04 | −1.39E−04 | 8.20E−05 | −2.90E−05 | 1.10E−05 | 1.00E−06 | 6.00E−06 |
| S5 | −0.752 | −1.56E−02 | 3.70E−04 | 1.06E−04 | −1.07E−04 | 5.90E−05 | −2.30E−05 | 4.00E−06 | −2.00E−06 | 5.00E−06 |
| S6 | −90.000 | −2.42E−01 | 3.22E−02 | −6.19E−03 | 2.84E−03 | 3.17E−04 | 8.23E−04 | 1.64E−04 | 4.50E−05 | 1.40E−05 |
| S7 | 0.261 | −5.30E−01 | 6.63E−02 | −1.26E−02 | 4.88E−03 | −1.47E−03 | 8.86E−04 | −2.48E−04 | 1.74E−04 | 1.44E−04 |
| S8 | 0.038 | 1.15E+00 | −5.17E−02 | 1.36E−02 | −3.16E−03 | 3.59E−04 | −2.57E−04 | −2.30E−04 | −2.00E−06 | 1.38E−04 |
| S9 | −2.310 | 6.18E−01 | −6.71E−02 | 1.69E−02 | −9.06E−03 | 3.06E−03 | −9.97E−04 | 2.30E−04 | −1.21E−04 | 3.40E−05 |
| S10 | −37.520 | −1.67E−01 | 8.64E−03 | −1.09E−02 | −4.20E−03 | 1.68E−04 | −6.96E−04 | −4.34E−04 | −3.07E−04 | −1.70E−04 |
| S11 | −0.056 | −1.40E−02 | −1.27E−02 | −5.14E−03 | −1.18E−03 | 9.30E−05 | 1.36E−04 | 1.74E−04 | 7.80E−05 | −3.00E−06 |
| S12 | 0.173 | −1.44E+00 | 1.51E−01 | −3.54E−02 | 4.92E−03 | −1.92E−03 | 1.81E−04 | 2.49E−04 | 1.56E−04 | 5.40E−05 |
| S13 | −2.606 | −7.34E−01 | 6.34E−02 | −8.80E−03 | 6.62E−04 | 1.53E−04 | −1.80E−05 | −3.80E−05 | −1.00E−05 | −7.00E−06 |
| S14 | −90.000 | −8.65E−02 | 2.11E−02 | −2.67E−03 | 3.31E−04 | 3.50E−05 | −4.00E−06 | −6.90E−05 | −1.00E−05 | −1.00E−05 |
| S15 | −0.054 | −1.02E−02 | 8.48E−03 | −6.30E−05 | −8.72E−04 | 6.45E−04 | −2.97E−04 | 6.60E−05 | −5.80E−05 | 5.00E−06 |
| S16 | −36.489 | 5.38E−01 | −5.39E−02 | 2.89E−03 | −4.81E−03 | −1.13E−03 | −1.93E−03 | −3.53E−04 | −2.48E−04 | 5.70E−05 |
| S17 | 0.299 | 7.03E−01 | −5.48E−02 | 9.65E−03 | −1.85E−03 | −2.40E−05 | −3.74E−04 | −1.63E−04 | −7.60E−05 | −7.00E−06 |

FIG. 25A illustrates a longitudinal aberration curve of the optical system 800 in the first state in Embodiment 8, representing deviations of focal points of light of different wavelengths converged after passing through the optical system 800. FIG. 25B illustrates an astigmatic curve of the optical system 800 in the first state in Embodiment 8, representing a curvature of a tangential image plane and a curvature of a sagittal image plane corresponding to different image heights. FIG. 25C illustrates a distortion curve of the optical system 800 in the first state in Embodiment 8, representing amounts of distortion corresponding to different image heights. It can be seen from FIG. 25A, FIG. 25B and FIG. 25C that the optical system 800 in Embodiment 8 can achieve a good imaging quality in the first state.

### Embodiment 9

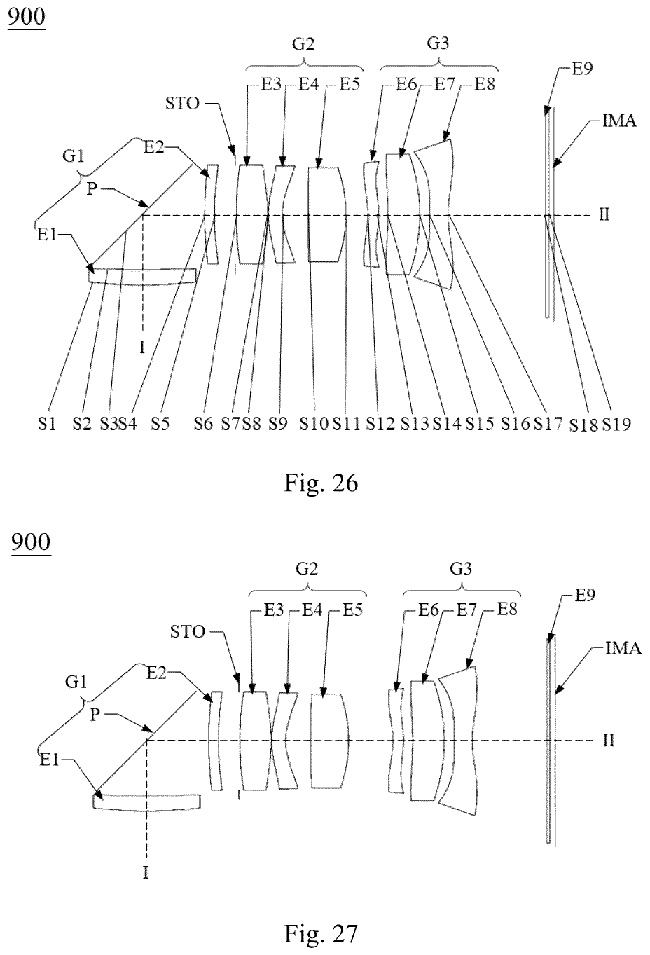

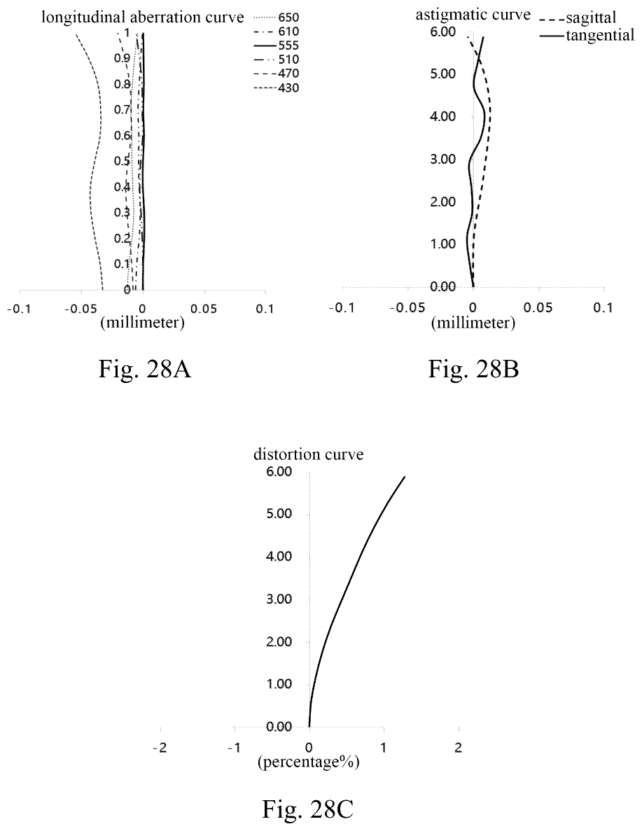

An optical system according to Embodiment 9 is described below with reference to FIG. 26, FIG. 27, FIG. 28A, FIG. 28B, and FIG. 28C.

As shown in FIG. 26 and FIG. 27, the optical system 900 may include a first element group G1, a second element group G2 and a third element group G3 arranged sequentially from an object side to an image side. The image side may be provided with, for example, an image plane IMA. The imageable object distance range of the optical system 900 may be from 17 cm to infinity. A magnification of the optical system 900 may be 2.5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 900 is decreased, adjusting the distance between the third element group G3 and the second element group G2 on the optical axis II enables the optical system 900 to switch between a first state and a second state to achieve a focusing function of the optical system 900. During the focusing of the optical system 900, a maximal travelling distance of the third element group G3 may be 1.0472 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a convex surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a concave surface, and an image-side surface S11 of the fifth lens E5 is a convex surface. The sixth lens E6 may have a positive refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 17 shows a table of basic parameters of the optical system 900 in Embodiment 9. Here, the units of the radius of curvature and the thickness/distance are millimeters (mm).

TABLE 17

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 20.4055 | 0.7200 | plastic | 1.545 | 55.959 |
| S2 | | aspheric | 53.9223 | 2.5633 | | | |
| S3 | reflective element | spherical | infinite | −2.9057 | glass | | |
| S4 | second lens | aspheric | −14.9718 | −0.4549 | plastic | 1.561 | 43.963 |
| S5 | | aspheric | −12.2663 | −0.9703 | | | |
| STO | aperture | spherical | infinite | −0.0497 | | | |
| S6 | third lens | aspheric | −21.3601 | −1.4643 | plastic | 1.545 | 55.959 |
| S7 | | aspheric | 7.1470 | −0.0225 | | | |
| S8 | fourth lens | aspheric | −4.0517 | −0.6496 | plastic | 1.654 | 20.926 |
| S9 | | aspheric | −2.6502 | −1.2085 | | | |
| S10 | fifth lens | aspheric | 286.4980 | −1.7500 | plastic | 1.545 | 55.959 |
| S11 | | aspheric | 6.3122 | W1 | | | |
| S12 | sixth lens | aspheric | 3.7516 | −0.5000 | plastic | 1.608 | 25.191 |
| S13 | | aspheric | 3.8143 | −0.4316 | | | |
| S14 | seventh lens | aspheric | 10.2220 | −1.4771 | plastic | 1.671 | 19.400 |
| S15 | | aspheric | 8.1106 | −0.4659 | | | |
| S16 | eighth lens | aspheric | −84.2447 | −0.8491 | plastic | 1.535 | 45.928 |
| S17 | | aspheric | −4.4264 | W2 | | | |
| S18 | optical filter | spherical | infinite | −0.1343 | glass | 1.517 | 64.210 |
| S19 | | spherical | infinite | −0.2708 | | | |
| IMA | image plane | spherical | infinite | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 26 and FIG. 27.

Here, an on-axis distance W1 from the second element group G2 to the third element group G3, and an on-axis distance W2 from the third element group G3 to the optical filter E9 are variables, which may change as the distance between the photographed object and the optical system 900 changes.

When the photographed object is at infinity from the optical system 900, the optical system 900 is in the first state, and a structural diagram of the optical system 900 may be referred to in FIG. 26, where, W1=−1.0281 mm, W2=−4.5442 mm, an effective focal length of the optical system 900 EFL=15.20 mm, a maximal field-of-view of the optical system 900 FOV=41.72°, an aperture value of the optical system 900 in a first direction Fnox=2.6, and an aperture value of the optical system 900 in a second direction Fnoy=2.6. When the photographed object is at a preset distance from the optical system 900, the optical system 900 is in the second state, and a structural diagram of the optical system 900 may be referred to in FIG. 27.

In this embodiment, the object-side surface and the image-side surface of any lens in the first lens E1 to the eighth lens E8 are both aspheric surfaces. Table 18 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 9.

TABLE 18

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −19.957 | −4.34E−02 | −6.77E−03 | −8.70E−05 | −4.90E−05 | −2.90E−05 | 1.00E−05 | −2.28E−07 | 1.00E−05 | −6.00E−06 |
| S2 | 90.000 | −1.00E−01 | −5.03E−03 | −2.21E−04 | −5.50E−05 | −1.80E−05 | 1.30E−05 | 3.00E−06 | 7.00E−06 | −7.00E−06 |
| S4 | −90.000 | −6.90E−03 | 9.29E−03 | −2.16E−03 | 4.22E−04 | −6.60E−05 | 2.10E−05 | −1.20E−05 | 5.00E−06 | −1.00E−06 |
| S5 | −43.568 | −1.36E−02 | 6.90E−03 | −1.45E−03 | 2.43E−04 | −3.00E−05 | 1.30E−05 | −1.10E−05 | 5.00E−06 | −1.00E−06 |
| S6 | −90.000 | −1.09E−01 | 9.14E−03 | −1.19E−04 | 3.27E−04 | −8.10E−05 | 3.20E−05 | −1.20E−05 | 8.00E−06 | −3.63E−07 |
| S7 | 0.483 | −2.34E−01 | 2.48E−02 | −8.86E−04 | 2.06E−04 | 6.60E−05 | −2.40E−05 | 2.20E−05 | 3.42E−07 | −1.59E−08 |
| S8 | 0.057 | 5.98E−01 | −1.73E−02 | 6.32E−03 | −1.52E−03 | 4.54E−04 | −4.60E−05 | 3.00E−05 | 6.00E−06 | −2.00E−06 |
| S9 | −2.346 | 3.75E−01 | −3.31E−02 | 8.37E−03 | −2.20E−03 | 7.25E−04 | −7.00E−05 | 3.50E−05 | 1.00E−06 | −5.00E−06 |
| S10 | 90.000 | −6.90E−02 | 9.74E−04 | −1.89E−04 | 2.40E−05 | 1.18E−04 | 8.60E−05 | 1.70E−05 | 7.00E−06 | −2.00E−06 |
| S11 | −0.508 | −5.44E−02 | −6.74E−03 | −1.06E−03 | −8.20E−05 | 5.80E−05 | 4.40E−05 | 1.50E−05 | 7.00E−06 | −2.00E−06 |
| S12 | 0.103 | −1.49E+00 | 1.31E−01 | −3.21E−02 | 6.43E−03 | −2.07E−03 | 3.26E−04 | 2.30E−05 | −3.00E−05 | 1.00E−06 |
| S13 | −0.248 | −1.65E+00 | 1.78E−01 | −4.04E−02 | 1.15E−02 | −3.47E−03 | 5.58E−04 | 2.00E−06 | 3.90E−05 | −1.80E−05 |
| S14 | −90.000 | −1.63E−01 | 5.42E−03 | −1.71E−02 | 5.21E−03 | −2.63E−03 | 4.58E−04 | −1.29E−04 | 1.25E−04 | −1.70E−05 |
| S15 | −0.957 | −9.66E−03 | −1.41E−02 | −4.70E−03 | −8.44E−04 | −1.53E−03 | −3.01E−04 | −2.29E−04 | 5.20E−05 | 1.00E−06 |
| S16 | −90.000 | 1.12E+00 | −1.11E−01 | 3.18E−02 | −6.87E−03 | 1.12E−03 | −5.79E−04 | −2.04E−04 | 4.20E−05 | −2.50E−05 |
| S17 | 0.017 | 2.76E+00 | −2.09E−01 | 1.05E−01 | −1.73E−02 | 1.06E−02 | −2.18E−03 | 1.29E−03 | −2.32E−04 | 1.13E−04 |

FIG. 28A illustrates a longitudinal aberration curve of the optical system 900 in the first state in Embodiment 9, representing deviations of focal points of light of different wavelengths converged after passing through the optical system 900. FIG. 28B illustrates an astigmatic curve of the optical system 900 in the first state in Embodiment 9, representing a curvature of a tangential image plane and a curvature of a sagittal image plane corresponding to different image heights. FIG. 28C illustrates a distortion curve of the optical system 900 in the first state in Embodiment 9, representing amounts of distortion corresponding to different image heights. It can be seen from FIG. 28A, FIG. 28B and FIG. 28C that the optical system 900 in Embodiment 9 can achieve a good imaging quality in the first state.

### Embodiment 10

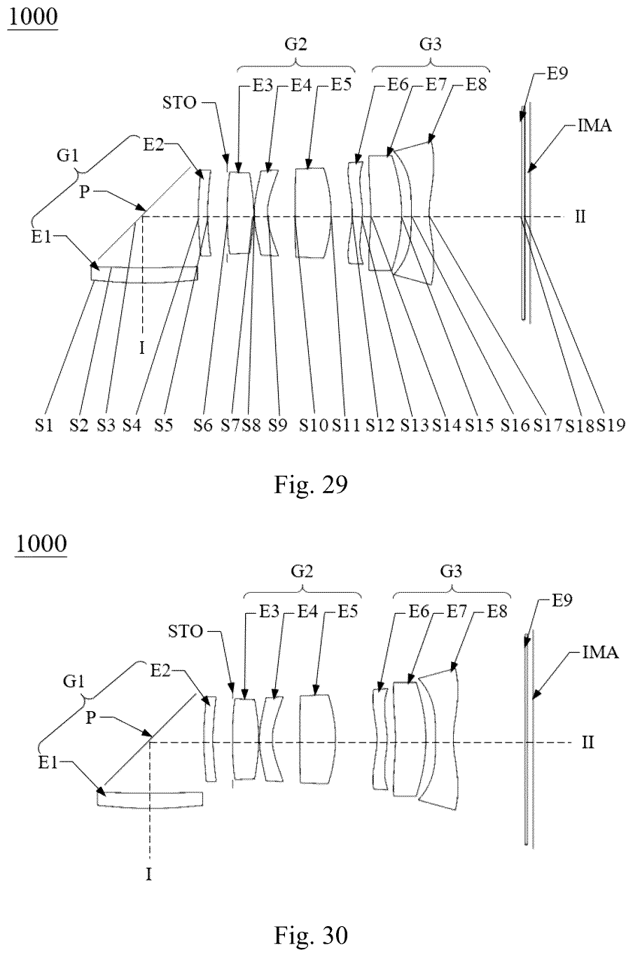

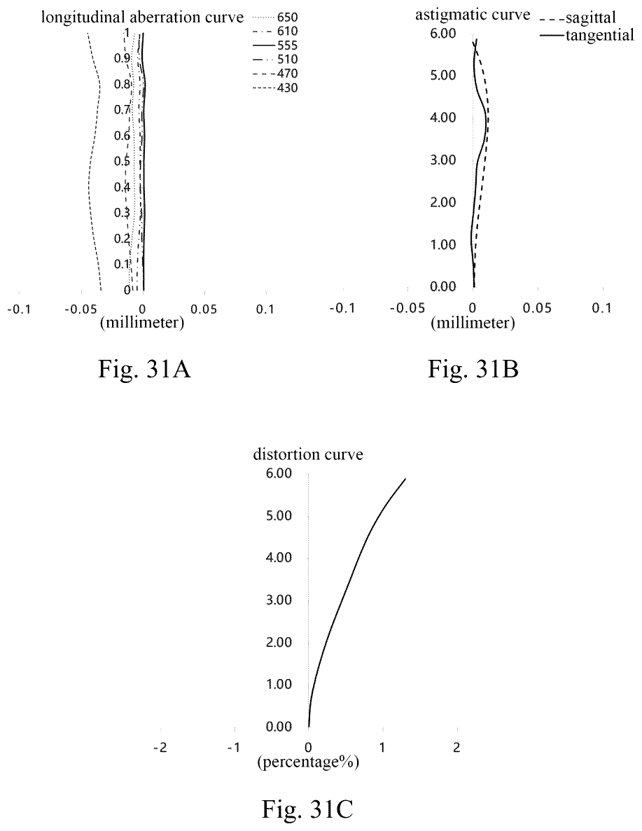

An optical system according to Embodiment 10 is described below with reference to FIG. 29, FIG. 30, FIG. 31A, FIG. 31B, and FIG. 31C.

As shown in FIG. 29 and FIG. 30, the optical system 1000 may include a first element group G1, a second element group G2 and a third element group G3 arranged sequentially from an object side to an image side. The image side may be provided with, for example, an image plane IMA. The imageable object distance range of the optical system 1000 may be from 17 cm to infinity. A magnification of the optical system 1000 may be 2.5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 1000 is decreased, adjusting the distance between the third element group G3 and the second element group G2 on the optical axis II enables the optical system 1000 to switch between a first state and a second state to achieve a focusing function of the optical system 1000. During the focusing of the optical system 1000, a maximal travelling distance of the third element group G3 may be 1.0087 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a convex surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a positive refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 19 shows a table of basic parameters of the optical system 1000 in Embodiment 10. Here, the units of the radius of curvature and the thickness/distance are millimeters (mm).

TABLE 19

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 20.4255 | 0.7480 | plastic | 1.545 | 55.959 |
| S2 | | aspheric | 53.1691 | 2.2369 | | | |
| S3 | reflective element | spherical | infinite | −2.6427 | glass | | |
| S4 | second lens | aspheric | −14.8737 | −0.4508 | plastic | 1.559 | 45.322 |
| S5 | | aspheric | −11.9223 | −0.9573 | | | |
| STO | aperture | spherical | infinite | −0.1409 | | | |
| S6 | third lens | aspheric | −21.4203 | −1.2947 | plastic | 1.545 | 55.959 |
| S7 | | aspheric | 6.9897 | −0.0297 | | | |
| S8 | fourth lens | aspheric | −4.0815 | −0.6383 | plastic | 1.648 | 21.413 |
| S9 | | aspheric | −2.6698 | −1.3584 | | | |
| S10 | fifth lens | aspheric | −660.4490 | −1.7500 | plastic | 1.545 | 55.959 |
| S11 | | aspheric | 6.5609 | W1 | | | |
| S12 | sixth lens | aspheric | 3.7459 | −0.5000 | plastic | 1.611 | 24.771 |
| S13 | | aspheric | 3.8177 | −0.4041 | | | |
| S14 | seventh lens | aspheric | 10.1579 | −1.5000 | plastic | 1.671 | 19.400 |
| S15 | | aspheric | 8.2293 | −0.4701 | | | |
| S16 | eighth lens | aspheric | −76.5671 | −0.8851 | plastic | 1.541 | 45.306 |
| S17 | | aspheric | −4.4268 | W2 | | | |
| S18 | optical filter | spherical | infinite | −0.1343 | glass | 1.517 | 64.210 |
| S19 | | spherical | infinite | −0.2708 | | | |
| IMA | image plane | spherical | infinite | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 29 and FIG. 30.

Here, an on-axis distance W1 from the second element group G2 to the third element group G3, and an on-axis distance W2 from the third element group G3 to the optical filter E9 are variables, which may change as the distance between the photographed object and the optical system 1000 changes.

When the photographed object is at infinity from the optical system 1000, the optical system 1000 is in the first state, and a structural diagram of the optical system 1000 may be referred to in FIG. 29, where, W1=−1.0343 mm, W2=−4.5275 mm, an effective focal length of the optical system 1000 EFL=15.19 mm, a maximal field-of-view of the optical system 1000 FOV=41.72°, an aperture value of the optical system 1000 in a first direction Fnox=3.3, and an aperture value of the optical system 1000 in a second direction Fnoy=3.3. When the photographed object is at a preset distance from the optical system 1000, the optical system 1000 is in the second state, and a structural diagram of the optical system 1000 may be referred to in FIG. 30.

In this embodiment, the object-side surface and the image-side surface of any lens in the first lens E1 to the eighth lens E8 are both aspheric surfaces. Table 20 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 10.

TABLE 20

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −20.959 | −3.26E−02 | −4.33E−03 | 3.14E−04 | −3.20E−05 | −9.00E−06 | 1.00E−06 | 4.00E−06 | 2.00E−06 | −2.00E−06 |
| S2 | 90.000 | −7.72E−02 | −2.76E−03 | 2.10E−04 | −4.50E−05 | −4.00E−06 | 1.00E−06 | 5.00E−06 | −1.43E−07 | −3.00E−06 |
| S4 | −90.000 | −9.61E−03 | 5.02E−03 | −9.96E−04 | 1.82E−04 | −1.50E−05 | 1.50E−05 | −7.00E−06 | 1.00E−06 | −1.00E−06 |
| S5 | −42.424 | −1.27E−02 | 3.52E−03 | −6.17E−04 | 9.20E−05 | −8.00E−06 | 1.20E−05 | −5.00E−06 | 2.00E−06 | 2.61E−07 |
| S6 | −90.000 | −5.32E−02 | 3.22E−03 | −2.17E−04 | 9.60E−05 | −3.30E−05 | 1.20E−05 | −4.07E−09 | 2.00E−06 | 1.00E−06 |
| S7 | 0.592 | −1.20E−01 | 9.31E−03 | −1.97E−04 | −1.09E−04 | 5.90E−05 | −8.00E−06 | 1.80E−05 | −8.00E−06 | 7.00E−06 |
| S8 | 0.052 | 2.93E−01 | −1.04E−02 | 2.94E−03 | −7.22E−04 | 1.21E−04 | −1.50E−05 | 1.70E−05 | −7.00E−06 | 7.00E−06 |
| S9 | −2.343 | 1.96E−01 | −1.75E−02 | 4.01E−03 | −9.31E−04 | 1.39E−04 | −1.50E−05 | 7.00E−06 | −8.94E−08 | 2.00E−06 |
| S10 | −90.000 | −4.06E−02 | 4.55E−04 | 4.03E−04 | −6.50E−05 | −5.40E−05 | −1.20E−05 | 2.00E−06 | 1.00E−06 | 2.00E−06 |
| S11 | −0.537 | −3.32E−02 | −2.19E−03 | 1.02E−04 | −1.60E−05 | −3.90E−05 | −3.10E−05 | 1.00E−06 | −2.00E−06 | 2.00E−06 |
| S12 | 0.100 | −1.24E+00 | 1.08E−01 | −2.26E−02 | 5.56E−03 | −1.24E−03 | 1.24E−04 | 7.20E−05 | −4.60E−05 | 9.00E−06 |
| S13 | −0.248 | −1.41E+00 | 1.48E−01 | −3.23E−02 | 9.64E−03 | −2.26E−03 | 1.76E−04 | 1.50E−05 | 1.80E−05 | −7.00E−06 |
| S14 | −90.000 | −1.37E−01 | 1.08E−02 | −1.48E−02 | 4.18E−03 | −1.94E−03 | 5.40E−05 | −1.97E−04 | 1.12E−04 | 1.00E−05 |
| S15 | −1.064 | −8.92E−03 | −1.19E−02 | −3.87E−03 | −1.01E−03 | −8.99E−04 | −7.17E−04 | −6.09E−04 | −5.70E−05 | 9.00E−06 |
| S16 | −90.000 | 1.10E+00 | −1.07E−01 | 2.87E−02 | −4.69E−03 | 1.97E−03 | −5.40E−04 | −6.16E−04 | −1.02E−04 | −2.20E−05 |
| S17 | 0.014 | 2.76E+00 | −2.14E−01 | 1.03E−01 | −1.57E−02 | 9.97E−03 | −2.03E−03 | 1.18E−03 | −1.13E−04 | 8.10E−05 |

FIG. 31A illustrates a longitudinal aberration curve of the optical system 1000 in the first state in Embodiment 10, representing deviations of focal points of light of different wavelengths converged after passing through the optical system 1000. FIG. 31B illustrates an astigmatic curve of the optical system 1000 in the first state in Embodiment 10, representing a curvature of a tangential image plane and a curvature of a sagittal image plane corresponding to different image heights. FIG. 31C illustrates a distortion curve of the optical system 1000 in the first state in Embodiment 10, representing amounts of distortion corresponding to different image heights. It can be seen from FIG. 31A, FIG. 31B and FIG. 31C that the optical system 1000 in Embodiment 10 can achieve a good imaging quality in the first state.

### Embodiment 11

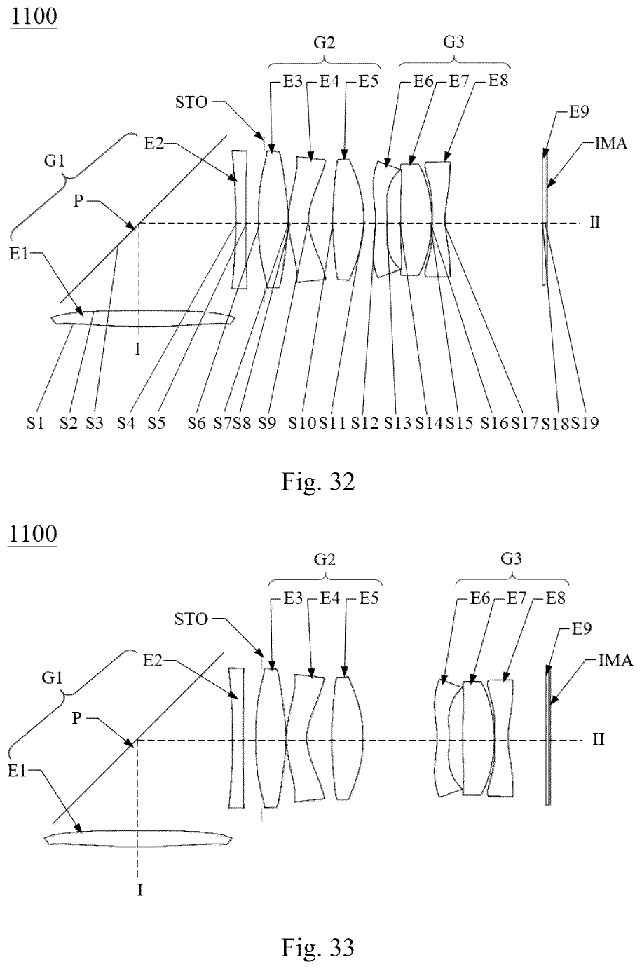

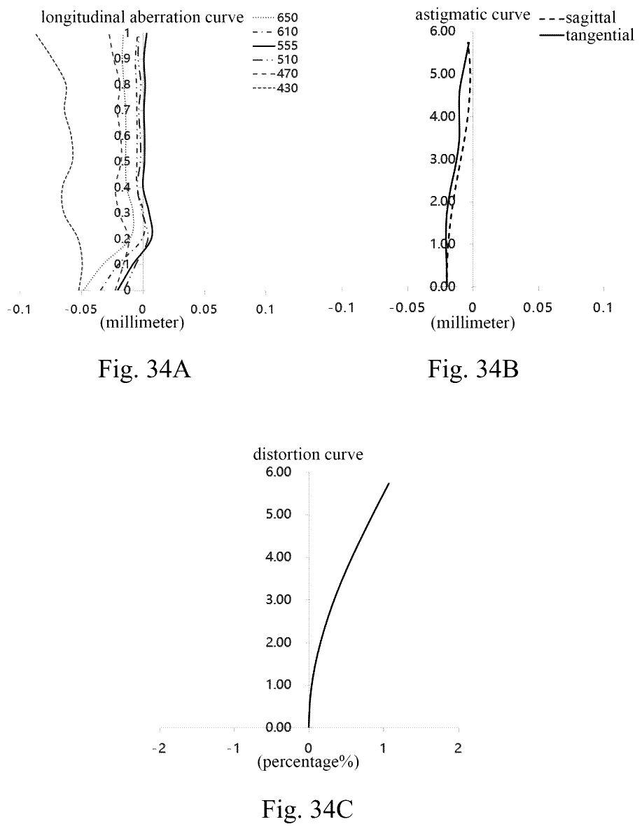

An optical system according to Embodiment 11 is described below with reference to FIG. 32, FIG. 33, FIG. 34A, FIG. 34B, and FIG. 34C.

As shown in FIG. 32 and FIG. 33, the optical system 1100 may include a first element group G1, a second element group G2 and a third element group G3 arranged sequentially from an object side to an image side. The image side may be provided with, for example, an image plane IMA. The imageable object distance range of the optical system 1100 may be from 10 cm to infinity. A magnification of the optical system 1100 may be 5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 1100 is decreased, adjusting the distance between the third element group G3 and the second element group G2 on the optical axis II enables the optical system 1100 to switch between a first state and a second state to achieve a focusing function of the optical system 1100. During the focusing of the optical system 1100, a maximal travelling distance of the third element group G3 may be 5.8859 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 21 shows a table of basic parameters of the optical system 1100 in Embodiment 11. Here, the units of the radius of curvature and the thickness/distance are millimeters (mm).

TABLE 21

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 65.7380 | 1.5542 | plastic | 1.518 | 56.916 |
| S2 | | aspheric | −141.8470 | 8.7601 | | | |
| S3 | reflective element | spherical | infinite | −9.0101 | glass | | |
| S4 | second lens | aspheric | 61.8527 | −1.0000 | plastic | 1.567 | 32.415 |
| S5 | | aspheric | −285.6150 | −1.7478 | | | |
| STO | aperture | spherical | infinite | 0.5478 | | | |
| S6 | third lens | aspheric | −36.5017 | −2.8977 | plastic | 1.545 | 55.959 |
| S7 | | aspheric | 13.5852 | −0.0300 | | | |
| S8 | fourth lens | aspheric | −8.2958 | −1.9521 | plastic | 1.636 | 22.129 |
| S9 | | aspheric | −4.7421 | −2.3659 | | | |
| S10 | fifth lens | aspheric | −33.3087 | −3.0000 | plastic | 1.545 | 55.959 |
| S11 | | aspheric | 11.5841 | W1 | | | |
| S12 | sixth lens | aspheric | 7.5675 | −1.1441 | plastic | 1.595 | 30.708 |
| S13 | | aspheric | 14.2292 | −1.3125 | | | |
| S14 | seventh lens | aspheric | 289.9840 | −3.0000 | plastic | 1.671 | 19.400 |
| S15 | | aspheric | 12.1279 | −0.0500 | | | |
| S16 | eighth lens | aspheric | −142.1200 | −1.2408 | plastic | 1.553 | 36.651 |
| S17 | | aspheric | −7.3729 | W2 | | | |
| S18 | optical filter | spherical | infinite | −0.2801 | glass | 1.517 | 64.210 |
| S19 | | spherical | infinite | −0.1685 | | | |
| IMA | image plane | spherical | infinite | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 32 and FIG. 33.

Here, an on-axis distance W1 from the second element group G2 to the third element group G3, and an on-axis distance W2 from the third element group G3 to the optical filter E9 are variables, which may change as the distance between the photographed object and the optical system 1100 changes.

When the photographed object is at infinity from the optical system 1100, the optical system 1100 is in the first state, and a structural diagram of the optical system 1100 may be referred to in FIG. 32, where, W1=−1.1538 mm, W2=−9.4875 mm, an effective focal length of the optical system 1100 EFL=31.68 mm, a maximal field-of-view of the optical system 1100 FOV=20.3122°, an aperture value of the optical system 1100 in a first direction Fnox=1.9, and an aperture value of the optical system 1100 in a second direction Fnoy=1.9. When the photographed object is at a preset distance from the optical system 1100, the optical system 1100 is in the second state, and a structural diagram of the optical system 1100 may be referred to in FIG. 33.

In this embodiment, the object-side surface and the image-side surface of any lens in the first lens E1 to the eighth lens E8 are both aspheric surfaces. Table 22 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 11.

TABLE 22

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −47.710 | −1.89E−01 | −5.01E−02 | −7.65E−03 | −1.57E−03 | −3.32E−04 | −5.10E−05 | −1.00E−05 | −5.00E−06 | −1.00E−06 |
| S2 | 90.000 | −3.35E−01 | −7.46E−02 | −1.44E−02 | −3.21E−03 | −7.14E−04 | −1.41E−04 | −4.30E−05 | −1.60E−05 | 1.66E−09 |
| S4 | −90.000 | 8.68E−02 | −1.24E−03 | −1.04E−03 | 2.04E−04 | 8.00E−05 | 4.00E−06 | −3.10E−05 | 8.00E−06 | −4.00E−06 |
| S5 | −90.000 | −1.02E−02 | 3.25E−03 | −1.47E−03 | 3.10E−04 | 6.30E−05 | −1.80E−05 | −3.90E−05 | 1.00E−05 | −8.00E−06 |
| S6 | −90.000 | −5.75E−01 | 1.14E−01 | 5.91E−03 | 9.19E−03 | 1.04E−04 | 6.80E−05 | −3.20E−04 | 9.20E−05 | −2.60E−05 |
| S7 | 0.231 | −1.01E+00 | 1.73E−01 | −3.87E−03 | 9.57E−03 | −1.23E−03 | −1.34E−03 | 1.39E−04 | 1.94E−04 | −5.40E−05 |
| S8 | 0.046 | 1.93E+00 | −4.42E−02 | 2.31E−02 | −3.42E−03 | 2.19E−03 | −1.71E−03 | −7.10E−05 | 2.34E−04 | −4.20E−05 |
| S9 | −2.380 | 9.52E−01 | −9.23E−02 | 2.61E−02 | −8.62E−03 | 3.39E−03 | −1.38E−03 | 1.32E−04 | 8.70E−05 | −2.70E−05 |
| S10 | −73.513 | −8.37E−02 | −1.55E−02 | −9.69E−03 | −4.16E−03 | 3.60E−05 | −1.40E−05 | −2.13E−04 | 1.90E−05 | 5.00E−06 |
| S11 | −0.431 | −8.62E−02 | −3.83E−02 | −1.12E−02 | −4.44E−03 | −8.09E−04 | −1.97E−04 | −1.38E−04 | −3.80E−05 | 1.00E−06 |
| S12 | −0.095 | −2.92E+00 | 3.43E−01 | −8.22E−02 | 1.91E−02 | −3.78E−03 | 1.06E−03 | −7.20E−05 | 1.00E−06 | −9.00E−06 |
| S13 | −10.994 | −2.06E+00 | 1.71E−01 | −4.46E−02 | 3.99E−03 | −6.20E−04 | 1.80E−05 | 9.60E−05 | 6.90E−05 | 1.40E−05 |
| S14 | −90.000 | −1.39E−01 | 7.92E−02 | 2.78E−03 | 4.25E−03 | 1.27E−04 | 2.89E−04 | −8.50E−05 | 3.60E−05 | 2.00E−06 |
| S15 | 0.009 | −4.31E−03 | 2.91E−02 | −4.55E−04 | −8.06E−03 | 8.20E−04 | −1.20E−03 | −3.19E−04 | 2.63E−04 | −7.30E−05 |
| S16 | −90.000 | 1.12E+00 | −3.76E−01 | 1.90E−02 | −2.32E−02 | 7.74E−03 | −1.11E−03 | 5.03E−04 | 4.61E−04 | −2.43E−04 |
| S17 | 0.018 | 2.24E+00 | −2.56E−01 | 5.67E−02 | −1.74E−02 | 3.70E−03 | −1.71E−03 | 1.44E−04 | −7.00E−05 | −2.80E−05 |

FIG. 34A illustrates a longitudinal aberration curve of the optical system 1100 in the first state in Embodiment 11, representing deviations of focal points of light of different wavelengths converged after passing through the optical system 1100. FIG. 34B illustrates an astigmatic curve of the optical system 1100 in the first state in Embodiment 11, representing a curvature of a tangential image plane and a curvature of a sagittal image plane corresponding to different image heights. FIG. 34C illustrates a distortion curve of the optical system 1100 in the first state in Embodiment 11, representing amounts of distortion corresponding to different image heights. It can be seen from FIG. 34A, FIG. 34B and FIG. 34C that the optical system 1100 in Embodiment 11 can achieve a good imaging quality in the first state.

### Embodiment 12

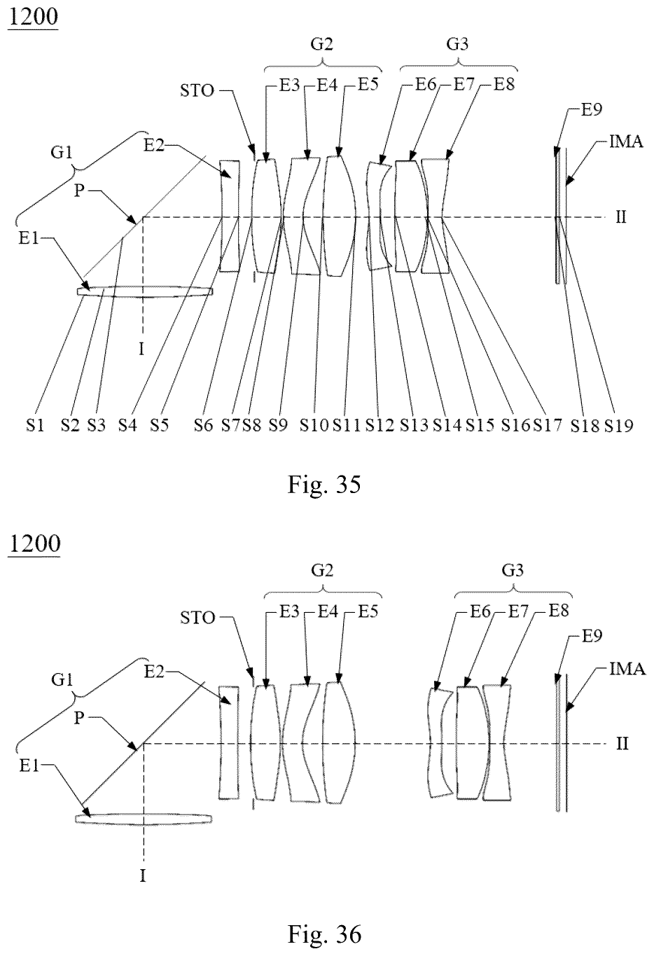

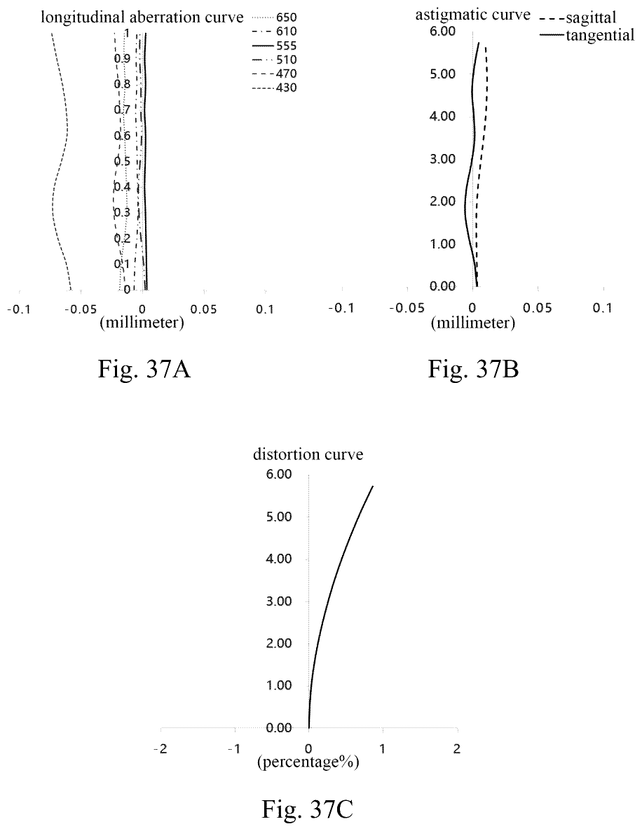

An optical system according to Embodiment 12 is described below with reference to FIG. 35, FIG. 36, FIG. 37A, FIG. 37B, and FIG. 37C.

As shown in FIG. 35 and FIG. 36, the optical system 1200 may include a first element group G1, a second element group G2 and a third element group G3 arranged sequentially from an object side to an image side. The image side may be provided with, for example, an image plane IMA. The imageable object distance range of the optical system 1200 may be from 10 cm to infinity. A magnification of the optical system 1200 may be 5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 1200 is decreased, adjusting the distance between the third element group G3 and the second element group G2 on the optical axis II enables the optical system 1200 to switch between a first state and a second state to achieve a focusing function of the optical system 1200. During the focusing of the optical system 1200, a maximal travelling distance of the third element group G3 may be 5.6900 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 23 shows a table of basic parameters of the optical system 1200 in Embodiment 12. Here, the units of the radius of curvature and the thickness/distance are millimeters (mm).

TABLE 23

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 66.0877 | 1.0000 | plastic | 1.516 | 56.999 |
| S2 | | aspheric | −141.5550 | 6.5392 | | | |
| S3 | reflective | spherical | infinite | −7.1433 | glass | | |
| | element | | | | | | |
| S4 | second | aspheric | 65.4234 | −1.5300 | plastic | 1.545 | 55.959 |
| | lens | | | | | | |
| S5 | | aspheric | −176.5540 | −1.4540 | | | |
| STO | aperture | spherical | infinite | 0.2540 | | | |
| S6 | third lens | aspheric | −33.5566 | −2.7410 | plastic | 1.541 | 56.102 |
| S7 | | aspheric | 13.3710 | −0.1906 | | | |
| S8 | fourth lens | aspheric | −8.4774 | −1.8219 | plastic | 1.651 | 21.637 |
| S9 | | aspheric | −4.6929 | −1.8609 | | | |
| S10 | fifth lens | aspheric | −34.7102 | −3.0000 | plastic | 1.542 | 56.058 |
| S11 | | aspheric | 11.3808 | W1 | | | |
| S12 | sixth lens | aspheric | 7.7252 | −1.0581 | plastic | 1.594 | 31.566 |
| S13 | | aspheric | 13.8024 | −1.3419 | | | |
| S14 | seventh | aspheric | 595.0080 | −3.0000 | plastic | 1.671 | 19.400 |
| | lens | | | | | | |
| S15 | | aspheric | 12.5619 | −0.0625 | | | |
| S16 | eighth | aspheric | −84.4283 | −1.3018 | plastic | 1.562 | 33.950 |
| | lens | | | | | | |
| S17 | | aspheric | −7.1614 | W2 | | | |
| S18 | optical | spherical | infinite | −0.2801 | glass | 1.517 | 64.210 |
| | filter | | | | | | |
| S19 | | spherical | infinite | −0.6599 | | | |
| IMA | image | spherical | infinite | | | | |
| | plane | | | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 35 and FIG. 36.

Here, an on-axis distance W1 from the second element group G2 to the third element group G3, and an on-axis distance W2 from the third element group G3 to the optical filter E9 are variables, which may change as the distance between the photographed object and the optical system 1200 changes.

When the photographed object is at infinity from the optical system 1200, the optical system 1200 is in the first state, and a structural diagram of the optical system 1200 may be referred to in FIG. 35, where, W1=−1.2426 mm, W2=−10.5278 mm, an effective focal length of the optical system 1200 EFL=31.70 mm, a maximal field-of-view of the optical system 1200 FOV=20.3122°, an aperture value of the optical system 1200 in a first direction Fnox=2.6, and an aperture value of the optical system 1200 in a second direction Fnoy=2.6. When the photographed object is at a preset distance from the optical system 1200, the optical system 1200 is in the second state, and a structural diagram of the optical system 1200 may be referred to in FIG. 36.

In this embodiment, the object-side surface and the image-side surface of any lens in the first lens E1 to the eighth lens E8 are both aspheric surfaces. Table 24 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 12.

TABLE 24

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −53.723 | −2.91E−02 | −4.51E−03 | −4.09E−04 | −3.50E−05 | −4.00E−05 | 7.00E−06 | −6.00E−06 | 4.00E−06 | −6.99E−08 |
| S2 | 90.000 | 4.02E−02 | −3.47E−03 | −4.21E−04 | −3.90E−05 | −3.70E−05 | 7.00E−06 | −5.00E−06 | 4.00E−06 | −1.00E−06 |
| S4 | −90.000 | 3.04E−02 | −1.15E−03 | 8.30E−05 | −8.70E−05 | 5.30E−05 | −1.60E−05 | 1.00E−06 | −1.00E−06 | −3.00E−06 |
| S5 | −84.353 | −5.84E−03 | −7.00E−06 | −1.10E−05 | −7.20E−05 | 4.40E−05 | −2.20E−05 | −3.00E−06 | −2.00E−06 | −3.00E−06 |
| S6 | −90.000 | −2.89E−01 | 3.04E−02 | −3.52E−03 | 1.34E−03 | −3.06E−04 | 1.03E−04 | −2.30E−05 | 4.00E−06 | 2.00E−06 |
| S7 | 0.213 | −5.51E−01 | 5.79E−02 | −7.49E−03 | 2.24E−03 | −3.81E−04 | 1.89E−04 | −4.20E−05 | 1.60E−05 | 6.00E−06 |
| S8 | 0.047 | 1.19E+00 | −4.04E−02 | 1.14E−02 | −2.41E−03 | 1.44E−03 | −7.90E−05 | 1.00E−06 | 2.60E−05 | −1.00E−06 |
| S9 | −2.372 | 7.79E−01 | −6.88E−02 | 2.46E−02 | −5.76E−03 | 4.12E−03 | −8.76E−04 | 1.40E−04 | −8.80E−05 | −1.40E−05 |
| S10 | −67.307 | −6.20E−02 | −7.02E−03 | −1.32E−03 | −1.64E−03 | 1.94E−03 | 3.20E−05 | −2.63E−04 | −1.33E−04 | −7.10E−05 |
| S11 | −0.395 | −5.95E−02 | −3.16E−02 | −8.05E−03 | −2.73E−03 | −8.10E−05 | −1.89E−04 | −1.92E−04 | −1.07E−04 | −5.10E−05 |
| S12 | −0.096 | −2.12E+00 | 2.41E−01 | −4.94E−02 | 9.89E−03 | −1.69E−03 | 5.70E−05 | 3.70E−05 | −8.40E−05 | 4.00E−06 |
| S13 | −10.298 | −1.80E+00 | 1.58E−01 | −3.36E−02 | 3.69E−03 | 2.61E−04 | −3.31E−04 | 7.60E−05 | −6.40E−05 | −3.30E−05 |
| S14 | −90.000 | −1.58E−01 | 6.77E−02 | 1.05E−03 | 2.71E−03 | 4.91E−04 | 6.40E−05 | 9.00E−06 | 1.00E−06 | −2.40E−05 |
| S15 | −0.098 | −1.63E−02 | 2.27E−02 | 3.76E−03 | −6.23E−03 | 1.85E−03 | −1.30E−03 | 2.39E−04 | −1.14E−04 | −2.20E−05 |
| S16 | −90.000 | 1.03E+00 | −2.96E−01 | 2.43E−02 | −1.87E−02 | 5.04E−03 | −1.80E−03 | 6.16E−04 | −1.53E−04 | −4.90E−05 |
| S17 | 0.036 | 1.91E+00 | −2.13E−01 | 4.71E−02 | −1.21E−02 | 2.80E−03 | −8.89E−04 | 1.57E−04 | −2.60E−05 | −1.80E−05 |

FIG. 37A illustrates a longitudinal aberration curve of the optical system 1200 in the first state in Embodiment 12, representing deviations of focal points of light of different wavelengths converged after passing through the optical system 1200. FIG. 37B illustrates an astigmatic curve of the optical system 1200 in the first state in Embodiment 12, representing a curvature of a tangential image plane and a curvature of a sagittal image plane corresponding to different image heights. FIG. 37C illustrates a distortion curve of the optical system 1200 in the first state in Embodiment 12, representing amounts of distortion corresponding to different image heights. It can be seen from FIG. 37A, FIG. 37B and FIG. 37C that the optical system 1200 in Embodiment 12 can achieve a good imaging quality in the first state.

### Embodiment 13

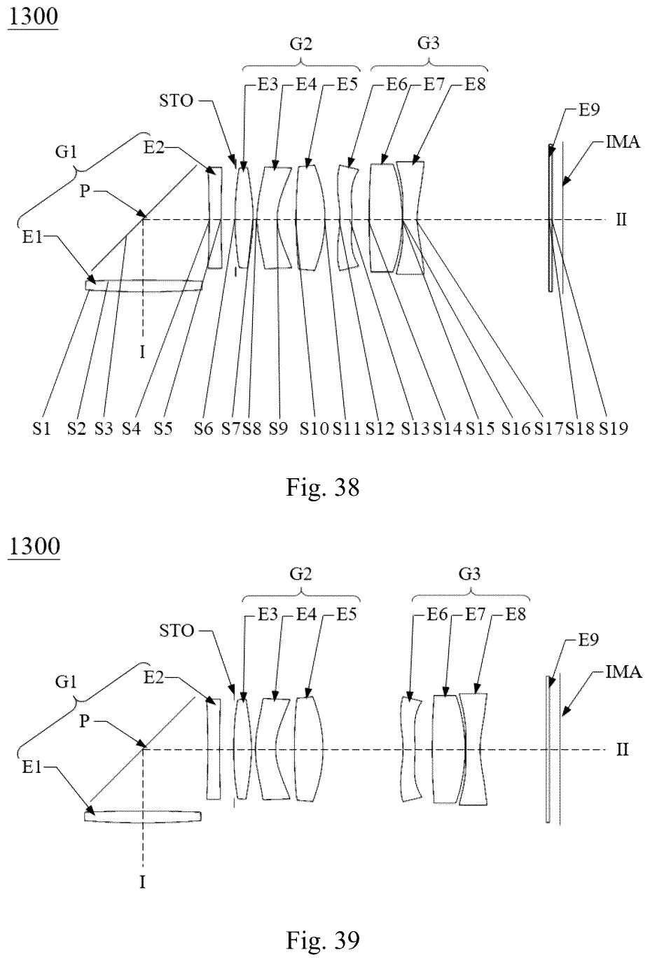

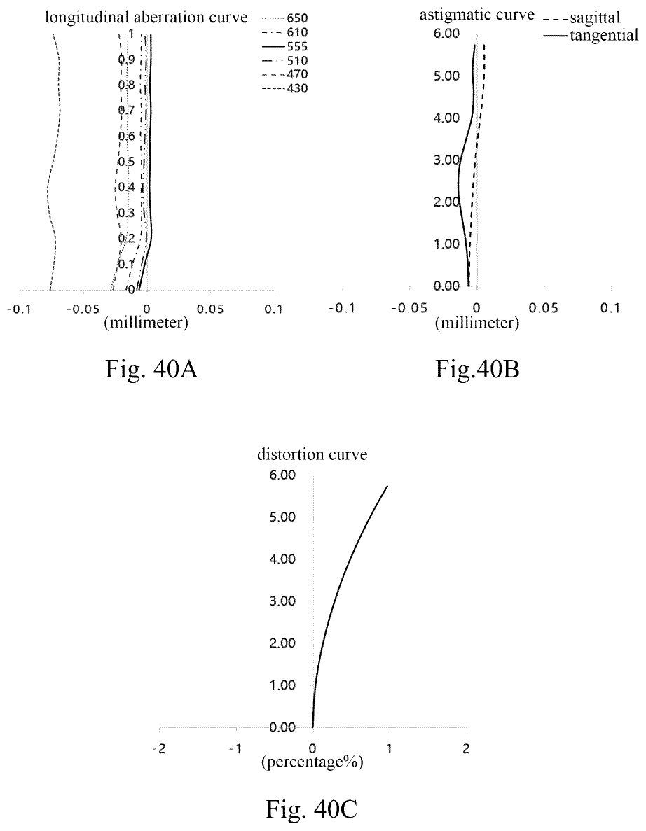

An optical system according to Embodiment 13 is described below with reference to FIG. 38, FIG. 39, FIG. 40A, FIG. 40B, and FIG. 40C.

As shown in FIG. 38 and FIG. 39, the optical system 1300 may include a first element group G1, a second element group G2 and a third element group G3 arranged sequentially from an object side to an image side. The image side may be provided with, for example, an image plane IMA. The range of imaging object distances of the optical system 1300 may be from 10 cm to infinity. A magnification of the optical system 1300 may be 5×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 1300 is decreased, adjusting the distance between the third element group G3 and the second element group G2 on the optical axis II enables the optical system 1300 to switch between a first state and a second state to achieve a focusing function of the optical system 1300. During the focusing of the optical system 1300, a maximal travelling distance of the third element group G3 may be 5.5307 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a convex surface, and an image-side surface S15 of the seventh lens E7 is a convex surface. The eighth lens E8 may have a negative refractive power, an object-side surface S16 of the eighth lens E8 is a convex surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 25 shows a table of basic parameters of the optical system 1300 in Embodiment 13. Here, the units of the radius of curvature and the thickness/distance are millimeters (mm).

TABLE 25

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 60.9398 | 1.0000 | plastic | 1.545 | 55.959 |
| S2 | | aspheric | −156.4190 | 5.2565 | | | |
| S3 | reflective | spherical | infinite | −5.5434 | glass | | |
| | element | | | | | | |
| S4 | second | aspheric | 94.0427 | −1.0000 | plastic | 1.542 | 50.348 |
| | lens | | | | | | |
| S5 | | aspheric | −108.8700 | −1.2455 | | | |
| STO | aperture | spherical | infinite | 0.0455 | | | |
| S6 | third lens | aspheric | −33.8333 | −1.5092 | plastic | 1.537 | 56.221 |
| S7 | | aspheric | 13.0842 | −0.3417 | | | |
| S8 | fourth lens | aspheric | −8.6367 | −1.7143 | plastic | 1.648 | 22.049 |
| S9 | | aspheric | −4.7208 | −1.5936 | | | |
| S10 | fifth lens | aspheric | −41.9012 | −2.4399 | plastic | 1.537 | 56.232 |
| S11 | | aspheric | 11.2843 | W1 | | | |
| S12 | sixth lens | aspheric | 7.9659 | −1.0204 | plastic | 1.585 | 34.067 |
| S13 | | aspheric | 13.6261 | −1.4688 | | | |
| S14 | seventh | aspheric | −1745.1600 | −2.7837 | plastic | 1.661 | 20.083 |
| | lens | | | | | | |
| S15 | | aspheric | 13.3939 | −0.0646 | | | |
| S16 | eighth | aspheric | −76.6495 | −1.2112 | plastic | 1.576 | 36.628 |
| | lens | | | | | | |
| S17 | | aspheric | −7.1792 | W2 | | | |
| S18 | optical | spherical | infinite | −0.2801 | glass | 1.517 | 64.210 |
| | filter | | | | | | |
| S19 | | spherical | infinite | −0.8790 | | | |
| IMA | image | spherical | infinite | | | | |
| | plane | | | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 38 and FIG. 39.

Here, an on-axis distance W1 from the second element group G2 to the third element group G3, and an on-axis distance W2 from the third element group G3 to the optical filter E9 are variables, which may change as the distance between the photographed object and the optical system 1300 changes.

When the photographed object is at infinity from the optical system 1300, the optical system 1300 is in the first state, and a structural diagram of the optical system 1300 may be referred to in FIG. 38, where, W1=−1.2789 mm, W2=−11.1713 mm, an effective focal length of the optical system 1300 EFL=31.70 mm, a maximal field-of-view of the optical system 1300 FOV=20.3122°, an aperture value of the optical system 1300 in a first direction Fnox=3.3, and an aperture value of the optical system 1300 in a second direction Fnoy=3.3. When the photographed object is at a preset distance from the optical system 1300, the optical system 1300 is in the second state, and a structural diagram of the optical system 1300 may be referred to in FIG. 39.

In this embodiment, the object-side surface and the image-side surface of any lens in the first lens E1 to the eighth lens E8 are both aspheric surfaces. Table 26 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 13.

TABLE 26

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −56.655 | −9.59E−03 | 2.59E−04 | 4.09E−04 | −1.00E−04 | 4.70E−05 | −2.60E−05 | 1.50E−05 | −7.00E−06 | 2.00E−06 |
| S2 | 90.000 | −1.57E−02 | 8.85E−04 | 4.06E−04 | −1.08E−04 | 5.20E−05 | −2.70E−05 | 1.60E−05 | −9.00E−06 | 3.00E−06 |
| S4 | −90.000 | 1.09E−02 | 9.76E−04 | −2.45E−04 | 8.20E−05 | −1.50E−05 | 1.20E−05 | −7.00E−06 | 2.00E−06 | −3.00E−06 |
| S5 | −41.333 | −1.71E−03 | 9.64E−04 | −2.12E−04 | 6.80E−05 | −1.10E−05 | 9.00E−06 | −6.00E−06 | 2.00E−06 | −2.00E−06 |
| S6 | −90.000 | −1.53E−01 | 1.45E−02 | −1.62E−03 | 5.70E−04 | −5.80E−05 | −3.00E−06 | −2.50E−05 | 1.80E−05 | 1.00E−06 |
| S7 | 0.256 | −2.77E−01 | 2.35E−02 | −2.69E−03 | 8.07E−04 | −5.80E−05 | −3.40E−05 | −2.70E−05 | 4.70E−05 | −9.00E−06 |
| S8 | 0.062 | 5.27E−01 | −2.25E−02 | 4.69E−03 | −8.12E−04 | 2.36E−04 | −5.00E−05 | −1.00E−05 | 3.60E−05 | −2.20E−05 |
| S9 | −2.362 | 3.41E−01 | −3.24E−02 | 9.90E−03 | −2.11E−03 | 8.26E−04 | −2.40E−05 | 4.40E−05 | 3.20E−05 | −5.00E−06 |
| S10 | −71.312 | −1.75E−02 | −6.39E−03 | 2.30E−03 | −6.61E−04 | 4.67E−04 | 2.40E−04 | 5.50E−05 | 5.30E−05 | 1.80E−05 |
| S11 | −0.592 | −1.63E−02 | −1.01E−02 | −1.03E−03 | −5.78E−04 | 1.46E−04 | 1.04E−04 | 3.00E−05 | 2.40E−05 | 1.30E−05 |
| S12 | −0.119 | −1.46E+00 | 1.52E−01 | −2.50E−02 | 4.11E−03 | −5.56E−04 | −2.03E−04 | −1.40E−05 | −4.70E−05 | 6.00E−06 |
| S13 | −10.676 | −1.19E+00 | 9.63E−02 | −1.39E−02 | 1.19E−03 | 3.84E−04 | −1.38E−04 | 7.00E−06 | −2.30E−05 | −1.40E−05 |
| S14 | −90.000 | −1.49E−01 | 3.51E−02 | −1.24E−03 | 8.03E−04 | 1.88E−04 | 4.10E−05 | −8.00E−06 | 3.00E−06 | −1.20E−05 |
| S15 | −0.105 | −2.72E−02 | 1.20E−02 | 4.37E−03 | −3.29E−03 | 1.64E−03 | −6.27E−04 | 1.83E−04 | −4.00E−06 | −2.30E−05 |
| S16 | −90.000 | 8.50E−01 | −1.69E−01 | 2.28E−02 | −9.55E−03 | 3.03E−03 | −1.20E−03 | 3.47E−04 | −6.60E−05 | −6.80E−05 |
| S17 | 0.058 | 1.34E+00 | −1.45E−01 | 2.96E−02 | −6.36E−03 | 1.54E−03 | −4.07E−04 | 8.70E−05 | 4.00E−06 | −9.00E−06 |

FIG. 40A illustrates a longitudinal aberration curve of the optical system 1300 in the first state in Embodiment 13, representing deviations of focal points of light of different wavelengths converged after passing through the optical system 1300. FIG. 40B illustrates an astigmatic curve of the optical system 1300 in the first state in Embodiment 13, representing a curvature of a tangential image plane and a curvature of a sagittal image plane corresponding to different image heights. FIG. 40C illustrates a distortion curve of the optical system 1300 in the first state in Embodiment 13, representing amounts of distortion corresponding to different image heights. It can be seen from FIG. 40A, FIG. 40B and FIG. 40C that the optical system 1300 in Embodiment 13 can achieve a good imaging quality in the first state.

### Embodiment 14

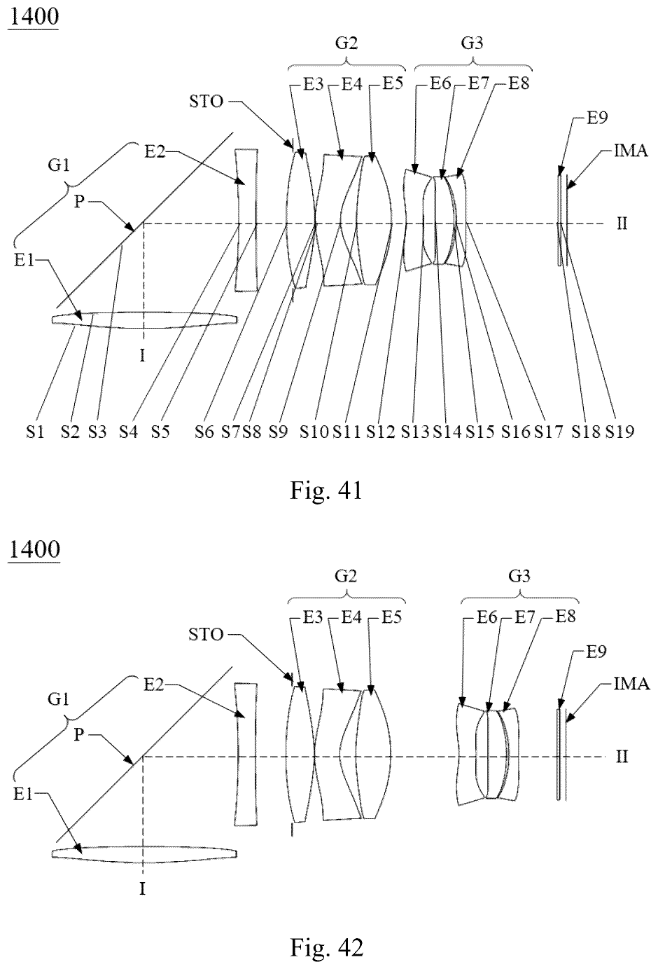

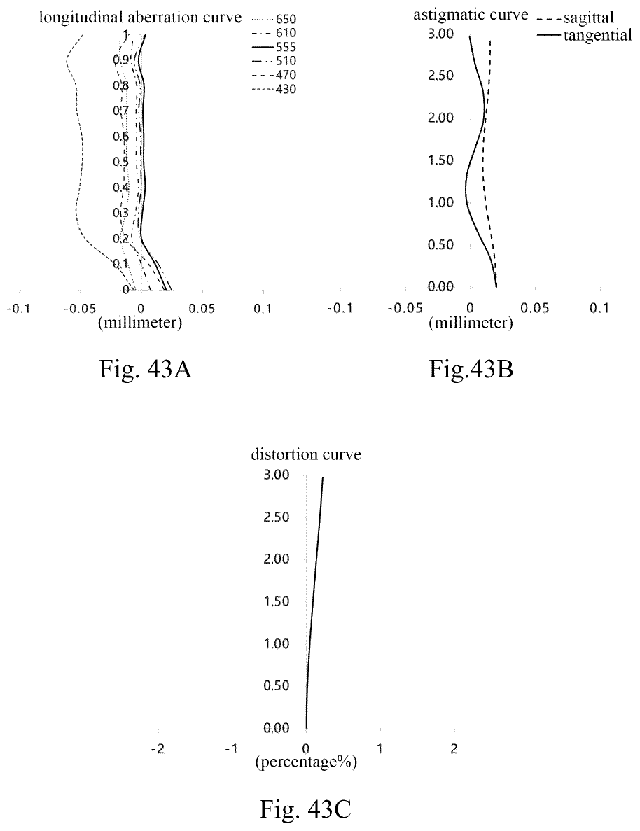

An optical system according to Embodiment 14 is described below with reference to FIG. 41, FIG. 42, FIG. 43A, FIG. 43B, and FIG. 43C.

As shown in FIG. 41 and FIG. 42, the optical system 1400 may include a first element group G1, a second element group G2 and a third element group G3 arranged sequentially from an object side to an image side. The image side may be provided with, for example, an image plane IMA. The imageable object distance range of the optical system 1400 may be from 10 cm to infinity. A magnification of the optical system 1400 may be 8×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 1400 is decreased, adjusting the distance between the third element group G3 and the second element group G2 on the optical axis II enables the optical system 1400 to switch between a first state and a second state to achieve a focusing function of the optical system 1400. During the focusing of the optical system 1400, a maximal travelling distance of the third element group G3 may be 4.3025 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a concave surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 27 shows a table of basic parameters of the optical system 1400 in Embodiment 14. Here, the units of the radius of curvature and the thickness/distance are millimeters (mm).

TABLE 27

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 42.4714 | 1.2963 | plastic | 1.545 | 55.959 |
| S2 | | aspheric | −162.2700 | 7.3953 | | | |
| S3 | reflective | spherical | infinite | −7.5543 | glass | | |
| | element | | | | | | |
| S4 | second | aspheric | 44.9803 | −1.3733 | plastic | 1.632 | 22.480 |
| | lens | | | | | | |
| S5 | | aspheric | −345.5260 | −2.9439 | | | |
| STO | aperture | spherical | infinite | 0.6753 | | | |
| S6 | third lens | aspheric | −29.9685 | −2.2763 | plastic | 1.545 | 55.959 |
| S7 | | aspheric | 11.5909 | −0.0300 | | | |
| S8 | fourth lens | aspheric | −7.4284 | −2.0206 | plastic | 1.596 | 26.769 |
| S9 | | aspheric | −3.6472 | −1.2864 | | | |
| S10 | fifth lens | aspheric | −13.8042 | −2.8000 | plastic | 1.545 | 55.959 |
| S11 | | aspheric | 10.8970 | W1 | | | |
| S12 | sixth lens | aspheric | 6.8496 | −1.3767 | plastic | 1.599 | 30.349 |
| S13 | | aspheric | 14.6806 | −0.9556 | | | |
| S14 | seventh | aspheric | 92.2795 | −1.5030 | plastic | 1.671 | 19.400 |
| | lens | | | | | | |
| S15 | | aspheric | 8.4898 | −0.1934 | | | |
| S16 | eighth | aspheric | 7.3905 | −0.7500 | plastic | 1.556 | 38.777 |
| | lens | | | | | | |
| S17 | | aspheric | −42.4160 | W2 | | | |
| S18 | optical | spherical | infinite | −0.2100 | glass | 1.517 | 64.210 |
| | filter | | | | | | |
| S19 | | spherical | infinite | −0.4941 | | | |
| IMA | image | spherical | infinite | | | | |
| | plane | | | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 41 and FIG. 42.

Here, an on-axis distance W1 from the second element group G2 to the third element group G3, and an on-axis distance W2 from the third element group G3 to the optical filter E9 are variables, which may change as the distance between the photographed object and the optical system 1400 changes.

When the photographed object is at infinity from the optical system 1400, the optical system 1400 is in the first state, and a structural diagram of the optical system 1400 may be referred to in FIG. 41, where, W1=−1.1817 mm, W2=−7.4147 mm, an effective focal length of the optical system 1400 EFL=27.73 mm, a maximal field-of-view of the optical system 1400 FOV=12.3122°, an aperture value of the optical system 1400 in a first direction Fnox=1.9, and an aperture value of the optical system 1400 in a second direction Fnoy=1.9. When the photographed object is at a preset distance from the optical system 1400, the optical system 1400 is in the second state, and a structural diagram of the optical system 1400 may be referred to in FIG. 42.

In this embodiment, the object-side surface and the image-side surface of any lens in the first lens E1 to the eighth lens E8 are both aspheric surfaces. Table 28 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 14.

TABLE 28

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −29.839 | −8.21E−02 | −2.56E−02 | −6.46E−03 | −1.25E−03 | −5.55E−04 | −3.90E−05 | −4.30E−05 | 2.20E−05 | −2.40E−05 |
| S2 | 90.000 | −1.64E−01 | −1.86E−02 | −6.79E−03 | −1.10E−03 | −5.28E−04 | −2.10E−05 | −3.30E−05 | 2.10E−05 | −2.60E−05 |
| S4 | −90.000 | 2.08E−02 | 2.57E−03 | −7.60E−05 | −4.86E−04 | 3.18E−04 | −1.79E−04 | 2.00E−05 | 1.30E−05 | 4.00E−06 |
| S5 | −90.000 | −7.78E−02 | 8.37E−03 | −7.93E−04 | −3.33E−04 | 2.67E−04 | −1.60E−04 | 2.10E−05 | 1.30E−05 | 4.00E−06 |
| S6 | −90.000 | −4.08E−01 | 5.31E−02 | −1.93E−02 | −7.59E−04 | 4.07E−03 | −2.39E−04 | 7.80E−05 | 3.40E−05 | −8.00E−06 |
| S7 | 0.419 | −6.85E−01 | 7.11E−02 | −3.14E−02 | −1.72E−03 | −5.15E−03 | −2.74E−04 | 1.30E−05 | −1.29E−04 | −3.60E−05 |
| S8 | 0.041 | 1.62E+00 | −8.00E−02 | 3.66E−03 | −1.19E−02 | 1.75E−03 | 1.18E−04 | 7.90E−05 | −7.10E−05 | −9.70E−05 |
| S9 | −2.381 | 8.42E−01 | −1.28E−01 | 1.74E−02 | −1.71E−02 | 8.02E−03 | −1.63E−03 | −3.20E−04 | −1.31E−04 | −2.07E−04 |
| S10 | −52.954 | −1.38E−01 | −5.60E−03 | −1.83E−02 | 1.72E−04 | 2.87E−03 | 1.12E−03 | −1.05E−03 | 1.72E−04 | −1.63E−04 |
| S11 | 0.038 | 6.41E−03 | −4.02E−02 | −1.17E−04 | 1.70E−04 | 1.28E−03 | 2.48E−04 | 4.40E−05 | 1.51E−04 | 3.30E−05 |
| S12 | −0.170 | −1.44E+00 | 1.62E−01 | −2.98E−02 | 5.88E−03 | −8.22E−04 | 2.14E−04 | −1.80E−05 | −3.10E−05 | 1.00E−05 |
| S13 | −139.883 | −9.98E−01 | 8.26E−02 | 1.38E−02 | 8.64E−03 | 5.95E−03 | 2.47E−03 | 1.30E−03 | 3.40E−04 | 1.07E−04 |
| S14 | −90.000 | −2.26E−02 | 7.22E−02 | 1.49E−02 | 6.80E−03 | 1.74E−03 | 1.63E−03 | 7.07E−04 | 2.35E−04 | 6.90E−05 |
| S15 | 0.172 | 1.82E−02 | 3.65E−02 | 6.53E−03 | −2.26E−03 | −1.45E−03 | 1.43E−03 | 6.43E−04 | 1.49E−04 | 1.18E−04 |
| S16 | −24.428 | 4.77E−01 | −2.02E−02 | 1.49E−02 | −2.40E−03 | 1.06E−03 | 1.90E−03 | 1.09E−03 | 3.17E−04 | 1.87E−04 |
| S17 | 90.000 | 4.83E−01 | 2.56E−02 | 4.06E−03 | 2.58E−03 | 3.09E−04 | 2.63E−04 | 2.50E−05 | −2.60E−05 | −3.40E−05 |

FIG. 43A illustrates a longitudinal aberration curve of the optical system 1400 in the first state in Embodiment 14, representing deviations of focal points of light of different wavelengths converged after passing through the optical system 1400. FIG. 43B illustrates an astigmatic curve of the optical system 1400 in the first state in Embodiment 14, representing a curvature of a tangential image plane and a curvature of a sagittal image plane corresponding to different image heights. FIG. 43C illustrates a distortion curve of the optical system 1400 in the first state in Embodiment 14, representing amounts of distortion corresponding to different image heights. It can be seen from FIG. 43A, FIG. 43B and FIG. 43C that the optical system 1400 in Embodiment 14 can achieve a good imaging quality in the first state.

### Embodiment 15

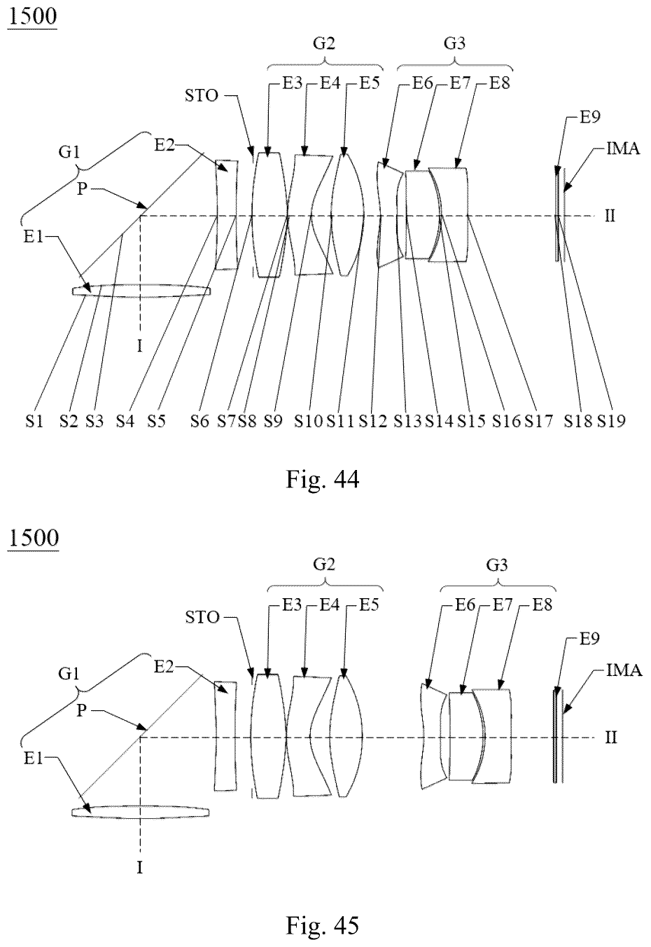

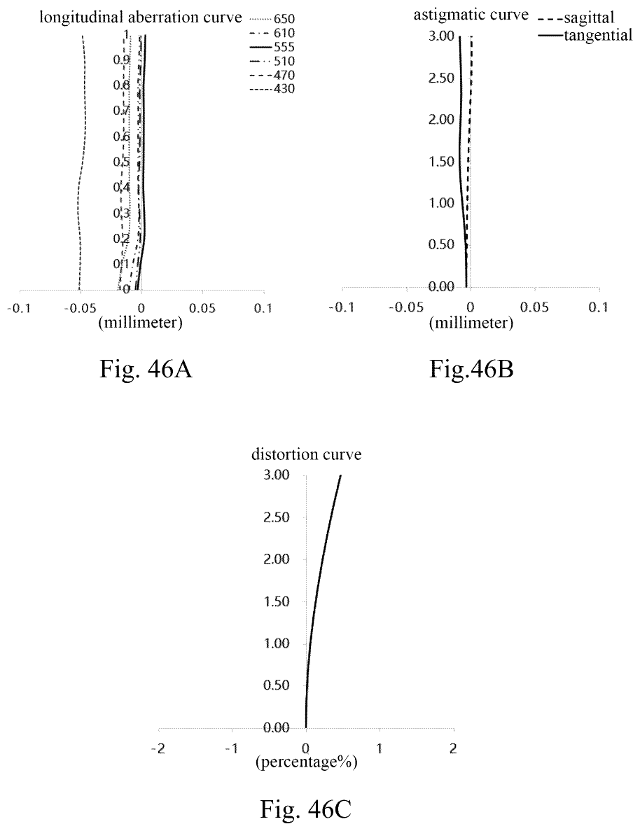

An optical system according to Embodiment 15 is described below with reference to FIG. 44, FIG. 45, FIG. 46A, FIG. 46B, and FIG. 46C.

As shown in FIG. 44 and FIG. 45, the optical system 1500 may include a first element group G1, a second element group G2 and a third element group G3 arranged sequentially from an object side to an image side. The image side may be provided with, for example, an image plane IMA. The imageable object distance range of the optical system 1500 may be from 10 cm to infinity. A magnification of the optical system 1500 may be 8×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 1500 is decreased, adjusting the distance between the third element group G3 and the second element group G2 on the optical axis II enables the optical system 1500 to switch between a first state and a second state to achieve a focusing function of the optical system 1500. During the focusing of the optical system 1500, a maximal travelling distance of the third element group G3 may be 3.5912 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a concave surface, and an image-side surface S17 of the eighth lens E8 is a concave surface. The optical filter E9 may have an object-side surface S18 and an image-side surface S19. Light from an object sequentially passes through the surfaces S1-S19 and finally forms an image on an image plane S20.

Table 29 shows a table of basic parameters of the optical system 1500 in Embodiment 15. Here, the units of the radius of curvature and the thickness/distance are millimeters (mm).

TABLE 29

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 50.1839 | 1.0000 | plastic | 1.545 | 55.959 |
| S2 | | aspheric | −74.3100 | 5.5210 | | | |
| S3 | reflective | spherical | infinite | −6.0167 | glass | | |
| | element | | | | | | |
| S4 | second | aspheric | 48.0472 | −1.5000 | plastic | 1.555 | 48.173 |
| | lens | | | | | | |
| S5 | | aspheric | −124.0480 | −1.3357 | | | |
| STO | aperture | spherical | infinite | 0.0857 | | | |
| S6 | third lens | aspheric | −25.4888 | −2.8000 | plastic | 1.545 | 55.959 |
| S7 | | aspheric | 11.5971 | −0.0300 | | | |
| S8 | fourth lens | aspheric | −7.6319 | −1.8774 | plastic | 1.615 | 25.696 |
| S9 | | aspheric | −3.3941 | −1.5710 | | | |
| S10 | fifth lens | aspheric | −11.2164 | −2.5866 | plastic | 1.545 | 55.959 |
| S11 | | aspheric | 9.9219 | W1 | | | |
| S12 | sixth lens | aspheric | 6.6178 | −1.3353 | plastic | 1.595 | 31.318 |
| S13 | | aspheric | 17.2766 | −0.7357 | | | |
| S14 | seventh | aspheric | 44.3835 | −2.6293 | plastic | 1.671 | 19.400 |
| | lens | | | | | | |
| S15 | | aspheric | 7.3269 | −0.1617 | | | |
| S16 | eighth | aspheric | 7.0423 | −2.0732 | plastic | 1.567 | 34.306 |
| | lens | | | | | | |
| S17 | | aspheric | −80.6094 | W2 | | | |
| S18 | optical | spherical | infinite | −0.2100 | glass | 1.517 | 64.210 |
| | filter | | | | | | |
| S19 | | spherical | infinite | −0.4941 | | | |
| IMA | image | spherical | infinite | | | | |
| | plane | | | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 44 and FIG. 45.

Here, an on-axis distance W1 from the second element group G2 to the third element group G3, and an on-axis distance W2 from the third element group G3 to the optical filter E9 are variables, which may change as the distance between the photographed object and the optical system 1500 changes.

When the photographed object is at infinity from the optical system 1500, the optical system 1500 is in the first state, and a structural diagram of the optical system 1500 may be referred to in FIG. 44, where, W1=−1.3070 mm, W2=−6.9702 mm, an effective focal length of the optical system 1500 EFL=27.73 mm, a maximal field-of-view of the optical system 1500 FOV=12.3122°, an aperture value of the optical system 1500 in a first direction Fnox=2.591, and an aperture value of the optical system 1500 in a second direction Fnoy=2.591. When the photographed object is at a preset distance from the optical system 1500, the optical system 1500 is in the second state, and a structural diagram of the optical system 1500 may be referred to in FIG. 45.

In this embodiment, the object-side surface and the image-side surface of any lens in the first lens E1 to the eighth lens E8 are both aspheric surfaces. Table 30 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 15.

TABLE 30

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −79.174 | −4.29E−02 | −7.59E−03 | −5.04E−04 | −2.85E−04 | −1.30E−05 | −6.00E−06 | 1.00E−06 | −2.00E−06 | 1.05E−07 |
| S2 | 90.000 | −5.57E−02 | −2.45E−03 | −5.68E−04 | −2.49E−04 | −7.00E−06 | −7.00E−06 | 1.00E−06 | −2.00E−06 | 1.00E−06 |
| S4 | −90.000 | −2.21E−02 | −4.45E−03 | 7.96E−04 | −1.39E−04 | 3.70E−05 | −1.10E−05 | 2.00E−06 | 2.00E−06 | −2.00E−06 |
| S5 | 90.000 | −4.55E−02 | −2.79E−03 | 6.14E−04 | −1.10E−04 | 3.10E−05 | −9.00E−06 | 1.56E−07 | 2.00E−06 | −2.00E−06 |
| S6 | −90.000 | −2.61E−01 | 5.03E−02 | −1.11E−02 | 1.20E−03 | −1.18E−03 | 3.04E−04 | 5.50E−05 | 8.20E−05 | −6.00E−06 |
| S7 | 0.204 | −5.45E−01 | 8.49E−02 | −1.79E−02 | 7.02E−03 | −4.76E−04 | 1.19E−03 | −3.18E−04 | −3.06E−04 | −1.82E−04 |
| S8 | 0.028 | 1.15E+00 | −5.64E−02 | 9.93E−03 | −2.90E−03 | 1.18E−03 | −4.59E−04 | −5.80E−04 | −6.82E−04 | −2.68E−04 |
| S9 | −2.307 | 5.98E−01 | −7.94E−02 | 2.21E−02 | −1.10E−02 | 3.85E−03 | −2.61E−03 | −5.62E−04 | −8.94E−04 | −6.80E−05 |
| S10 | −30.717 | −2.11E−01 | 5.08E−02 | −1.27E−02 | −1.59E−03 | 4.51E−04 | 2.62E−04 | −2.62E−04 | −3.10E−04 | −1.96E−04 |
| S11 | 0.249 | 3.39E−02 | −8.96E−03 | −1.84E−03 | −2.72E−03 | 9.90E−05 | 2.06E−04 | 3.05E−04 | 1.03E−04 | −9.00E−06 |
| S12 | 0.031 | −1.48E+00 | 1.54E−01 | −3.68E−02 | 4.49E−03 | −1.60E−03 | 3.04E−04 | 5.38E−04 | 1.70E−04 | 1.95E−04 |
| S13 | −63.519 | −7.83E−01 | 6.46E−02 | −4.81E−03 | 1.16E−03 | 1.47E−03 | −4.50E−05 | 3.78E−04 | 3.60E−05 | −1.00E−05 |
| S14 | −90.000 | −7.28E−02 | 2.70E−02 | 2.11E−03 | 1.25E−03 | 1.43E−03 | 1.70E−04 | 3.74E−04 | 7.70E−05 | 1.10E−05 |
| S15 | −0.459 | −1.76E−02 | 1.46E−02 | 2.08E−03 | −1.27E−03 | 1.40E−03 | −5.51E−04 | 1.90E−04 | −4.10E−05 | −2.90E−05 |
| S16 | −21.974 | 5.69E−01 | −5.93E−02 | 1.05E−02 | −8.24E−03 | 3.31E−04 | −2.76E−03 | −1.65E−04 | −4.21E−04 | −5.50E−05 |
| S17 | 90.000 | 2.20E−01 | −1.86E−03 | −2.95E−04 | 1.47E−04 | −1.09E−04 | −2.60E−05 | −7.00E−06 | 1.20E−05 | −1.00E−06 |

FIG. 46A illustrates a longitudinal aberration curve of the optical system 1500 in the first state in Embodiment 15, representing deviations of focal points of light of different wavelengths converged after passing through the optical system 1500. FIG. 46B illustrates an astigmatic curve of the optical system 1500 in the first state in Embodiment 15, representing a curvature of a tangential image plane and a curvature of a sagittal image plane corresponding to different image heights. FIG. 46C illustrates a distortion curve of the optical system 1500 in the first state in Embodiment 15, representing amounts of distortion corresponding to different image heights. It can be seen from FIG. 46A, FIG. 46B and FIG. 46C that the optical system 1500 in Embodiment 15 can achieve a good imaging quality in the first state.

### Embodiment 16

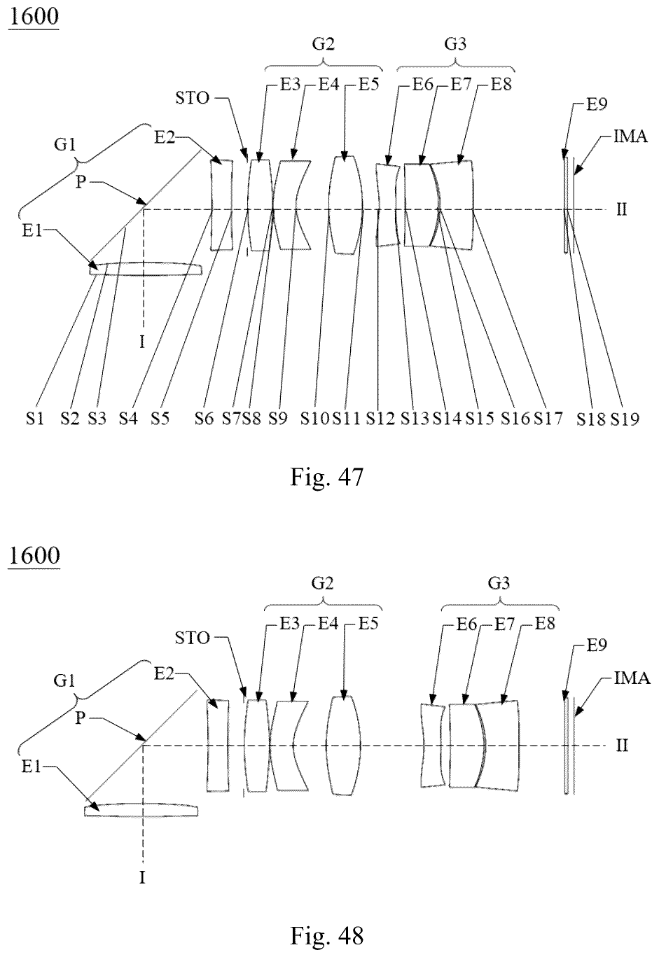

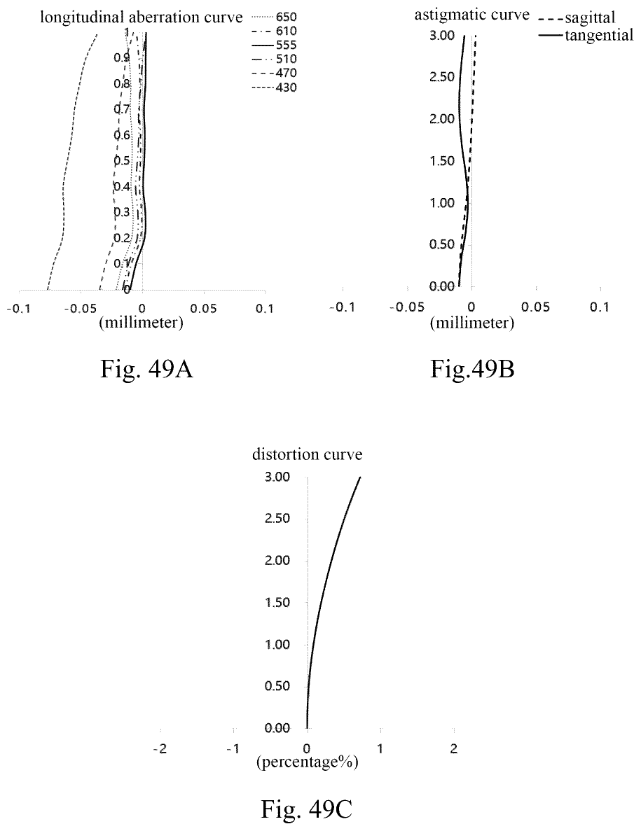

An optical system according to Embodiment 16 is described below with reference to FIG. 47, FIG. 48, FIG. 49A, FIG. 49B, and FIG. 49C.

As shown in FIG. 47 and FIG. 48, the optical system 1600 may include a first element group G1, a second element group G2 and a third element group G3 arranged sequentially from an object side to an image side. The image side may be provided with, for example, an image plane IMA. The imageable object distance range of the optical system 1600 may be from 10 cm to infinity. A magnification of the optical system 1600 may be 8×.

The first element group G1 may include a first lens E1, a reflective element P and a second lens E2. The second element group G2 may include a diaphragm STO, a third lens E3, a fourth lens E4 and a fifth lens E5. The third element group G3 may include a sixth lens E6, a seventh lens E7 and an eighth lens E8. In particular, the first lens E1 is located on the optical axis I and is disposed between the object side and the reflective element P. The second lens E2, the diaphragm STO, the third lens E3, the fourth lens E4, the fifth lens E5, the sixth lens E6, the seventh lens E7, and the eighth lens E8 are arranged sequentially along the optical axis II from the reflective element P to the image side. In an example, an optical filter E9 may be disposed between the eighth lens E8 and the image plane IMA.

During focusing process, the positions of the first element group G1 and the second element group G2 relative to the image plane IMA on the optical axis II are fixed. The third element group G3 is movable along the optical axis II relative to the second element group G2. When the distance between a photographed object and the optical system 1600 is decreased, adjusting the distance between the third element group G3 and the second element group G2 on the optical axis II enables the optical system 1600 to switch between a first state and a second state to achieve a focusing function of the optical system 1600. During the focusing of the optical system 1600, a maximal travelling distance of the third element group G3 may be 3.5362 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a convex surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a convex surface. The sixth lens E6 may have a negative refractive power, an object-side surface S12 of the sixth lens E6 is a concave surface, and an image-side surface S13 of the sixth lens E6 is a convex surface. The seventh lens E7 may have a positive refractive power, an object-side surface S14 of the seventh lens E7 is a concave surface, and an image-side surface S15 of the seventh lens E7 is a convex surface. The eighth lens E8 may have a negative refractive power, an object-side surface S16 of the eighth lens E8 is a concave surface, and an image-side surface S17 of the eighth lens E8 is a convex surface. The optical filter E9 may have an object-side surface S18 and an image-side surface S19. Light from an object sequentially passes through the surfaces S1-S19 and finally forms an image on an image plane S20.

Table 31 shows a table of basic parameters of the optical system 1600 in Embodiment 16. Here, the units of the radius of curvature and the thickness/distance are millimeters (mm).

TABLE 31

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 58.6801 | 1.0000 | plastic | 1.545 | 55.959 |
| S2 | | aspheric | −49.3551 | 4.3989 | | | |
| S3 | reflective | spherical | infinite | −5.0930 | glass | | |
| | element | | | | | | |
| S4 | second | aspheric | 49.2675 | −1.5000 | plastic | 1.546 | 54.656 |
| | lens | | | | | | |
| S5 | | aspheric | −112.2740 | −1.2152 | | | |
| STO | aperture | spherical | infinite | −0.0348 | | | |
| S6 | third lens | aspheric | −22.6141 | −1.9204 | plastic | 1.545 | 55.959 |
| S7 | | aspheric | 13.5050 | −0.0330 | | | |
| S8 | fourth lens | aspheric | −7.0421 | −1.7578 | plastic | 1.625 | 24.690 |
| S9 | | aspheric | −3.3912 | −2.5053 | | | |
| S10 | fifth lens | aspheric | −11.2991 | −2.5936 | plastic | 1.545 | 55.959 |
| S11 | | aspheric | 10.7085 | W1 | | | |
| S12 | sixth lens | aspheric | 6.9042 | −1.2783 | plastic | 1.602 | 29.610 |
| S13 | | aspheric | 19.1680 | −0.7195 | | | |
| S14 | seventh | aspheric | 34.9124 | −2.5493 | plastic | 1.671 | 19.400 |
| | lens | | | | | | |
| S15 | | aspheric | 6.8283 | −0.1302 | | | |
| S16 | eighth | aspheric | 6.5670 | −2.5404 | plastic | 1.584 | 32.103 |
| | lens | | | | | | |
| S17 | | aspheric | 49928.9000 | W2 | | | |
| S18 | optical | spherical | infinite | −0.2100 | glass | 1.517 | 64.210 |
| | filter | | | | | | |
| S19 | | spherical | infinite | −0.4941 | | | |
| IMA | image | spherical | infinite | | | | |
| | plane | | | | | | |

In this embodiment, the positive or negative sign of the numerical value of the radius of curvature of each surface merely indicates a bending direction of the surface. When a surface of a lens on the optical axis I and a surface of a lens on the optical axis II have the same bending direction, the positive or negative attribute of the numerical value for the radii of curvature of the surfaces are opposite to each other. Similarly, the positive or negative sign of the numerical value of the thickness/distance corresponding to each surface indicates the direction only. The bending direction of each surface and the thickness/distance of each surface may be referred to in FIG. 47 and FIG. 48.

Here, an on-axis distance W1 from the second element group G2 to the third element group G3, and an on-axis distance W2 from the third element group G3 to the optical filter E9 are variables, which may change as the distance between the photographed object and the optical system 1600 changes.

When the photographed object is at infinity from the optical system 1600, the optical system 1600 is in the first state, and a structural diagram of the optical system 1600 may be referred to in FIG. 47, where, W1=−1.2964 mm, W2=−7.0189 mm, an effective focal length of the optical system 1600 EFL=27.73 mm, a maximal field-of-view of the optical system 1600 FOV=12.3122°, an aperture value of the optical system 1600 in a first direction Fnox=3.3, and an aperture value of the optical system 1600 in a second direction Fnoy=3.3. When the photographed object is at a preset distance from the optical system 1600, the optical system 1600 is in the second state, and a structural diagram of the optical system 1600 may be referred to in FIG. 48.

In this embodiment, the object-side surface and the image-side surface of any lens in the first lens E1 to the eighth lens E8 are both aspheric surfaces. Table 32 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S17 in Embodiment 16.

TABLE 32

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −305.477 | −4.57E−02 | −8.52E−03 | −7.80E−05 | −1.54E−04 | 1.00E−05 | −1.80E−05 | 1.00E−06 | −6.00E−06 | 2.00E−06 |
| S2 | 90.000 | −3.85E−02 | −4.54E−04 | 2.47E−04 | 3.20E−05 | 2.60E−05 | −7.00E−06 | 2.00E−06 | −4.00E−06 | 2.00E−06 |
| S4 | −90.000 | −1.26E−02 | −1.86E−03 | 1.98E−04 | −8.00E−06 | −1.80E−05 | 1.30E−05 | −8.00E−06 | 4.00E−06 | −1.00E−06 |
| S5 | 90.000 | −2.14E−02 | −1.36E−03 | 1.59E−04 | −8.00E−06 | −1.30E−05 | 1.00E−05 | −9.00E−06 | 4.00E−06 | −3.62E−08 |
| S6 | −90.000 | −2.60E−01 | 5.51E−02 | −2.01E−02 | 4.29E−03 | −1.29E−03 | −4.22E−04 | −6.67E−04 | −5.78E−04 | −1.80E−04 |
| S7 | 0.429 | −5.43E−01 | 8.72E−02 | −2.31E−02 | 1.05E−02 | −2.46E−03 | 1.75E−03 | 2.30E−04 | −5.48E−04 | −2.81E−04 |
| S8 | 0.054 | 1.14E+00 | −5.70E−02 | 1.02E−02 | −1.29E−03 | −4.40E−04 | −2.01E−04 | −3.24E−04 | −3.93E−04 | −2.12E−04 |
| S9 | −2.311 | 6.13E−01 | −7.94E−02 | 1.68E−02 | −7.50E−03 | 3.07E−03 | −3.27E−03 | −1.11E−03 | −3.74E−04 | −4.80E−05 |
| S10 | −30.253 | −2.14E−01 | 5.59E−02 | −1.82E−02 | −4.41E−04 | 5.60E−05 | 4.80E−04 | −6.47E−04 | 5.00E−05 | 3.60E−05 |
| S11 | 0.044 | 1.28E−02 | 8.08E−04 | 5.75E−04 | −1.48E−03 | 2.51E−04 | −4.80E−05 | −3.71E−04 | −2.80E−05 | −1.00E−06 |
| S12 | 0.114 | −1.46E+00 | 1.46E−01 | −3.31E−02 | 3.60E−03 | −2.06E−03 | 8.91E−04 | 7.05E−04 | −1.80E−04 | −2.05E−04 |
| S13 | −60.755 | −5.59E−01 | 3.75E−02 | −3.43E−03 | −2.76E−04 | 6.41E−04 | −2.80E−05 | −1.02E−04 | −2.40E−05 | 1.00E−06 |
| S14 | −90.000 | −6.69E−02 | 1.87E−02 | 8.48E−04 | −8.16E−04 | 1.99E−04 | −2.14E−04 | −9.70E−05 | −4.10E−05 | −5.00E−06 |
| S15 | −0.798 | −3.54E−02 | 9.86E−03 | 2.35E−03 | −1.97E−03 | 8.75E−04 | −9.19E−04 | 2.28E−04 | −6.10E−05 | −3.00E−06 |
| S16 | −20.271 | 5.77E−01 | −7.72E−02 | 1.56E−02 | −9.88E−03 | −9.88E−04 | −3.60E−03 | 1.17E−04 | −8.66E−04 | 9.90E−05 |
| S17 | 90.000 | 1.86E−01 | −3.98E−03 | 2.23E−03 | 1.20E−03 | −3.00E−06 | −2.02E−04 | −1.59E−04 | −9.00E−05 | −1.80E−05 |

FIG. 49A illustrates a longitudinal aberration curve of the optical system 1600 in the first state in Embodiment 16, representing deviations of focal points of light of different wavelengths converged after passing through the optical system 1600. FIG. 49B illustrates an astigmatic curve of the optical system 1600 in the first state in Embodiment 16, representing a curvature of a tangential image plane and a curvature of a sagittal image plane corresponding to different image heights. FIG. 49C illustrates a distortion curve of the optical system 1600 in the first state in Embodiment 16, representing amounts of distortion corresponding to different image heights. It can be seen from FIG. 49A, FIG. 49B and FIG. 49C that the optical system 1600 in Embodiment 16 can achieve a good imaging quality in the first state.

In the present disclosure, the parameters of f1, f2, f3, f4, f5, f6, f7, f8, SL, SH, GH, D1, D2, D2x, D2y, fs1, fs2, SD1, SD2, FG12, FG3, α, β, or the like for each of the embodiments may respectively satisfy: 54.8 mm<f1<89.8 mm, −231.2 mm<f2<−61.5 mm, 9.7 mm<f3<21.6 mm, −33.0 mm<f4<−11.8 mm, 10.0 mm<f5<18.2 mm, −37.5 mm<f6<195.8 mm, 10.0 mm<f7<48.7 mm, −16.3 mm<f8<8.6 mm, 21.8 mm<SL<51.6 mm, 4.5 mm<SH<17.2 mm, 3.1 mm<GH<13.3 mm, 3.4 mm<D1<9.5 mm, 2.2 mm<D2<7.4 mm, 2.2 mm<D2x<7.4 mm, 1.7 mm<D2y<6.7 mm, 57.4 mm<fs1<261.8 mm, −100.0 mm<fs2<353.0 mm, 2.1 mm<SD1<7.3 mm, 2.1 mm<SD2<7.1 mm, −20.0 mm<FG12<9.7 mm, 10.1 mm<FG3<20.9 mm, 4.5 mm<EPDx<18.6 mm, 3.4 mm<EPDy<16.8 mm, 1.5°<<<6.6°, 0.2°<<2.8°.

Tables 33-1 and 33-2 show values of the parameters f1, f2, f3, f4, f5, f6, f7, f8, SL, SH, GH, D1, D2, D2x, D2y, fs1, fs2, SD1, SD2, FG12, FG3, a, B, or the like for each of the embodiments in Embodiments 1-16, respectively. Here, SL, SH, GH may be obtained by measuring according to the labelling method shown in FIG. 1. The units of the parameters f1, f2, f3, f4, f5, f6, f7, f8, SL, SH, GH, D1, D2, D2x, D2y, fs1, fs2. SD1, SD2, FG12, FG3, or the like in Tables 33-1 and 33-2 are millimetres (mm), and the unit of α and β is °.

TABLE 33-1

| | embodiment | | | | | | | |
|---|---|---|---|---|---|---|---|---|
| parameter | 1 | 2 | 3 | 4 | 5 | 6 | 7 | 8 |
| f1 | 58.74 | 59.80 | 89.64 | 77.18 | 78.98 | 66.79 | 54.95 | 55.72 |
| f2 | −231.17 | −117.60 | −102.79 | −78.11 | −87.02 | −92.24 | −67.29 | −67.21 |
| f3 | 10.36 | 9.85 | 21.57 | 18.14 | 18.37 | 17.43 | 15.43 | 14.39 |
| f4 | −14.15 | −14.28 | −32.00 | −18.85 | −18.08 | −18.14 | −15.37 | −14.47 |
| f5 | 11.78 | 11.85 | 18.13 | 16.12 | 16.35 | 13.92 | 12.63 | 13.50 |
| f6 | 184.20 | 182.15 | −18.53 | −33.54 | −37.20 | −14.09 | −20.94 | −20.03 |
| f7 | 41.99 | 46.96 | 15.52 | 17.82 | 17.40 | 10.08 | 12.74 | 11.77 |
| f8 | −8.80 | −8.69 | −16.20 | −13.15 | −12.62 | −11.25 | −10.31 | −9.73 |
| SL | 22.67 | 22.10 | 51.52 | 45.16 | 44.37 | 40.93 | 39.21 | 42.38 |
| SH | 5.57 | 4.68 | 14.77 | 10.38 | 8.70 | 12.00 | 9.10 | 7.60 |
| GH | 3.95 | 3.13 | 10.02 | 8.00 | 6.49 | 9.12 | 6.37 | 5.29 |
| D1 | 3.97 | 3.52 | 9.39 | 6.90 | 5.48 | 8.20 | 6.02 | 4.78 |
| D2 | 3.01 | 2.46 | 7.31 | 5.84 | 4.75 | 6.71 | 4.72 | 4.72 |
| D2x | 3.01 | 2.46 | 7.31 | 5.84 | 4.75 | 6.71 | 4.72 | 4.72 |
| D2y | 2.14 | 1.76 | 5.07 | 4.06 | 3.31 | 4.64 | 3.27 | 3.27 |
| fs1 | 57.50 | 57.77 | 261.71 | 177.83 | 181.75 | 127.12 | 111.88 | 106.53 |
| fs2 | −99.88 | −98.10 | 189.24 | 233.10 | 235.17 | 352.93 | 226.49 | 288.98 |
| SD1 | 2.88 | 2.31 | 7.23 | 5.83 | 4.74 | 6.59 | 4.64 | 3.83 |
| SD2 | 2.80 | 2.35 | 7.02 | 5.83 | 4.91 | 5.93 | 4.57 | 3.80 |
| FG12 | −10.00 | −9.82 | −19.53 | −18.95 | −19.05 | −16.92 | −16.04 | −16.06 |
| FG3 | 10.93 | 10.36 | 20.47 | 20.07 | 20.82 | 18.16 | 14.87 | 15.10 |
| EPDx | 6.48 | 5.07 | 18.47 | 13.51 | 10.65 | 16.20 | 11.85 | 9.35 |
| EPDy | 4.54 | 3.54 | 12.93 | 9.46 | 7.46 | 11.35 | 8.28 | 6.52 |
| α | 2.16 | 1.67 | 3.99 | 3.38 | 2.63 | 4.69 | 4.25 | 3.29 |
| β | 1.50 | 0.82 | 2.70 | 0.32 | 0.40 | 1.57 | 1.41 | 0.94 |

TABLE 33-2

| | embodiment | | | | | | | |
|---|---|---|---|---|---|---|---|---|
| parameter | 9 | 10 | 11 | 12 | 13 | 14 | 15 | 16 |
| f1 | 59.59 | 60.17 | 86.62 | 87.16 | 80.34 | 61.70 | 54.94 | 49.19 |
| f2 | −128.22 | −113.29 | −89.01 | −87.11 | −92.65 | −62.40 | −62.03 | −62.26 |
| f3 | 9.98 | 9.80 | 18.48 | 17.99 | 17.70 | 15.59 | 14.98 | 15.76 |
| f4 | −14.24 | −14.38 | −21.99 | −19.79 | −19.27 | −14.92 | −11.89 | −12.76 |
| f5 | 11.78 | 11.89 | 16.10 | 16.13 | 16.77 | 11.60 | 10.06 | 10.49 |
| f6 | 183.94 | 195.75 | −28.84 | −31.43 | −34.95 | −22.83 | −18.82 | −18.55 |
| f7 | 45.18 | 48.67 | 18.60 | 18.90 | 19.94 | 13.70 | 12.59 | 12.08 |
| f8 | −8.74 | −8.68 | −14.05 | −13.94 | −13.78 | −11.20 | −11.27 | −11.19 |
| SL | 22.46 | 21.97 | 49.60 | 46.50 | 41.75 | 42.38 | 40.07 | 38.29 |
| SH | 5.94 | 5.10 | 17.15 | 12.82 | 10.49 | 14.60 | 10.90 | 8.90 |
| GH | 5.18 | 4.11 | 13.24 | 10.29 | 8.29 | 10.97 | 8.22 | 6.50 |
| D1 | 3.86 | 3.62 | 8.97 | 6.25 | 4.95 | 7.40 | 5.45 | 4.27 |
| D2 | 2.77 | 2.30 | 6.67 | 5.18 | 4.18 | 5.59 | 4.24 | 3.37 |
| D2x | 2.77 | 2.30 | 6.67 | 5.18 | 4.18 | 5.59 | 4.24 | 3.37 |
| D2y | 2.77 | 2.30 | 6.67 | 5.18 | 4.18 | 5.59 | 4.24 | 3.37 |
| fs1 | 57.73 | 57.78 | 192.17 | 193.73 | 172.39 | 120.15 | 141.97 | 166.00 |
| fs2 | −98.62 | −97.24 | 272.82 | 273.40 | 286.07 | 296.78 | 135.91 | 90.27 |
| SD1 | 2.63 | 2.11 | 6.62 | 5.21 | 4.21 | 5.49 | 4.15 | 3.31 |
| SD2 | 2.63 | 2.17 | 6.07 | 5.30 | 4.31 | 5.26 | 4.14 | 3.34 |
| FG12 | −9.89 | −9.78 | −19.00 | −18.58 | −18.15 | −16.54 | −15.56 | −15.41 |
| FG3 | 10.55 | 10.21 | 18.74 | 19.41 | 19.17 | 16.11 | 15.49 | 15.92 |
| EPDx | 5.85 | 4.61 | 16.66 | 12.19 | 9.60 | 14.60 | 10.70 | 8.40 |
| EPDy | 5.85 | 4.61 | 16.66 | 12.19 | 9.60 | 14.60 | 10.70 | 8.40 |
| α | 2.70 | 2.13 | 5.39 | 3.81 | 3.22 | 6.50 | 5.43 | 4.93 |
| β | 1.10 | 0.91 | 0.66 | 0.23 | 0.43 | 1.02 | 1.64 | 1.94 |

Tables 34-1 and 34-2 show values of the conditional expressions for each embodiment in Embodiments 1-16, respectively. It should be noted that the values of the conditional expressions involving FOV, EFL, EPDx, and EPDy in Tables 34-1 and 34-2 are all obtained by calculating the FOV, EFL, EPDx, and EPDy of the optical system in the first state.

TABLE 34-1

| conditional | embodiment | | | | | | | |
|---|---|---|---|---|---|---|---|---|
| expression | 1 | 2 | 3 | 4 | 5 | 6 | 7 | 8 |
| tan(α) × d12 | 0.22 | 0.14 | 1.38 | 0.66 | 0.41 | 1.02 | 0.85 | 0.54 |
| tan(α) × d12 + | 0.24 | 0.16 | 1.44 | 0.67 | 0.43 | 1.05 | 0.88 | 0.56 |
| tan(β) × d23 | | | | | | | | |
| d1P/dP2 | 1.00 | 0.98 | 0.68 | 0.83 | 0.87 | 0.98 | 0.66 | 0.67 |
| (d1P + dP2)/ | 1.26 | 1.31 | 1.55 | 1.32 | 1.32 | 1.23 | 1.54 | 1.56 |
| SH | | | | | | | | |
| dP2/SL | 0.15 | 0.14 | 0.26 | 0.17 | 0.14 | 0.18 | 0.22 | 0.17 |
| tan(FOV/2) | 0.38 | 0.38 | 0.18 | 0.18 | 0.18 | 0.11 | 0.11 | 0.11 |
| D1/CT1 | 5.15 | 4.37 | 5.93 | 6.56 | 5.48 | 6.31 | 5.52 | 4.78 |
| D2/CT2 | 6.68 | 5.47 | 4.78 | 3.82 | 3.11 | 6.71 | 3.15 | 3.15 |
| \|f1/f2\| | 0.25 | 0.51 | 0.87 | 0.99 | 0.91 | 0.72 | 0.82 | 0.83 |
| \|FG12/EFL\| | 0.66 | 0.65 | 0.62 | 0.60 | 0.60 | 0.61 | 0.58 | 0.58 |
| \|FG12/FG3\| | 0.92 | 0.95 | 0.95 | 0.94 | 0.92 | 0.93 | 1.08 | 1.06 |
| \|EFL/(FG12/ | 16.61 | 16.03 | 33.21 | 33.57 | 34.65 | 29.78 | 25.71 | 26.09 |
| FG3)\| | | | | | | | | |
| D2x/EPDx/d12 | 0.08 | 0.10 | 0.02 | 0.04 | 0.05 | 0.03 | 0.03 | 0.05 |
| D2y/EPDy/d12 | 0.08 | 0.10 | 0.02 | 0.04 | 0.05 | 0.03 | 0.03 | 0.05 |
| fs1/fs2 | −0.58 | −0.59 | 1.38 | 0.76 | 0.77 | 0.36 | 0.49 | 0.37 |
| EFL/SL | 0.67 | 0.69 | 0.62 | 0.70 | 0.71 | 0.68 | 0.71 | 0.65 |
| SD1/SD2 | 1.03 | 0.99 | 1.03 | 1.00 | 0.97 | 1.11 | 1.02 | 1.01 |

TABLE 34-2

| conditional | embodiment | | | | | | | |
|---|---|---|---|---|---|---|---|---|
| expression | 9 | 10 | 11 | 12 | 13 | 14 | 15 | 16 |
| tan(α) × d12 | 0.26 | 0.18 | 1.68 | 0.91 | 0.61 | 1.70 | 1.10 | 0.82 |
| tan(α) × d12 + | 0.28 | 0.20 | 1.69 | 0.92 | 0.62 | 1.74 | 1.13 | 0.86 |
| tan(β) × d23 | | | | | | | | |
| d1P/dP2 | 0.98 | 0.96 | 1.03 | 0.87 | 0.96 | 0.97 | 0.87 | 0.82 |
| (d1P + dP2)/ | 1.12 | 1.19 | 1.19 | 1.26 | 1.22 | 1.21 | 1.29 | 1.35 |
| SH | | | | | | | | |
| dP2/SL | 0.15 | 0.14 | 0.20 | 0.19 | 0.16 | 0.21 | 0.19 | 0.17 |
| tan(FOV/2) | 0.38 | 0.38 | 0.18 | 0.18 | 0.18 | 0.11 | 0.11 | 0.11 |
| D1/CT1 | 5.37 | 4.84 | 5.77 | 6.25 | 4.95 | 5.71 | 5.45 | 4.27 |
| D2/CT2 | 6.08 | 5.10 | 6.67 | 3.38 | 4.18 | 4.07 | 2.83 | 2.25 |
| \|f1/f2\| | 0.46 | 0.53 | 0.97 | 1.00 | 0.87 | 0.99 | 0.89 | 0.79 |
| \|FG1/EFL\| | 0.65 | 0.64 | 0.60 | 0.59 | 0.57 | 0.60 | 0.56 | 0.56 |
| \|FG12/FG3\| | 0.94 | 0.96 | 1.01 | 0.96 | 0.95 | 1.03 | 1.00 | 0.97 |
| \|EFL/(FG12/ | 16.21 | 15.86 | 31.24 | 33.12 | 33.44 | 27.01 | 27.60 | 28.64 |
| FG3)\| | | | | | | | | |
| D2x/EPDx/d12 | 0.09 | 0.10 | 0.02 | 0.03 | 0.04 | 0.03 | 0.03 | 0.04 |
| D2y/EPDy/d12 | 0.09 | 0.10 | 0.02 | 0.03 | 0.04 | 0.03 | 0.03 | 0.04 |
| fs1/fs2 | −0.59 | −0.59 | 0.70 | 0.71 | 0.60 | 0.40 | 1.04 | 1.84 |
| EFL/SL | 0.68 | 0.69 | 0.64 | 0.68 | 0.76 | 0.65 | 0.69 | 0.72 |
| SD1/SD2 | 1.00 | 0.97 | 1.09 | 0.98 | 0.98 | 1.04 | 1.00 | 0.99 |

The present disclosure also provides a camera module, and the camera module may be, for example, a periscope camera module. The camera module may include the optical system as described above and an imaging element configured to convert an optical image formed by the optical system into an electrical signal.

The foregoing is only a description for the preferred embodiments of the present disclosure and the applied technical principles. It should be appreciated by those skilled in the art that the scope of protection of the present disclosure is not limited to the technical solution formed by the particular combination of the above technical features. The scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical system, along an optical axis from an object side to an image side sequentially comprising:
a first element group, from the object side to the image side sequentially comprising:
a first lens, having a positive refractive power;
a reflective element, configured to reflect light exiting from the first lens;
a second element group; and
a third element group;
wherein the optical system satisfies: 0.85<|FG12/FG3|<1.1, wherein FG12 is a combined focal length of the first element group and the second element group, and FG3 is an effective focal length of the third element group.

2. The optical system according to claim 1, wherein the first element group comprises:
a second lens, having a negative refractive power, and disposed between the reflective element and the second element group.

3. The optical system according to claim 2, wherein the optical system satisfies: 0.1<tan(α)×d12<1.8, wherein α is an included angle between emitting light corresponding to the first lens and incident light corresponding to the first lens, and d12 is an on-axis distance from an image-side surface of the first lens to an object-side surface of the second lens.

4. The optical system according to claim 2, wherein the second element group comprises a third lens closest to the object side, wherein the optical system satisfies:
$$0.1 < tan ( α ) \times d 12 + tan ( β ) \times d 23 < 1.8 ,$$
wherein α is an included angle between emitting light corresponding to the first lens and incident light corresponding to the first lens, d12 is an on-axis distance from an image-side surface of the first lens to an object-side surface of the second lens, β is an included angle between emitting light corresponding to the second lens and incident light corresponding to the first lens, and d23 is an on-axis distance from an image-side surface of the second lens to an object-side surface of the third lens.

5. The optical system according to claim 2, wherein the optical system satisfies:
$$1.1 < ( d 1 P + dP 2 ) / SH < 1.6 ,$$
wherein d1P is an on-axis distance from an object-side surface of the first lens to the reflective element, dP2 is an on-axis distance from the reflective element to an image-side surface of the second lens, and SH is a total height of the optical system.

6. The optical system according to claim 2, wherein the optical system satisfies:
$$0.1 < dP 2 / SL < 0.3 ,$$
wherein dP2 is an on-axis distance from the reflective element to an image-side surface of the second lens, and SL is a total length of the optical system.

7. The optical system according to claim 2, wherein the optical system satisfies:
$$0.6 < d 1 P / dP 2 < 1.1 ,$$
wherein d1P is an on-axis distance from an object-side surface of the first lens to the reflective element, and dP2 is an on-axis distance from the reflective element to an image-side surface of the second lens.

8. The optical system according to claim 1, wherein the optical system satisfies:
$$tan ( FOV / 2 ) < 0.4 ,$$
wherein FOV is a maximal field-of-view of the optical system.

9. The optical system according to claim 1, wherein the optical system satisfies:
$$3. < D 1 / CT 1 < 7. ,$$
wherein D1 is a maximal effective aperture radius of the first lens, and CT1 is a center thickness of the first lens on the optical axis.

10. The optical system according to claim 2, wherein the optical system satisfies:
1.8≤D2/CT2<8.1,
wherein D2 is a maximal effective aperture radius of the second lens, and CT2 is a center thickness of the second lens on the optical axis.

11. The optical system according to claim 2, wherein the optical system satisfies:
$$\vert f 1 / f 2 \vert \leq 1. ,$$
wherein f1 is an effective focal length of the first lens, and f2 is an effective focal length of the second lens.

12. The optical system according to claim 1, wherein the optical system satisfies:
$$0.55 \leq \vert FG 12 / EFL \vert \leq 0.67 ,$$
wherein FG12 is the combined focal length of the first element group and the second element group, and EFL is an effective focal length of the optical system.

13. The optical system according to claim 2, wherein the optical system satisfies:
$$15.5 mm < \vert EFL / ( FG 12 / FG 3 ) \vert < 35 mm ,$$
wherein FG12 is the combined focal length of the first element group and the second element group, FG3 is the effective focal length of the third element group, and EFL is an effective focal length of the optical system.

14. The optical system according to claim 2, wherein the optical axis comprises a first optical axis and a second optical axis having a preset angle therebetween, the reflective element is configured to receive the light exiting from the first lens along a direction of the first optical axis, and reflect the light along a direction of the second optical axis to be emitted into the second lens, wherein the optical system satisfies:
$$0.02 {mm}^{- 1} \leq D 2 x / EPDx / d 12 < 0.15 {mm}^{- 1} ,$$
wherein D2x is a maximal effective aperture radius of the second lens in a first direction, EPDx is an entrance pupil diameter of the optical system in the first direction, and d12 is an on-axis distance from an image-side surface of the first lens to an object-side surface of the second lens;
wherein the first direction is a direction perpendicular to a plane formed by the first optical axis and the second optical axis.

15. The optical system according to claim 2, wherein the optical axis comprises a first optical axis and a second optical axis having a preset angle therebetween, the reflective element is configured to receive the light exiting from the first lens along a direction of the first optical axis, and reflect the light along a direction of the second optical axis to be emitted into the second lens, wherein the optical system satisfies:
$$0.02 {mm}^{- 1} \leq D 2 y / EPDy / d 12 < 0.15 {mm}^{- 1} ,$$
wherein D2y is a maximal effective aperture radius of the second lens in a second direction, EPDy is an entrance pupil diameter of the optical system in the second direction, and d12 is an on-axis distance from an image-side surface of the first lens to an object-side surface of the second lens;
wherein the second direction is a direction parallel to the first optical axis.

16. The optical system according to claim 1, wherein the optical system satisfies: −
$$0.6 < fs 1 / fs 2 < 1.85 ,$$
wherein fs1 is an effective focal length of an object-side surface of the first lens, and fs2 is an effective focal length of an image-side surface of the first lens.

17. The optical system according to claim 1, wherein the optical system satisfies:
$$0.56 < EFL / SL < 1. ,$$
wherein EFL is an effective focal length of the optical system, and SL is a total length of the optical system.

18. The optical system according to claim 1, wherein the optical system satisfies:
$$0.95 \leq SD 1 / SD 2 \leq 1.12 ,$$
wherein SD1 is a maximal effective aperture radius of a lens closest to the object side in the second element group, and SD2 is a maximal effective aperture radius of another lens adjacent to the lens closest to the object side in the second element group.

19. The optical system according to claim 1, wherein a position of the second element group relative to an image plane disposed on the image side is fixed, and a distance between the third element group and the second element group on the optical axis is adjustable.

20. A camera module, comprising an optical system and an imaging element configured to convert an optical image formed by the optical system into an electrical signal, wherein the optical system along an optical axis from an object side to an image side sequentially comprises:
a first element group, from the object side to the image side sequentially comprising:
a first lens, having a positive refractive power;
a reflective element, configured to reflect light exiting from the first lens;
a second element group; and
a third element group;
wherein the optical system satisfies: 0.85<|FG12/FG3|<1.1, wherein FG12 is a combined focal length of the first element group and the second element group, and FG3 is an effective focal length of the third element group.
